(19) United States
(12) Patent Application Publication
(10) Pub. No.: US 2025/0251339 A1
(43) Pub. Date: Aug. 7, 2025

(54) PHOTONIC INTEGRATED ACOUSTIC SENSOR

(71) Applicant: DeepSight Technology, Inc., Santa Clara, CA (US)

(72) Inventors: Yihang LI, Olivette, MO (US); Zhoutian FU, Clayton, MO (US); Jack ROSS, St. Louis, MO (US); Mohsen Shahmohammadi GHAHSAREH, St. Louis, MO (US); Linhua XU, University City, MO (US); Haochen KANG, Sunnyvale, CA (US); Lan YANG, Clayton, MO (US); Danhao MA, San Jose, CA (US); Guangming ZHAO, Beijing (CN)

(73) Assignee: DeepSight Technology, Inc., Santa Clara, CA (US)

(21) Appl. No.: 19/046,479

(22) Filed: Feb. 5, 2025

Related U.S. Application Data
(60) Provisional application No. 63/550,515, filed on Feb. 6, 2024.

(51) Int. Cl. G01N 21/17

(52) U.S. Cl. CPC G01N 21/1702; G01N 2021/1708; G01N 2201/067; G01N 2201/0873

(57) ABSTRACT

Disclosed herein are apparatus and methods for acoustic imaging. The disclosed embodiments include an optical sensor. The optical sensor may include an acoustic stack. The acoustic stack may include a backing layer that supports an optical layer. The optical layer may include an optical waveguide and a tuning device configured to tune an optical propagation property of the optical waveguide. The optical waveguide may include a core region and one or more cladding regions. The one or more cladding regions may have optical refractive index less than that of the core region.

### CROSS-REFERENCE TO RELATED APPLICATIONS

This application claims priority to U.S. Provisional Application No. 63/550,515, filed Feb. 6, 2024. The disclosure of the above-referenced application is expressly incorporated herein by reference in its entirety.

### TECHNICAL FIELD

This disclosure relates generally to the field of ultrasound, and in particular to acoustic sensing, and, without limitation, to acoustic sensing using optical waveguides.

### BACKGROUND

Acoustic or ultrasound imaging technology is used in various industries, particularly in non-invasive measurements, remote sensing, and medical imaging. Acoustic imaging technology operates by transmitting acoustic signals toward an object and detecting resulting echo signals that reflect or generate from the object in response to the transmitted acoustic signals. Ultrasound, a form of non-ionizing radiation, is an advantageously non-invasive form of imaging. The resolution of ultrasound increases by transmitting higher frequency acoustic waves. However, the depth of penetration decreases due to the increased acoustic attenuation. This tradeoff between resolution and penetration depth poses a challenge.

Various conventional ultrasound transducers used in ultrasound imaging have numerous drawbacks. For example, some ultrasound transducers are made of piezoelectric material, such as lead zirconate titanate (PZT), polymer thick film (PTF) and polyvinylidene fluoride (PVDF). However, some of the challenges associated with use of piezoelectric properties of these materials include high operation voltage requirements, a high electric field requirement (which may cause breakdown and failure), a non-linear response with high hysteresis, and limited angle of detection. The bandwidth of conventional ultrasound transducers are limited in view of materials used. The 6 dB bandwidth of PZT materials is generally limited to only about 70%. Certain composite PZT materials have a slightly increased bandwidth, but still only achieve a bandwidth of up to about 80%. As another example, single crystal materials have increasingly been used in an effort to improve performance of ultrasound probes but have lower Curie temperatures and are brittle. Another type of transducer material is silicon, which can be processed to build Capacitive Micromachined Ultrasound Transducer (CMUT) probes that can have increased bandwidth. However, CMUT probes are not very sensitive or reliable. Moreover, CMUT probes have several operational limitations. For example, CMUT probes are nonlinear transducers and, therefore, are not generally suitable for harmonic imaging. In addition, CMUT probes require an additional bias voltage to operate properly. Thus, there is a need for new and improved devices and methods for ultrasound sensing.

### BRIEF SUMMARY

The inventors here have solved the above example problems, and other problems, by providing new and improved devices and methods for ultrasound sensing. Disclosed embodiments include an apparatus for acoustic imaging of a medium. In some embodiments, the optical sensor includes an acoustic stack. The acoustic stack includes a backing layer that supports an optical layer. The optical layer includes an optical waveguide and a tuning device configured to tune an optical propagation property of the optical waveguide. The optical waveguide includes a core region and one or more cladding regions. The one or more cladding regions may have optical refractive index less than that of the core region.

In some embodiments, the optical waveguide includes a plurality of straight parallel portions and a plurality of bend portions disposed within the width of the sensor. The optical propagation property of the optical waveguide may be configured to change in response to ultrasound signals.

In some embodiments, the average spacing of the straight portions is smaller than the smallest bending diameter of the bend portions.

In some embodiments, the apparatus includes a plurality of ultrasound transducers configured to generate ultrasound signals and an optical sensor array comprising the optical sensor.

In some embodiments, the optical waveguide is an acoustic responsive optical waveguide configured such that a complex refractive index or a group velocity associated with a guided mode of the acoustic-responsive optical waveguide changes in response to ultrasound signals reflecting from the imaged medium.

In some embodiments, the apparatus includes a top layer coupled to the optical layer.

In some embodiments, the top layer includes an acoustic matching layer having an acoustic impedance between that of the imaged medium and that of the backing layer, wherein the acoustic matching layer has a thickness configured to facilitate acoustic transmission from the imaged medium to the optical layer.

In some embodiments, the tuning device and the optical waveguide are included in a single layer in a photonic chip, and the mode refractive index of the corresponding acoustic-responsive optical waveguide is tuned via at least one of thermo-optical effect, electro-optic effect, photoelastic effect, or free-carrier-based electro-refractive effect.

In some embodiments, the tuning device and the optical waveguide are included in different layers in an acoustic stack, and the tuning device may be in an external layer that is adjacent to the optical layer, the mode refractive index of the corresponding acoustic-responsive optical waveguide is tuned via at least one of thermo-optical effect, electro-optic effect, photoelastic effect, or mechanical deformation of the waveguide.

In some embodiments, at least one of the one or more cladding regions is formed from a buried oxide layer of a silicon-on-insulator wafer.

In some embodiments, at least one of the cladding regions or core regions comprises an acoustic responsive material.

Disclosed embodiments include a method of imaging. The method includes receiving an input optical signal at an interference-based device. The interference-based device includes one or more optical waveguides including a cladding, the one or more optical waveguides configured to be perturbed by an acoustic signal from an imaged medium, one or more optical ports coupled to the one or more optical waveguides, and a tuning device configured to tune an optical waveguide of the one or more optical waveguides. The method includes generating, via the interference-based device, an optical interference signal encoding a change in an optical propagation property of one or more optical waveguides based on the perturbation by the acoustic signal. The method includes measuring the optical interference signal from the interference-based device. The method includes detecting the acoustic signal from the imaged medium based on the measured optical interference signal.

In some embodiments, the interference-based device includes an interferometer including a reference arm optical waveguide coupled to an optical input port and an optical output port of the one or more optical ports, and a sensing arm optical waveguide coupled to an optical input port and an optical output port of the one or more optical waveguides.

In some embodiments, the reference arm optical waveguide includes an acoustic-responsive material and the tuning device is disposed adjacent to an optical core of the sensing arm optical waveguide.

In some embodiments, the interference-based device includes a waveguide resonator, the waveguide resonator includes a resonator body having the one or more optical waveguide.

The disclosed embodiments include a method of reading signals from a sensor array. The method includes receiving a plurality of input signals from an optical source. The method includes branching the plurality of input signals to a sensor array including a plurality of optical sensors. Each optical sensor of the plurality of optical sensors includes one or more optical waveguides disposed between an optical input port and an optical output port, a tuning device, and an electrical input port. A first input signal of the plurality of input signals may correspond to a first optical sensor of the plurality of optical sensors. The method includes tuning, with the tuning device of the first optical sensor, the first optical sensor according to a wavelength of the optical source. The method includes transmitting, from the optical output port of the first optical sensor, a first output signal.

In some embodiments, the method includes receiving a second input signal corresponding to a second optical sensor of the plurality of optical sensors. The method may include tuning, with the tuning device of the second optical sensor, the second optical sensor. The method may include transmitting, from the second optical sensor, a second output signal.

In some embodiments, the method includes receiving a plurality of electrical control signals at each electrical input port, and controlling the tuning device of each optical sensor with the plurality of electrical control signals.

In some embodiments, the tuning device includes a thermo-optical tuning device that changes an effective mode index of the optical sensor.

In some embodiments, the tuning device includes an optoelectronic tuning device configured to change an effective mode index of the optical sensor.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

The accompanying drawings, which are incorporated in and constitute a part of this specification, illustrate several embodiments and, together with the description, serve to explain the disclosed principles. In the drawings:

FIGS. 1A, 1B, 1C, 1D, and 1E depict an exemplary implementation of an ultrasound system, consistent with embodiments of the present disclosure.

FIGS. 2A and 2B depict a cross-section of waveguide stack, consistent with embodiments of the present disclosure.

FIGS. 3A, 3B, 3C, 3D, 3E, 3F, and 3G depict sensor responses and exemplary cores for a waveguide sensor, consistent with embodiments of the present disclosure.

FIG. 4A depicts examples of sensitivity zeros and intrinsic directionality of waveguides, consistent with embodiments of the present disclosure.

FIG. 4B depicts an example of PE sensitivity and deformation sensitivity, consistent with embodiments of the present disclosure.

FIG. 4C depicts an example of PE sensitivity and deformation sensitivity, consistent with embodiments of the present disclosure.

FIG. 4D depicts another example of PE sensitivity and deformation sensitivity, consistent with embodiments of the present disclosure.

FIG. 5 depicts an embodiment of a cross section for a waveguide containing a matching layer.

FIG. 6 depicts an example of an interferometer sensor, consistent with embodiments of the present disclosure.

FIGS. 7A and 7B depicts an embodiment of a resonator sensor, consistent with embodiments of the present disclosure.

FIGS. 8A and 8B depict examples of a resonator sensor, consistent with embodiments of the present disclosure.

FIG. 9 illustrate flow charts of a method for imaging, consistent with embodiments of the present disclosure.

FIG. 10 depicts a cross section of an acoustic responsive optical sensor, consistent with embodiments of the present disclosure.

FIG. 11 illustrates a flowchart of a process for using an acoustic-responsive sensor, consistent with embodiments of the present disclosure.

FIG. 12 depicts a waveguide trace with a 7-fold slim rectangular spiral, consistent with embodiments of the present disclosure.

FIG. 13 depicts a waveguide trace with 8-fold slim rectangular spiral loop consistent with embodiments of the present disclosure.

FIG. 14 depicts a waveguide trace with of 7-fold dipole spiral, consistent with embodiments of the present disclosure.

FIG. 15 depict a trace with 8-fold dipole spiral loop, consistent with embodiments of the present disclosure.

FIGS. 16A and 16B depict a waveguide, consistent with embodiments of the present disclosure.

FIG. 17 depicts an embodiment of traces for arms for an interferometer sensor, consistent with embodiments of the present disclosure.

FIG. 18 depicts an embodiment of traces for a sensor array consistent, with embodiments of the present disclosure.

FIG. 19 illustrates a flowchart of a process for fabricating an acoustic-responsive sensor, consistent with embodiments of the present disclosure.

FIG. 20 depicts a cross section of a sensor including of thermo-optical tuning, consistent with embodiments of the present disclosure.

FIG. 21 depicts a cross section of a sensor including thermo-optical tuning, consistent with embodiments of the present disclosure.

FIG. 22 depicts a cross section of a sensor including optoelectronic tuning, consistent with embodiments of the present disclosure.

FIG. 23 depicts a cross section of a sensor including electro-optical controlling, consistent with embodiments of the present disclosure.

FIG. 24 depicts a cross section of a sensor including thermo-optical tuning with hybrid cladding, consistent with embodiments of the present disclosure.

FIG. 25 depicts a cross-section of a receiving array, consistent with embodiments of the present disclosure.

FIG. 26 depicts a zoomed in view of a sensor of a receiving array, consistent with embodiments of the present disclosure.

FIG. 27 depicts an FEM simulation result for the temperature profile of an embodiment of a heated element, consistent with embodiments of the present disclosure.

FIG. 28 depicts a cross section of a sensor with a tuning layout, consistent with embodiments of the present disclosure.

FIG. 29 depicts a cross section of a sensor with of thermo-optical controller, consistent with embodiments of the present disclosure.

FIG. 30 depicts a cross section of a sensor with a thermo-optical controller and external circuitry stack, consistent with embodiments of the present disclosure.

FIGS. 31, 32, 33, 34, and 35 depict steps in a sensor array manufacturing process flow diagram, consistent with embodiments of the present disclosure.

FIG. 36A depicts a circuit schematic for a sensor array with individual inputs and outputs, consistent with embodiments of the present disclosure.

FIG. 36B depicts a circuit schematic for a sensor array, consistent with embodiments of the present disclosure.

FIG. 37 depicts a circuit schematic for a sensor array with shared inputs and individual outputs, consistent with embodiments of the present disclosure.

FIG. 38 illustrates a flowchart of a process for using a sensor array for acoustic sensing, consistent with embodiments of the present disclosure.

FIG. 39 illustrates a flowchart of a process for reading signals with a sensor array, consistent with embodiments of the present disclosure.

FIG. 40 illustrates a flowchart of a process for reading signals with a sensor array, consistent with embodiments of the present disclosure.

FIG. 41 illustrates a flowchart of a process for reading signals with a sensor array, consistent with embodiments of the present disclosure.

FIG. 42 depicts a block diagram of a computer system, consistent with embodiments of the present disclosure.

In the drawings, similar components and/or features may have the same reference label.

### DETAILED DESCRIPTION

The ensuing description provides preferred exemplary embodiment(s) only, and is not intended to limit the scope, applicability, or configuration of the disclosure. Rather, the ensuing description of the preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims.

Non-limiting examples of various aspects and variations of the invention are described herein and illustrated in the accompanying drawings. The following detailed description is merely illustrative in nature and is not intended to limit the invention or the application and uses of the invention. Although the description of the invention is in the context of optical-sensor systems, methods, and devices for ultrasound imaging, the disclosure should not be considered so limiting. For example, although methods may be discussed herein with respect to medical ultrasound, embodiments hereof may be suitable for other medical procedures as well as other procedures or methods in other industries that may benefit from the sensing and imaging technologies described herein. Further, various systems and devices that incorporate photonic integrated sensors are described. It is understood that photonic integrated sensors as described herein, may be integrated into and/or used with a variety of systems and devices not described herein. Modifications may be made to the embodiments described herein without departing from the spirit and scope of the present invention. Therefore, the following detailed description is not meant to be limiting. Furthermore, there is no intention to be bound by any expressed or implied theory presented in the preceding technical field, background, summary, or the following detailed description.

Various structures are described herein according to their geometric properties. As discussed herein, structures so described may vary from the described shape according to the tolerances of known manufacturing techniques. Unless otherwise specified, features described with the term “substantially” are understood to be within 5% of exactness. For example, features described as “substantially parallel” may deviate from true parallel by 5%.

Ultrasound or acoustic imaging technology, a form of non-ionizing radiation, is an advantageously non-invasive form of imaging used in various industries. For example, acoustic imaging has applications in non-invasive measurements, remote sensing, medical imaging, diagnostic procedures, surgical procedures, and therapeutic procedures. An imaged medium may include an object or multiple objects that are the target of acoustic imaging. An imaged medium can include an area, region, structure, or material. In an example of medical imaging, diagnostic, surgical or therapeutic applications, the clinician can use ultrasound to image internal structures of patients, and the imaged medium may include tissue, organ, bone and other anatomical structures, implants, medical tools, or other objects within the insonified region.

Some existing imaging technologies use acoustic energy generating (AEG) materials for transducers to generate and receive acoustic signals. Commonly used AEG transducers include piezoelectric materials such as lead-zirconate-titanate (PZT), ceramic, piezoelectric single crystal (e.g. PIN-PT, PIN-PMN-PT), polymer thick film (PTF), polyvinylidene fluoride (PVDF), capacitive micromachined ultrasonic transducers (CMUT), photoacoustic transducers, piezoelectric micromachined ultrasound transducers (PMUT), among many other materials known to those of skill in the art. However, some of the challenges associated with use of these materials, aside of the trade-offs between resolution and penetration depth, include high operation voltage requirements, a high electric field requirement (which may cause breakdown and failure), a non-linear response with high hysteresis, and limited angle of detection. Furthermore, the detection sensitivity of AEG transducers is a function of size, thereby limiting the suitability of size-constrained applications such as intravascular ultrasound (IVUS) devices.

Another challenge is the narrow bandwidth of an AEG transducer. For example, for ultrasound transducers made of piezoelectric material, such as lead zirconate titanate (PZT), the 6 dB bandwidth of PZT is generally limited to only about 70%. Certain composite PZT materials have a slightly increased bandwidth, but still only achieve a bandwidth of up to about 80%. As another example, single crystal materials have increasingly been used in an effort to improve performance of ultrasound probes but have lower Curie temperatures and are brittle. Another type of transducer material is silicon, which can be processed to build Capacitive Micromachined Ultrasound Transducer (CMUT) probes that can have increased bandwidth. However, CMUT probes are not very sensitive or reliable. Moreover, CMUT probes have several operational limitations. For example, CMUT probes are nonlinear transducers and, therefore, are not generally suitable for harmonic imaging. In addition, CMUT probes require an additional bias voltage to operate properly. Additionally, some AEG transducers and systems may be affected by electromagnetic interference, such as that caused by ablation tools, cauterization tools, or any other procedure or technique that applies electrical energy to tissue. Furthermore, use of an electro-mechanical transducer at the distal end may involve an electrically conductive line and associated components requiring additional design and safety requirements and challenges. Thus, there is a need for new and improved devices and methods for ultrasound imaging modes with various frequency harmonics to obtain higher resolution, better penetration, improved tunability, and fewer artifacts than fundamental imaging of conventional ultrasound sensing.

The disclosed embodiments provide improvements in ultrasound imaging and can address one or more challenges described herein. In particular, in using optical sensors with tuning devices and specific control of such tuning, interference-based transduction mechanisms, and array driving mechanisms to read signals, the disclosed embodiments can provide enhanced signal reading, improved tunability, simpler manufacturing, and reduced costs, among other advantages that will be described.

Photonic devices and optical pressure detection techniques have shown great promise for ultrasound detection. In photonic devices, refractive index modulation and/or shape deformations due to strain induced by an acoustic wave are translated into changes in the intensity of the detected light or the spectral properties of the device. In some existing devices, optical resonators have been used as highly sensitive ultrasound detectors. In general, the performance of an optical resonator is limited by its quality factor Q (i.e., the higher the Q, the lower the optical loss and the smaller the detectable resonance shift) as well as by the acousto-optical and mechanical properties of the material from which the resonator is made. Optical sensors, such as, for example, interference based optical sensors, optical resonators and interferometers, may have high sensitivity and broad bandwidth in reception of ultrasound signals compared to other types of ultrasound sensors. Because of the high sensitivity and broad bandwidth of optical sensors, the image produced by the optical sensors may have improved spatial resolution, improved penetration depth, improved signal-to-noise ratio (SNR), improved tissue harmonic imaging, and/or improved Doppler sensitivity.

The optical resonators may include a closed loop of a transparent medium that allows some permitted frequencies of light to continuously propagate inside the closed loop, and to store optical energy of the permitted frequencies of light in the closed loop. The permitted frequencies of light and the quality factor of the optical resonators may be based at least in part on geometrical parameters of the optical resonator, refractive index of the transparent medium, and refractive indices of an environment surrounding the optical resonator.

The optical interferometers may include a Mach-Zehnder interferometer(s), a Michelson interferometer(s), a Fabry-Perot interferometer(s), a Sagnac interferometer(s), and/or the like. For example, a Mach-Zehnder interferometer may include two nearly identical optical paths (e.g., fibers, on-chip silicon waveguides, etc.). The two optical paths may be finely adjusted by acoustic waves (e.g., by physical movement caused by the acoustic waves, tuning of refractive index caused by the acoustic waves, etc.) to effect distribution of optical powers in an output(s) of the Mach-Zehnder interferometer, and therefore, detect a presence or a magnitude of the acoustic waves.

The optical sensors may be coupled to the outside world to receive light, to transmit light, and be useful in practice (e.g., for an ultrasound imaging or other transducing application in an acousto-optic system). Acousto-optic systems based on optical sensors may directly measure ultrasonic waves through the photo-elastic effect and/or physical deformation of the resonator(s) in response to the ultrasonic waves (e.g., ultrasonic echoes). For example, in the presence of ultrasonic (or other pressure) waves, the light waves traveling an optical resonator may undergo a spectral shift caused by changes in the refractive index and shape of the optical resonator. The spectral change can be monitored and analyzed in spectral domain and light transmission intensity to and from the optical resonator. Additional spatial and other information can furthermore be derived by monitoring and analyzing shifting light among multiple optical resonators. Furthermore, other physical parameters such as temperature and pressure can affect the transmitted light providing additional information to support multi-dimensional sensing.

However, challenges exist in designing a robust sensor with acceptable Q value in a form factor used in ultrasound imaging.

The disclosed embodiments include systems, devices, and methods for ultrasound sensing and imaging. The disclosed embodiments include Photonic Integrated Acoustic Sensors (PIAS) and Photonic Integrated Acoustic Receiver Arrays (PIARA). A PIAS may include to any photo-acoustic or opto-acoustic sensor, as will be described herein. A PIAS may refer to an individual sensor, such as a photonic sensing structure that lies within a single element outline. The sensing structure may be based on one or more acoustic-responsive waveguides that encode an incident acoustic signal into a readable optical power signal (e.g., via a specific transduction mechanism). For example, the element outline can be filled with one or more acoustic-responsive optical waveguides with sufficient length for a sensing application. For example, longer waveguides can improve signal to noise ratio in phase response, but excessively long waveguides can also result in insertion losses. Waveguides can be linked or merged with curved waveguides (e.g., determined by a signal transduction design) or couplers to increase or vary length within the sensor outline as desired. A coupler, which can also refer to a splitter, combiner, or other connector, may connect optical routing traces to the acoustic-responsive waveguides. For example, a coupler may connect on a boundary or region where an optical sensor may detect or respond to acoustic signals (e.g., on the edge of the aperture of the acoustic sensitivity). A PIAS can include one or more optical ports for letting light propagate into and out of the element outline. Optional electrical signals can also be guided into and out of the element outline (e.g., for sensor control via electrical ports). A PIAS may be a single element of a receiver array. A Photonic Integrated Acoustic Receiver Array (PIARA) may refer to any receiving arrays as will be described herein. For example, a PIARA can include multiple PIASs. Multiple PIASs can form a PIARA, working in a mixed array configuration with acoustic energy generating (AEG) transducers for ultrasound imaging. In some embodiments, the AEG transducers and PIARA may be separate from each other.

In some configurations, a plurality of transducer types can be used. In some examples, the ultrasound array may include the same type of elements. Alternatively, the ultrasound array may include different types of elements. For example, a probe 104 may include one or more acoustic energy generating (AEG) transducers, such as one or more of a piezoelectric transducer, a lead zirconate titanate (PZT) transducer, a polymer thick film (PTF) transducer, a polyvinylidene fluoride (PVDF) transducer, a capacitive micromachined ultrasound transducer (CMUT), a piezoelectric micromachined ultrasound transducer (PMUT), a photoacoustic transducer, a transducer based on single crystal materials (e.g., LiNb03(LN), Pb(Mg113Nb213)-PbTiQ3 (PMN-PT), and Pb(In112Nb112)-Pb(Mg113Nb213)PbTiQ3 (PIN-PMN-PT)), combinations thereof, and the like. Additionally, in some examples, the ultrasound array may include one or more optical sensors, such as an interference-based optical sensor, which may be one or more of an optical interferometer, an optical resonator and/or an optical fiber sensor.

Ultrasound imaging uses a sensor array for beamforming to construct high quality ultrasound images of targets or areas of interest. It will be appreciated that optical resonators may have high sensitivity and broad bandwidth in reception of ultrasound signals compared to other types of ultrasound sensors. The one or more array elements of a first type (e.g., AEG transducers) may be used to form a first image. In parallel, the one or more array elements of a second type (e.g., the optical sensors) can be used to detect acoustic signals that can be used to form a second image. The second image generated by these highly sensitive and broadband optical sensors may be used independently or can be combined with the first image to form an even further improved image. In some configurations, a PIAS and/or PIARA can be used independently of a transmit element or transmit array. Diagnostic and therapeutic procedures may use additional information from the sensed signals beyond the image such as when used for multi-dimensional sensing.

An optical sensor may perform multi-dimensional sensing (e.g., measure a plurality of different physical signals substantially simultaneously in real-time or near real-time).

An optical sensor system may generally include one or more optical sensors where an optical sensor (e.g., single sensor) may be used to detect multiple physical signals, such as temperature, pressure, acoustic waves, and the like by analyzing sensor responses such as a mode shift (e.g., change in resonance frequency, depth, shape of response), a baseline drift, a mode split, and/or a mode broadening.

A sensor signal may be used to generate a plurality of measurement signals corresponding to a plurality of physical signals. Accordingly, while an array may include multiple optical sensors, one or more optical sensors in the array may function independently and singularly from the other optical sensors in the array, as a multi-dimensional sensor capable of measuring a plurality of physical signals.

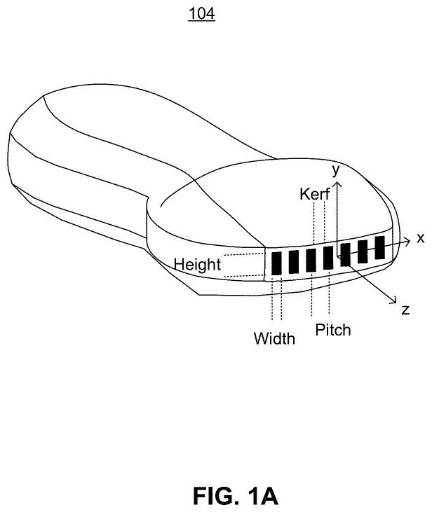

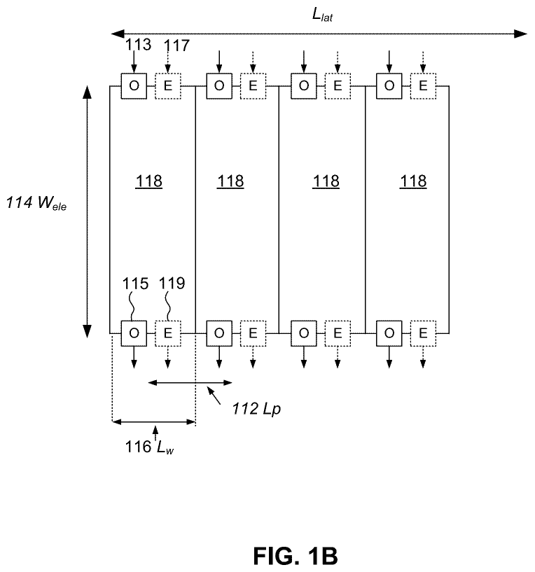

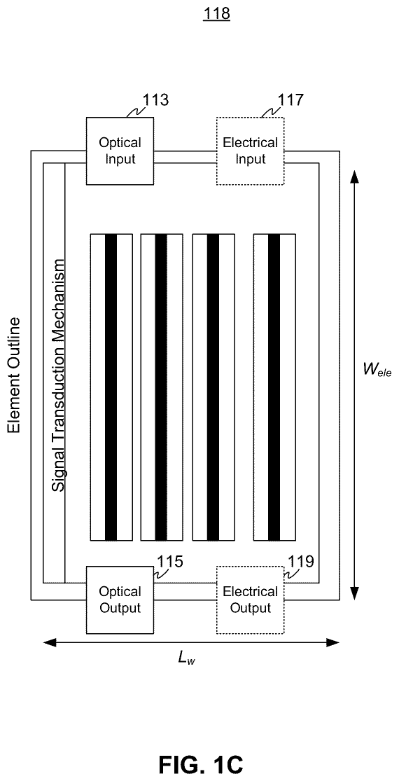

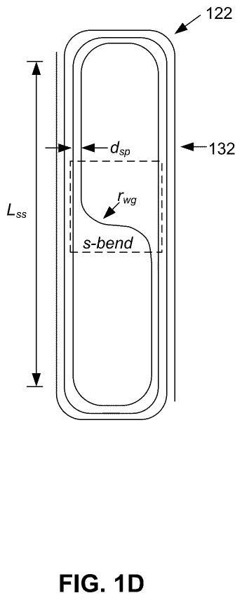

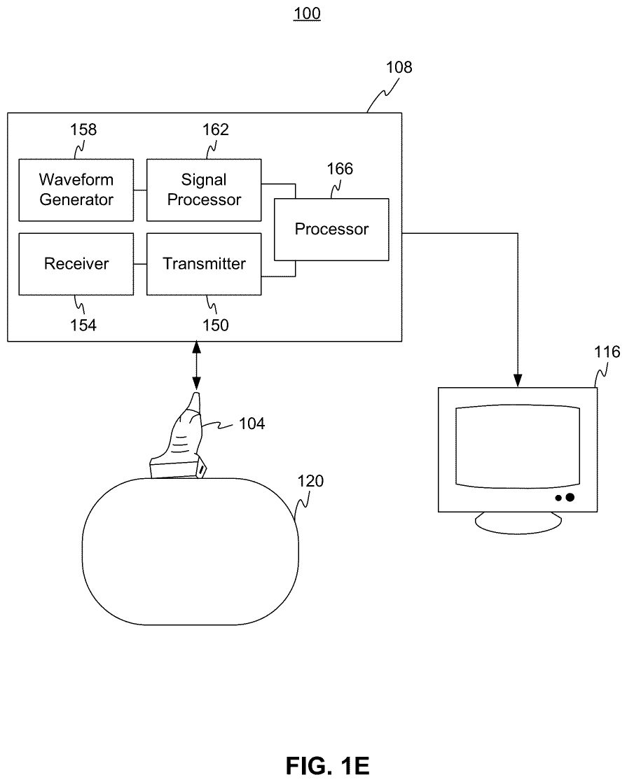

FIGS. 1A-1E illustrate features of an exemplary device for implementing various aspects of the present disclosure. It will be appreciated that FIGS. 1A-1E describe implementations of the disclosed embodiments by way of example, and are not meant to be limiting. FIG. 1A depicts an embodiment of a probe 104, consistent with embodiments of the present disclosure. Probe 104 may be an ex vivo mixed array probe. Probe 104 may include an imaging plane characterized by a lateral dimension, axial dimension, and elevation dimension. Kerf may refer to the spacing or distance between neighboring elements within the probe, pitch may refer to the distance between centers of adjacent elements, height may refer to the height of an element along the elevation direction, and width may refer to the width of an element along the lateral dimension. FIG. 1B depicts an embodiment of a 1-dimensional array 110. Array 110 may be a basic building block of an ultrasound probe sensor, such as probe 104. Array 110 may be characterized by pitch 112, determined by the imaging application constraints (for example, a lateral pitch that is equal to or less than an acoustic wavelength of the AEG center frequency of AEG in tissue for a typical linear or phased array); lateral width (L_{w}) 116; and elevation width (Wₑₗₑ) 114 determined by a desired acoustic focus of the ultrasound probe. Acoustic focus may refer to focus in the elevation dimension, and can apply to both transmitting and receiving process. The focal depth may be determined by the elevation size (Wₑₗₑ) and/or an acoustic lens. Array 110 may include a sensor element 118. Element 118 may include optical ports, such as optical input port 113 and optical output port 115. In some examples, element 118 may include electrical ports, such as electrical input port 117 and electrical output port 119. To form the 1-dimensional array 110, a single element 118, shown in FIG. 1C, may be confined within a certain outline (e.g., bounded by elevation width and lateral width). In some embodiments, an outline has a rectangular shape with a high aspect ratio in which the elevation width 14 (e.g., same as that of the array) is longer than a lateral width (L_{w}) 116 that does not exceed the lateral pitch 112 of the array. The lateral pitch of single elements adds up across the array and forms a lateral imaging aperture with a length Lₗₐₜ, which can at least partially determine an imaging performance of the array The element 118 may be in an ex vivo mixed array probe such as probe 104 or in an in-vivo probe, such as for endoluminal ultrasound (EUS), intravascular ultrasound (IVUS), endobronchial ultrasound (EBUS), intraoperative ultrasound for open or minimally invasive surgical procedures.

In some embodiments, Wₑₗₑ 114 may be shown as greater than L_{w} 116, and can be used in many situations (for example, in typical linear and phased arrays, a wavelength-level L_{w} and pitch are required for suppression of acoustic side lobes and acoustic lobes and a larger elevation aperture is required to realize enough focal depth) Other embodiments may not have Wₑₗₑ 114 greater than L_{w} 161. For example, in a 2D array or a “beacon” type arrangement, or in a ring array, the aspect ratio of Wₑₗₑ 114>L_{w} 116 is not used. For example, in a 2D array the Wₑₗₑ 114 is also below the acoustic wavelength.

A higher-dimensional array can be formed by combining multiple 1-dimensional arrays. For example, the array can be configured for operation in a 1.25-dimensional (1.25D) array configuration, a 1.5-dimensional (1.5D) array configuration, a 1.75-dimensional (1.75D) array configuration, a 2 dimensional (2D) array configuration, or other array configuration. Generally, dimensionality of the ultrasound transducer array relates to the range of elevation beam width (or elevation beam slice thickness) that is achievable when imaging with the ultrasound transducer array, and how much control the system has over the transducer array's elevation beam aperture size, foci, and/or steering throughout an imaging field (e.g., throughout imaging depth). A 1D array has one row of elements in elevation dimension and a fixed elevation aperture size. A 1.25D array has multiple rows of elements in elevation dimension and a variable elevation aperture size, but a fixed elevation focal point via an acoustic lens. A 1.5D array has multiple rows of elements in elevation dimension, a variable elevation aperture size, and a variable elevation focus via electronical delay control. A 1.75D array is a 1.5D array with additional elevation beam steering capability. A 2D array has a number of elements in both lateral and elevation dimensions to satisfy a minimum pitch design constraint for large beam steering angles. The array may have a geometric shape or other shape to accommodate various types of non-linear probes, such as, but not limited to curvilinear, convex, phased array, intra-cavity, EBUS, EUS, IVUS and other specialty probes.

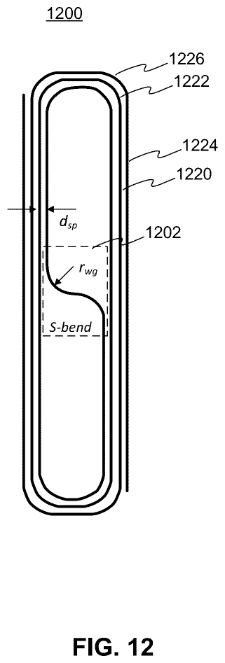

Turning now to the acoustic sensor in more detail, an acoustic responsive (AR) optical waveguide is a source of acoustic sensitivity of an acoustic-responsive optical sensor, such as a PIAS. An exemplary embodiment of an AR optical waveguide is shown in FIG. 1D. Further examples of waveguides are described herein, such as illustrated in FIGS. 12-18. The optical propagation properties of the optical waveguide change as a response to the acoustic input. For example, optical propagation properties can include how signals (e.g., light) behave while traveling through a medium, and optical propagation properties may include refractive index, optical path length, amplitude, phase, attenuation, phase velocity, distortion, dispersion, or the like. The response may be in the effective refractive index of the guided mode (e.g., or thereby the phase velocity); group velocity, the loss of the guided mode (e.g., attenuation), or the imaginary part of the mode index (e.g., due to materials); the dispersion of the guided mode, or the group velocity associated with a guided mode; which accumulate with propagation. The optical propagation properties also change as a response to physical signals, such as temperature, ambient pressure, or a change to a physical attribute of an acoustic wave. In some embodiments, responses can include a mode shift (e.g., change in frequency, depth, shape of response), a baseline drift, a mode split, and a mode broadening. For example, a change in phase velocity, waveguide loss, or waveguide dispersion can lead to a response in the interference mode of a mode shift, a baseline drift, a mode broadening, or a change of mode shape. It will be recognized that, although a longer AR waveguide benefits the acoustic sensitivity, the element outline has limited space. Thus, some disclosed embodiments include sensor layouts that efficiently use space within an element outline. The element outline presents constraints of minimum waveguide spacing and minimum bending radius while maximizing the optical path length and controlling optical loss induced by waveguide bending, propagation loss, scattering and material absorption.

The sensing optical path includes a through-elevation straight waveguide portion 132 and arc bend portion 122. For example, a straight waveguide portion may be substantially parallel with another straight portion, an adjacent straight portion, or with respect to a plurality of straight portions. Considering the large-aspect-ratio nature of the sensing outline (Wₑₗₑ>>Pitch), the major contributor to total length is multiple straight waveguides parallel with the elevation side. In this way, the elevation width of the element outline is sufficiently used with minimal bending. A fold number represents the number of through elevation straight waveguides within the element outline. In one example, the average length of the through-elevation waveguide is lₛₛ, or sensor length. For a m-fold PIAS with lₛₛ, mlₛₛ provides a reasonably good estimation of the total length of the sensing optical path with lss being less than Wₑₗₑ. For example, in FIG. 1C a schematic of a 4-fold PIAS is shown, and FIG. 1B shows a PIARA comprised of 4 PIAS. FIG. 1D shows a 7-fold PIAS, with an s-bend having a radius of curvature r_{wg}. A distance dₛₚ between straight waveguide portions 132 is also shown.

Referring to FIGS. 1E, an embodiment of a system 100 for ultrasound imaging is shown. The system 100 comprises a probe 104, a processing system 108, and a display 116. The system 100 is used to image a medium 120. For example, imaged medium may include organs, vessels, tissue, tumors, other anatomical structures, medical devices, implants, and/or non-medical devices within the medium. In some applications, the system 100 may be used to additionally visualize and/or track one or more therapeutic, surgical or diagnostic tools being moved within the medium 120 during imaging. Additionally, the system may be used for multi-dimensional sensing of physical parameters. The processing system 108 is in communication with the probe 104 and is configured to generate an ultrasound image based on the received acoustic beamforming signals. The received beamforming signals are used to generate an image and/or for measurement. The processing system may also be in communication with the probe 104 and is configured to generate data/information on physical parameters sensed.

In use, the probe 104 may be placed in vivo or ex vivo to image medium 120 as it transmits and receives ultrasound pulses, which may also be referred to as ultrasound signals. In some examples, the probe 104 may be placed externally on the imaged medium (e.g., a sample under investigation such as body tissue) as shown in FIG. 1E, or in vivo, such as endoluminal ultrasound (EUS), intravascular ultrasound (IVUS), endobronchial ultrasound (EBUS), intraoperative ultrasound for open or minimally invasive surgical procedures. In some examples, the probe 104 may include an ultrasound array with one or more elements (e.g., transducers) to output (e.g., generate) acoustic pulses and/or to receive acoustic signals (e.g., echo signals) corresponding to the acoustic pulses. For example, the ultrasound array may include one or more elements (e.g., one or more transducers for converting one or more electric signals into one or more acoustic pulses) configured to emit a set of acoustic beamforming pulses (e.g., ultrasound signals) and/or receive a set of acoustic beamforming signals (e.g., ultrasound echoes) corresponding to the set of acoustic beamforming pulses. The set of beamforming signals that correspond to the set of beamforming pulses may be used to generate an ultrasound image. In some examples, the medium 120 may comprise a non-linear medium such as, for example, a body tissue. In some embodiments with multi-dimensional sensing to detect multiple physical signals, such as temperature, ambient pressure, acoustic waves, and the like, processing of the received signals occurs, such analyzing sensor responses such as a mode shift (e.g., change in frequency, depth, shape of response), a baseline drift, a mode split, and a mode broadening.

The processing system 108 includes a transmitter 150, a receiver 154, a waveform generator 158, and one or more processors (e.g., a signal processor 162 and/or processor 166). The waveform generator 158 may be configured to generate a set of digital waveforms for acoustic beamforming pulses. One or more processors (e.g., processor 166) included in the processing system 108 may be configured to control the waveform generator 158. The waveform generator 158 may be configured to generate and send the digital waveforms to one or more of the transmitter 150 and/or a matched filter/Weiner filter. Transmitter 150 may communicate waveforms to probe 104. Receiver 154 may receive electrical signals from probe 104. In some embodiments, receiver 154 may receive optical signals from probe 104. Signal processor 162 may assist in processing received signals and/or generating waveforms. For example, signal processor 162 may provide amplification or filtering to optical signals from receiver 154.

To interrogate the optical response from the PIAS, a transduction mechanism is used. For example, an interference-based signal transduction mechanism can translate the phase response to easier detectable signals in optical power. However, the performance of transduction mechanisms like interference is sensitive to the relation between the length of AR waveguides' optical path length and the wavelength of the optical source. A simple system comprising only a fixed-wavelength laser, a steady-state PIAS/PIARA, and a photodetection module may not be able to account for possible random fabrication errors that may occur. In particular, random fabrication errors in each PIAS may lead to different requirements on optical source wavelength. To address such errors, tunability of the optical source wavelength or the optical path length of the waveguides in individual PIASs may be used. In some embodiments, one or only a few tunable optical sources are used to support a PIARA working at its optimal state. Individual tunability of each PIAS in a PIARA can be preferred in some situations. For example, acoustic-responsive sensors can be fabricated with integrated tuning devices for each sensor. Optoelectronic trace routing for a PIARA is described, where individual sensor control can be simplified. Other instances of tuning include electrooptic phase tuning, and external thin-film heaters in cases where optoelectronic trace routing is not possible. Such alternatives will be discussed later.

As will be discussed in more detail, an acoustic responsive sensor layout may be designed to efficiently use space within an element outline. In some embodiments, an acoustic-responsive sensor can be fabricated to involve tuning devices to control operation points (e.g., user-defined, computer-defined, defined according to changing properties). For example, a tuning device as described herein can be used to shift an optical power transmission spectrum of a sensor to align with a desired operation point.

### Acoustic-Responsive (AR) Optical Sensor

In some embodiments, a PIAS is manufactured in a chip-based photonics platform (e.g., silicon photonics, glass-based planar lightwave circuits, polymer integrated photonics, etc.), where the integrated optical waveguide is one of the PIAS basic building blocks.

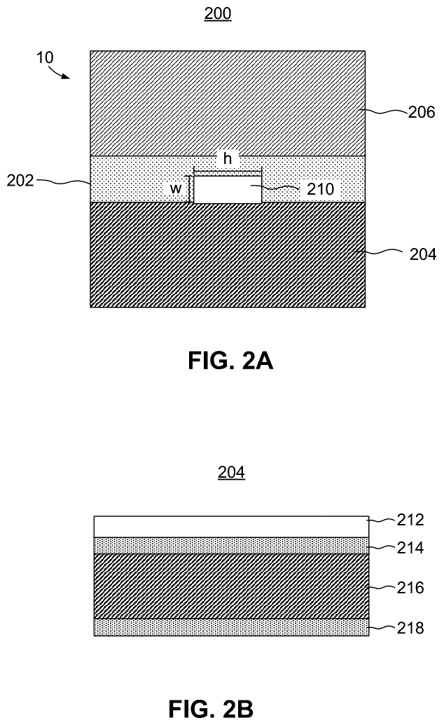

FIG. 2A depicts an embodiment of a cross-section of an AR optical sensor 200, consistent with embodiments of the present disclosure. In some embodiments, an AR optical waveguide may be used in a PIAS. An AR optical waveguide may include an acoustic stack having an optical layer 202 and a backing layer 204. In some embodiments, an AR optical waveguide may include a top layer 206. The optical layer 202 may include a core 210 of the AR optical waveguide. The core 210 may be the main body of the AR optical waveguide. In some embodiments, optical layer 202 may include a tuning device. As will be described herein, a tuning device may assist with tuning of the AR optical waveguide. In some embodiments a tuning device may be placed in optical layer 202. For example, the tuning device may be adjacent to core 210 (e.g., on top of, next to, or under). Additionally, or alternatively, one or more tuning devices may be disposed above and/or below optical layer 202. For example, a tuning device may be part of top layer 206 or the backing layer 204. In a chip-based photonic platform, the optical layer 202 can be thin (e.g., <10 um). In some embodiments, the waveguide may include one or more claddings or cladding regions. For example, a waveguide may include one or more cladding regions surrounding or encapsulating core 210. The one or more cladding regions may have an optical refractive index less than that of core 210. In some embodiments, the one or more cladding regions may include acoustic responsive materials. Additionally, or alternatively, core 210 may include acoustic responsive materials. In some embodiments, the thickness of claddings including acoustic responsive materials may be smaller than c_{ARC}/4fₕ, where c_{ARC} is the speed of sound in the acoustic responsive cladding, fₕ is the higher band edge of the ultrasound imaging band, and reading fₕ=max[3f_{c}, 10 MHz], where f_{c} is the center frequency of the ultrasound generation.

In some embodiments, an AR optical waveguide may include a top layer 206. Top layer 206 may be coupled (e.g. acoustically and thermally) to optical layer 202. For example, the top layer 206 may be disposed on top of optical layer 202. Top layer 206 may include an acoustic matching layer, RTV lens, or other interface. The configuration of top layer 206 can depend according on the packaging of the AR sensor. In some embodiments, top layer 206 may include an interface that can contact imaged medium 120. In some embodiments, top layer 206 may be shaped or otherwise configured to steer, focus, transmit, or enhance signals transmitted or received, such as acoustic signals received from imaged medium 120. In some examples, the top layer 206 may be an acoustic matching layer. In such an example, backing layer 204 and top layer 206 may assist in effective coupling of the incident acoustic field to the optical layer 202 with reduced or no echo or ring-down after the incident field passes through these layers. In this way, the AR waveguide responds to only a single-pass acoustic input, which is useful for a broad responsive bandwidth (up to 100 MHz level) of the AR waveguide. In some embodiments, top layer 206 may include one or more tuning devices. For example, top layer 206 may incorporate an external heater configuration above the optical layer 202, with 10-200 um extra thickness as will be discussed herein.

Optical sensor 200 may include a backing layer 204. Backing layer 204 may provide mechanical support for optical layer 202. In some embodiments, backing layer 204 may include a substrate layer 212. For example, substrate layer 212 may include a chip substrate, and core 210 may be disposed on substrate 212. In some embodiments, an AR optical waveguide may include a backing block. For example, backing layer 204 may include a backing block 216, as referenced in FIG. 2B. To avoid reflection from the bottom side of the substrate, an acoustic attenuation layer, referred to as a backing block, with the matched acoustic impedance can be used below the substrate. In some embodiments, extra supporting layers, as a part of the backing layer, may be included between the backing block and the substrate/optical layer. Those supporting layers, together with the chip substrate if applicable, provide thermo-mechanical support to the optical layers and the packaging assemblies of optical and electrical cables.

In some embodiments, a backing layer may include one or more sub-layers, such that the backing layer is a multi-layer backing layer. FIG. 2B depicts a multi-layer backing layer. For example, backing layer 204 may include one or more substrate layers and a backing block 216. Supporting substrate layer 214 may be introduced between a chip substrate layer 212 and the backing block 216 to provide thermo-mechanical support. Backing block 216 may improve resolution by dampening vibrations and reflections. In some embodiments, the backing block is a loaded polymer structure such as epoxy combined with tungsten or aluminum oxide, that has high attenuation such that it can absorb and attenuate ultrasound energy. Additionally, or alternatively, backing layer 204 may include a supporting substrate layer 218 disposed below backing block 216 to provide thermo-mechanical support. Supporting substrate layer 214 or 218 may include (e.g., for a silicon chip substrate) silicon, aluminum, and/or impedance-matched ceramics. In some embodiments, acoustic impedance of supporting layers (e.g., supporting substrate layer 214 or 218) may have an acoustic impedance that matches an acoustic impedance of other layers or backing block 216 in the backing layer 204. For example, if the layers are within the acoustic path, (e.g., below the acoustic sensors), the supporting substrates layers 214 or 218 may have an acoustic impedance matched to the chip substrate layer 212 and/or the backing block 216. However, it will be appreciated that acoustic attenuation is optional for supporting layers.

In some configurations, for a chip-based photonic platform, the optical layer 202 may be fabricated based on a substrate layer (e.g. the handle layer of silicon-on-insulator (SOI) wafer). The substrate may be treated as a part of the backing layer 204 and can be characterized by an acoustic impedance. For example, in current medical ultrasound imaging, the frequency range is usually in the range of 2-20 MHz and generally no higher than 100 MHz. Acoustic harmonics may be higher than 60-80 MHz, up to 100 MHz. Thus, with 100 MHz as an estimated upper limit of the receiving bandwidth of a PIAS with few-μm-level optical layer, the thickness of the substrate may be roughly 0.1 to 2 mm in the aforementioned example. This is comparable to the acoustic wavelength in the substrate material, like silicon, making it an acoustically bulky material in the acoustic stack.

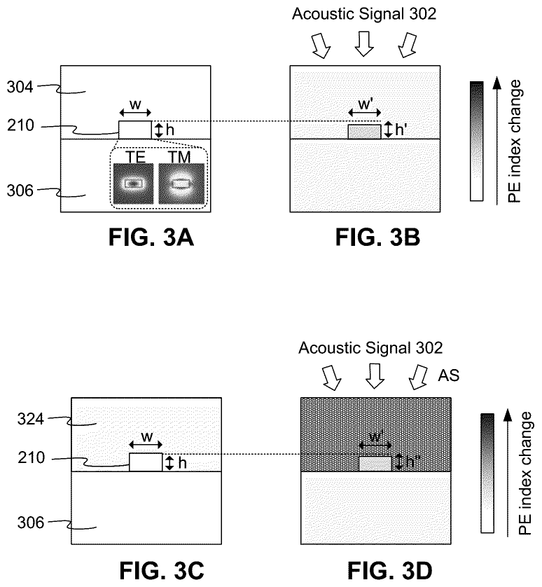

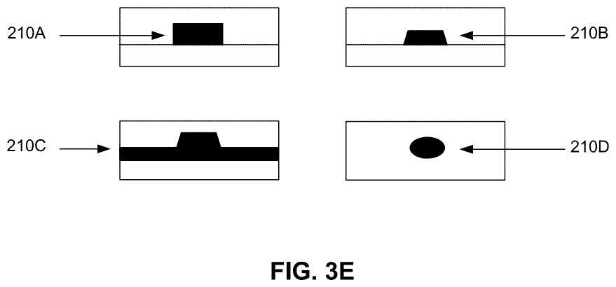

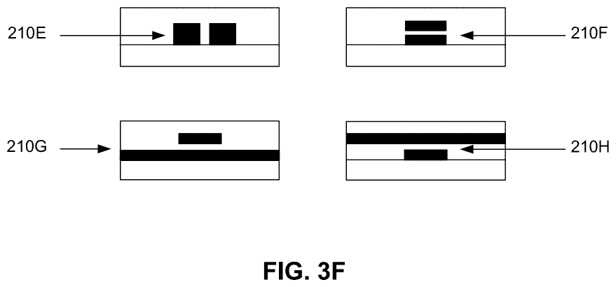

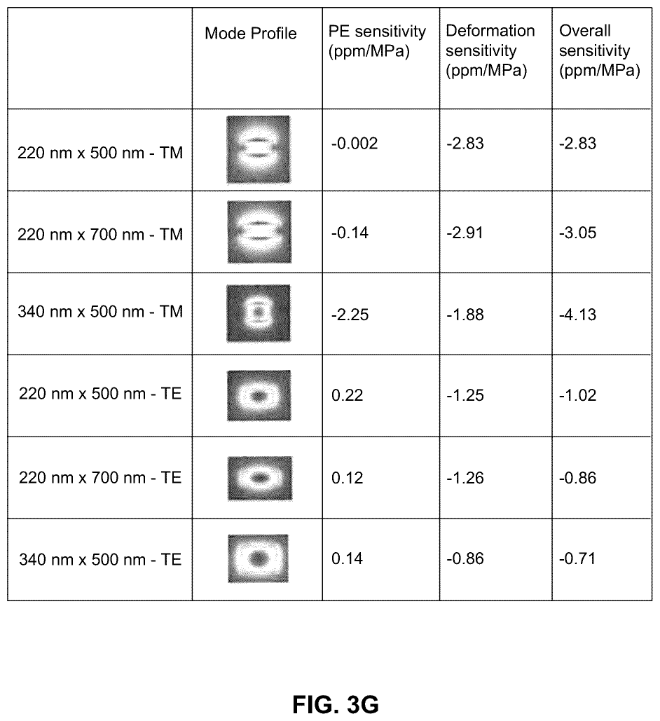

FIGS. 3A-3G illustrate sensor responses and waveguide cores, consistent with embodiments of the present disclosure. FIG. 3A and FIG. 3B depict an embodiment of a cross section of an AR waveguide in the optical layer in response to an incident acoustic signal 302. In some embodiments, an AR optical sensor may include one or more cladding regions. AR optical waveguide core 210 may be surrounded by a cladding material 304 and 306 having a refractive index lower than the refractive index of the core 210. Light in the visible, near-infrared, and/or telecommunication bands may be used and, the dimension of the core may be in micron or sub-micron wavelength levels. For example, a C-band single-mode silicon waveguide with an oxide substrate and cladding could have a core size of 500 nm×220 nm. In some embodiments, the acoustic frequency used in ultrasound imaging is <100 MHz. In solid materials, the acoustic wavelength can be much larger than the cross-sectional dimension of the optical core. It will be appreciated that smaller dimensions of the waveguide as compared to the acoustic wavelength can enable the integrated optical waveguide to be a broadband acoustic responsive structure. In some embodiments, acoustic coupling from a target to the sensor array involves a matching layer, as described herein (e.g., an echo field as an acoustic signal passes through the optical layer, which is acoustically thin, reducing distortion, filtering and/or ring-down).

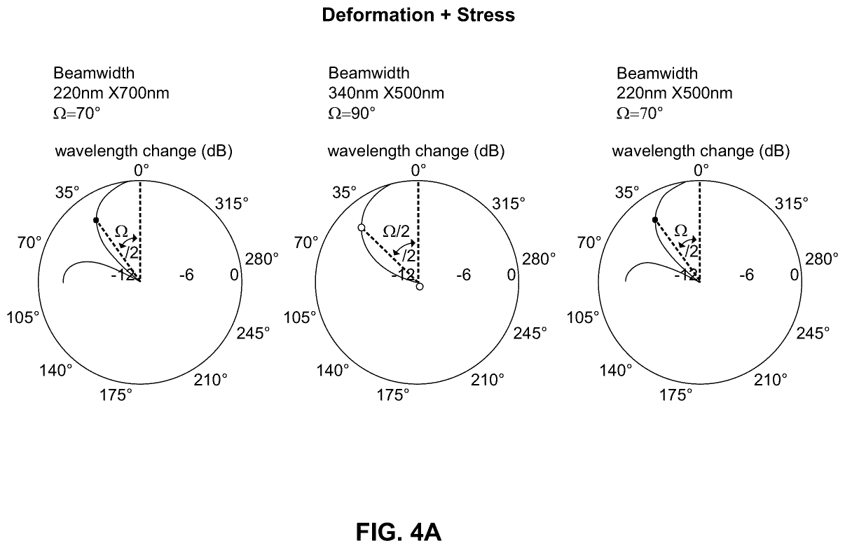

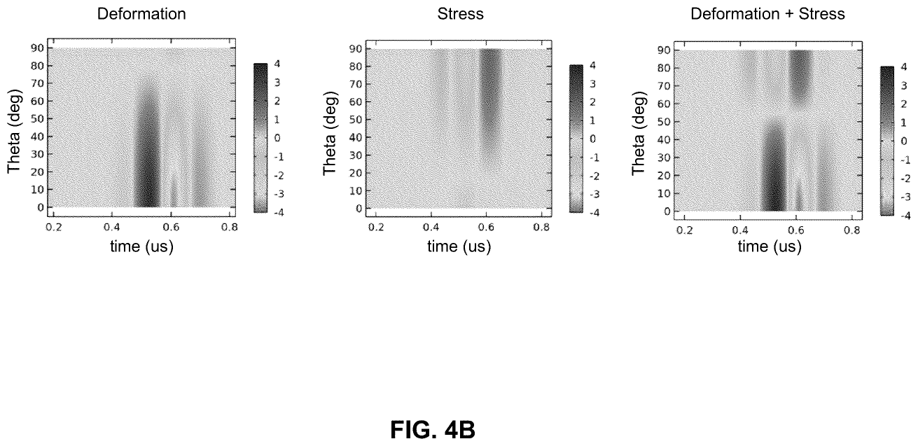

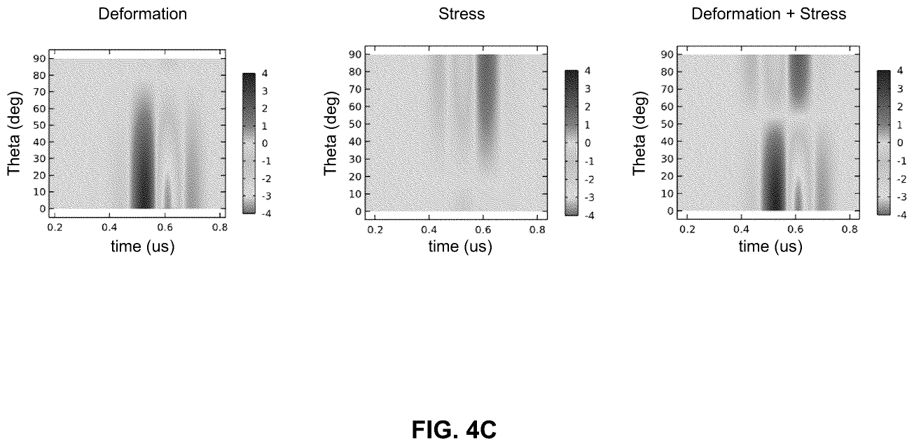

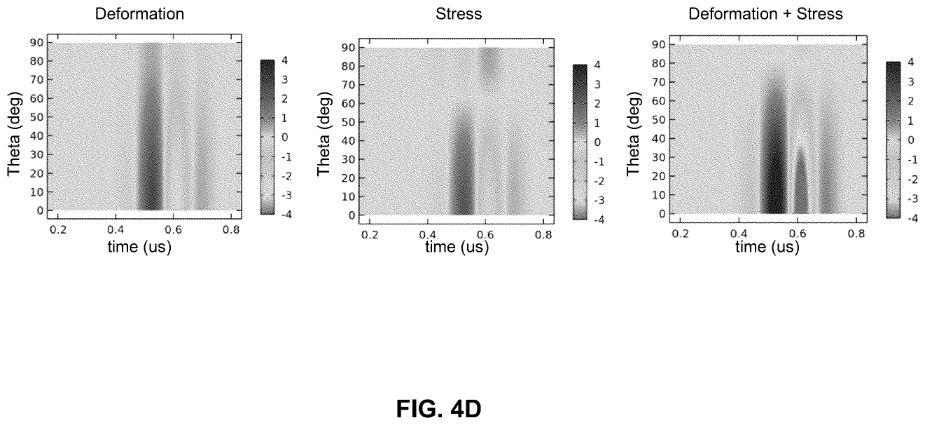

In some embodiments, the AR optical waveguide core 210 may have different cross-section shapes (such as rectangular, ridge and ellipse) and/or comprise a plurality of sub-cores with local maximum of optical field. The sub-cores of an AR waveguide may have the same or different materials, and their relative position may be designed to ensure the optical field is primarily distributed in the plurality of sub-cores and part of the cladding. FIGS. 3E and 3F depict different shaped examples of waveguide core cross sections, consistent with embodiments of the present disclosure. FIG. 3E illustrates an optical layer (e.g., optical layer 202) of cores having a rectangular 210A, trapezoidal 210B, ridge-shaped 210C (e.g., including one or more tapered edges), or elliptical 210D cross-section. One or more cladding surrounds all or a portion of the cores depicted in FIG. 4C. In some instances, the core may be suspended and not fully surrounded by a cladding or other material. FIG. 3F depicts examples of different sub-core structures such as vertical slot 210E, horizontal slot 210F, heterogeneous integrated at bottom 210G and 210HF heterogeneous integrated on top. In the waveguide cores involving sub-cores, the guided optical mode of the waveguide may be largely distributed in the slot between the sub-cores.

In some embodiments with AR waveguide with sub-cores, the optical field distribution tuned by sub-cores may benefit the sensitivity of the acoustic detection, because more field may be distributed in the AR cladding. In some embodiments, the AR waveguide may be adjacent to non- solid-state materials such as gas or liquid, or to soft materials including polymers. The inclusion of non-solid-state materials typically increases flexibility of the structure and thus the deformation sensitivity to acoustic signals, and the soft materials may increase both the deformation and photoelastic sensitivity (e.g., acting like AR cladding). The depth of the non-solid-state material or soft material should be thin enough to maintain a broad detection bandwidth. It will be appreciated that the total thickness of each type of AR waveguide should be in compliance with the thickness design constraints of the optical sensor.

Returning to FIGS. 3A and 3B, incident acoustic signal 302 (e.g., an acoustic wave) creates a spatiotemporal mechanical field in the waveguide cross-section. Materials forming the waveguide cross-section respond to the mechanical field via Photoelastic (PE) Effect (e.g., the refractive indices of the materials change with the stress field). Additionally, the mechanical field deforms the waveguide structure. Both the PE effect and the waveguide deformation initiate an optical response of an AR optical waveguide. The acoustic sensitivity of an AR waveguide, denoted as s, linearly translates an incident acoustic field, measured by a pressure pᵢₙ, to the change of the optical mode index neff, written as Δneff=s·pᵢₙ. As light propagates within an AR optical waveguide, the response in the mode index generates a response in optical phase via the acoustic responsive phase velocity vphase=c/neff.

FIGS. 3A and 3B provide a schematic of mechanisms in an integrated waveguide. The incident acoustic signal 302 induces the refractive index change of claddings 304, 306, and the core 210. The incident acoustic signal leads to an overall deformation of the core cross-section structure. The properties (e.g. phase velocity) of the optical mode respond to the change in dimensions and material indices of both the core and claddings in real-time. For example, with a typical single-mode silicon rectangular core in oxide cladding, an optical mode may be primarily sensitive to deformation of the core, and with a normally-incident acoustic signal, the change is mostly in the thickness of the waveguide core 210.

In some embodiments, an acoustic responsive material can be used as cladding to enhance sensitivity of an AR waveguide. FIG. 3C depicts an embodiment of a cross section of a waveguide with an acoustic-responsive cladding 324. FIG. 3D depicts an embodiment of the cross section of a waveguide with the acoustic-responsive cladding 324 in response to the acoustic signal 302. The AR waveguide in FIG. 3D with the acoustic-responsive cladding 324 has a higher response to the incident acoustic signal 302 than the AR waveguide 310 in FIG. 3C.

When designing an AR optical waveguide, numerical simulation can be used to evaluate and understand how sensitivities (e.g., PE sensitivity and deformation sensitivity) manifest themselves in propagation parameters of one or more optical modes. The following are four considerations that may guide designing the AR optical waveguide in order to optimize the AR optical waveguide:
(1) Mode Overlap Factor. As shown in the inset of FIG. 3A, the EM (Electro Magnetic) mode interacts with three regions of the waveguide: the core 210, cladding 304 (e.g., covering the top and sides of the core), and cladding 306 (e.g., silicon dioxide from a buried oxide layer of an SOI wafer). Both polarization and waveguide geometry can affect mode overlap, which can be characterized by a mode effective index n_{eff}.
(2) Mode Deformation Sensitivity. Generally, a weakly-confined optical mode is more sensitive to waveguide deformation. In practice, confinement can be tailored by polarization selection and waveguide geometry engineering.
(3) Tensor nature of PE effect: A material's PE effect has a tensor nature. Thus, PE effects of EM modes with different polarizations are governed by different PE coefficients (e.g., even with the same mechanical field distribution). Additionally, a change of the refractive index material varies with an orientation of the stress field.
(4) Directionality of deformation: deformation sensitivity inherits a directionality from the geometry of the waveguide cross-section, which can be quantitatively evaluated using a numerical simulation of the solid mechanics.

The considerations above can couple with each other in a complex way and result in a case-by-case overall acoustic response. For example, PE sensitivity and deformation sensitivity do not necessarily add up for all types of waveguides. When PE sensitivity and deformation conflict with each other, reduced sensitivity or vanishing acoustic response with an angled incident can result. The acoustic response could be characterized by the mode effective index change relative to the mode group index, or

$${S}_{ARW g} = \frac{1}{{n}_{g}} \frac{\partial {n}_{eff}}{\partial p} ,$$

where p is the acoustic pressure. The defined waveguide sensitivity has a unit of ppm/MPa (part per million/Mega Pascal).

These considerations can assist in selecting an arrangement that optimizes the sensitivity. The following non-limiting simulation shows how in certain embodiments the PE sensitivity and deformation sensitivity may cancel each other out at a specific incident angle and how to optimize the sensitivities.

Example 1: TE (transverse electric) and TM (transverse magnetic) waveguide sensitivity simulation. In the simulation, Oxide is used as cladding with a normal incident acoustic wave. Exemplary cladding materials can include silica (e.g., fused silica) as well as plasma-enhanced chemical vapor deposition (PECVD) oxide.

FIG. 3G depicts a table showing several TE and TM sensitivities. TM waveguides are more sensitive. A SOI system with oxide cladding is an integrated photonic platform to realize integrated AR waveguides. In some embodiments, rectangular waveguide cores, also known as strip waveguides, are fabricated in a device layer of an SOI wafer, the device layer having a thickness of 220 nm or 340 nm. The width of the waveguide is user-defined, and both TE and TM polarization can be selected as the operation polarization. In the table illustrated in FIG. 3G, six modes with different waveguide dimensions and polarizations are simulated and compared. It should be noted that a plane-wave normally incident acoustic input is assumed in the simulation. The overall waveguide sensitivity of TM modes is significantly higher than TE modes, mainly due to the high deformation sensitivity and the fact that the signs of both sensitivities are the same. It will also be recognized that although the overall S_{ARW g} among the three TM mode examples are similar, the contributions from the two types of sensitivities may be different, which could lead to different sensing performances with angled acoustic input.

Due to the tensor nature and the lack of rotation symmetry of waveguide cross-sections, both PE and deformation sensitivity have directional variation. In other words, even with an omnidirectional coupling of the incident acoustic field into the optical layer, the AR waveguides possess a directionality in their acoustic sensitivity, known as the intrinsic directionality of AR waveguides. Moreover, in some embodiments, PE sensitivity and deformation sensitivity may cancel each other at a specific incident angle, i.e. creating sensitivity zeros at some incident angle. As shown in FIG. 4A, sensitivity zeros and intrinsic directionality are shown for three waveguide dimensions of 220 nm×500nm, 220×700 nm, and 340 nm×500 nm. The intrinsic directionality of such mode in the AR waveguide limits the 3 dB acceptance angle to 70 degree (+−35 degree), For example, the TM mode of 500 nm×220 nm Silicon waveguide in oxide cladding has a sensitivity zero at 50 degrees with respect to normal incidence, beyond which the overall sensitivity has a reversed sign, as shown in FIG. 4B. For the TM mode of 700 nm×220 nm silicon waveguide in oxide cladding, as shown in FIG. 4C, the angular dependence of the two types of sensitivity is similar, leading to an overall sensitivity zero at +−50 degree and 3 dB acceptance angle of 70 degree (+−35 degree). However, the TM mode of 500 nm×340 nm silicon waveguide shows different intrinsic directionality due to the different contribution from the two types of sensitivity. No sensitivity zeros with sign reversion occurs within +−90 degree span, and the intrinsic directionality lead to a 90 degree (+−45 degree) 3 dB acceptance angle as shown in FIG. 4D.

In some embodiments, simplifying design and evaluation of an acoustic responsive waveguide, can involve letting one type of sensitivity dominate over the other one.

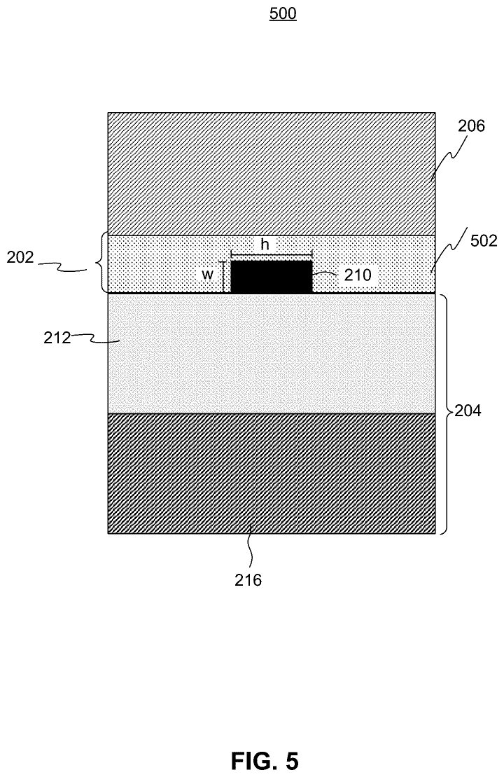

AR materials can be used to greatly enhance the PE sensitivity to achieve such dominance. Polymers (e.g., acrylate and epoxy) usually have high PE coefficients, making them good candidates for AR materials that could boost the overall sensitivity of the AR waveguide. Moreover, due to their molecular structures, their PE tensors show higher uniformity than those of other optical materials like glass, silicon, etc. Therefore, an ultra-wide-angle sensitivity might be realized, given the wide-angle acoustic coupling. While core, cladding, or substrate could be made from AR materials, an AR top cladding (e.g., cladding 324) is shown in FIG. 5. Introduction of AR materials can be performed as a back end of the line (BEOL) process, which can increase compatibility with semiconductor fabrication processing. In some embodiments, AR materials could be introduced into the wafer prior to the patterning of waveguides, and form or partially form the core or cladding of the AR waveguides.

FIG. 5 depicts an embodiment of a cross section for AR optical sensor 500, consistent with embodiments of the present disclosure. Sensor 500 may include an optical layer 202 and a top layer 206. The backing layer 204 may include a substrate 212 and a backing block 216, as described herein. Backing layer 204 may be characterized by a first impedance value. The first impedance value is an acoustic impedance, shared by sub-layers (e.g., such as a chip substrate layer and supporting layers). During ultrasound sensing and imaging, the acoustic signal is generated within the imaged medium 120 (such as a target of patient's tissue), which is characterized by a second impedance value. The second impedance value is an acoustic impedance. The second impedance value is less than the first impedance. In some embodiments, a top layer 206 is introduced to provide the required acoustic impedance gradient for the reflected acoustic waves so that majority of the acoustic power could be transmitted into the optical layer 202 and detected by AR waveguides. For example, top layer 206 may include an acoustic matching layer, such that top layer 206 has an acoustic impedance value that is between the second acoustic impedance value (e.g., corresponding to imaged medium 120) and the first acoustic impedance value (e.g., corresponding to the backing layer 204). Top layer 206 may be an acoustic matching layer and include one or more layers of epoxy, polyurethane, polystyrene, or other suitable material with a desired acoustic impedance. In some embodiments, the thickness of top layer 206 may be configured to facilitate acoustic transmission from the imaged medium to optical layer 202. It should be noted that the enhanced transmission of matching layer usually only occurs within a certain frequency band (60%-80% relative bandwidth). The ultra-broad bandwidth of AR waveguides (up to 100 MHz) may be narrowed by the matching layer. However, in some clinical ultrasound imaging scenarios, only ultrasound signal within 2-20 MHz may be of interest. A matching layer could effectively benefit the imaging quality by enhancing the acoustic transmission to the receivers. It will be appreciated that different values of matching layers can be used for different applications. In some embodiments, sensor 500 include a tuning device and optical waveguide in a single layer in a photonic chip. For example, an integrated tuning device may be disposed in optical layer 202, and the corresponding optical waveguide may have a mode refractive index that can be tuned as described herein. Additionally, or alternatively, the tuning device and the optical layer may be disposed in separate layers. For example, top layer 206 may include a tuning device (e.g., an external heater) that may be adjacent to the optical layer 202, and the tuning device may introduce a change in mode refractive index in the optical layers as described herein.

In some embodiments, the top layer 206 is attached to the optical layer 202 with an external adhesive layer 502. The thickness of the extra adhesive layer can be selected to be acoustically negligible, e.g., much smaller than 5% of the wavelength of the highest ultrasound frequency of interest for the application scenario. In some configurations, a thickness of <5 μm is preferred for adhesive layer 502. In some embodiments with AR top cladding, the cladding layer could serve as the adhesive layer. For example, adhesive layer 502 may be a cladding layer. In addition, top layer 206 may act as a top lid for the AR cladding, which could be used to define the thickness of the cladding layer uniformly. Top layer 206 also provides protection to the AR top cladding during the packaging and assembly processes.

In some embodiments, a PIAS comprises a silicon TM single-mode waveguide in oxide (e.g., based on a 220-nm thick device layer in a silicon-on-insulator wafer). TM modes in 220-nm thick waveguides may have a significant evanescent EM field in oxide cladding and substrate (e.g., as shown the in inset of FIG. 3A). During a linear scan, a common ultrasound imaging scenario, an echo signal incident from a near-normal angle induces mechanical fields roughly in parallel with the optical EM field. On one hand, the relatively weak-confined TM mode is highly sensitive to the deformative perturbation in the waveguide thickness. On the other hand, the PE effect in the silicon core has an opposite sign to that in an oxide cladding and substrate, greatly suppressing the PE sensitivity. However, with an angled acoustic input, deformation sensitivity may be reduced due to the weaker mode sensitivity to the horizontal deformation. Additionally, the net PE sensitivity starts to increase due to the involvement of other elements in the PE coefficient tensors, and it has an opposite sign to the deformation sensitivity. As a result, the waveguide has a zero in sensitivity with angled input. Therefore, TM thin silicon waveguides in oxide have a deformation-dominant strong acoustic response with near-normal acoustic input and have a zero in the waveguide response directionality. Considering a lower waveguide loss of TM modes than TE modes in this platform, some disclosed embodiments involve a TM mode waveguide with a 220 nm SOI platform for linear-scan ultrasound imaging applications. Though 220 nm platform thickness is discussed as an example, other thicknesses can be used.

It will be appreciated that proper design of AR waveguides can increase or maximize the response in optical mode index, or Δneff. With a waveguide length of L, the phase response reads ΔneffLω/c, where ω is the angular frequency of the light and c is the speed of light. Additionally, phase noise from fluctuation of the optical environment (material, structure, etc.) accumulates along the propagation following √L. As a result, the signal to noise ratio (SNR) of the phase response in an AR waveguide is proportional to √L. Therefore, longer AR waveguides could provide higher acoustic sensing SNR.

### Interference-Based Signal Transduction Mechanisms

It will be recognized that routing waveguides might not generate a readable acoustic-power signal, even though the waveguide responds to acoustic signals in phase. As discussed herein, an interference-based signal transduction mechanism can be used to translate the phase change of an incident acoustic signal induced phase change into a more readable optical power signal. When forming a PIAS, the interference-based signal transduction is arranged to occur within the element outline. In this way, the acoustically induced phase change within the element outline can be translated into optical power signal.

In a photonic integrated acoustic receiving array for ultrasound imaging, the sensitive aperture of each sensor may serve the acoustic design of the whole imaging transducer. Optical ports (e.g., one optical input port and one optical outport port) and, optionally, electrical ports (e.g., electrical input and electrical output ports if tuning devices are applied) are set on the boundary of the edge of the sensing aperture, connecting acoustic responsive waveguides to routing waveguides. Optical waveguides, including the acoustic-responsive waveguides and the routing waveguide, exposed to the incident acoustic field can generate phase response when transmitting optical signals. It will be appreciated that waveguides sandwiched by the optical ports will generate readable optical amplitude signals, as the optical interference occurs within/at the optical output port in some embodiments. Such interference can define the coverage of waveguides and isolate unwanted acoustic response and noise accumulation outside the waveguides.

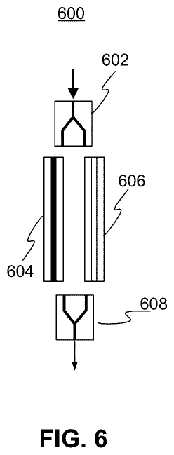

Examples of signal transduction layouts are shown in FIGS. 6-8. Acoustic responsive waveguides that contribute to readable optical power signal are schematically shown as a wide stripe within a rectangular outline. In some embodiments, both curved parts and straight parts are included in AR waveguides. In the disclosed embodiments, optical interference may occur between light propagating through waveguides, as well as propagating light that recircles in a closed-loop waveguide.

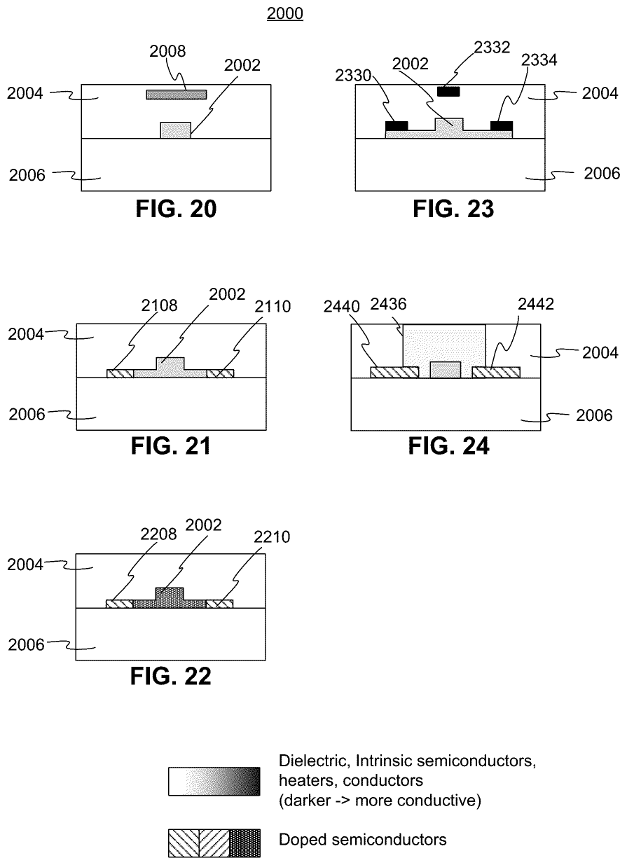

FIG. 6 depicts an embodiment of an interferometer sensor 600, consistent with embodiments of the present disclosure. As described herein, interferometer sensor 600 may include a Mach-Zehnder interferometer(s), a Michelson interferometer(s), a Fabry-Perot interferometer(s), a Sagnac interferometer(s), and/or the like. For example, a Mach-Zehnder interferometer may include two nearly identical optical paths (e.g., fibers, on-chip silicon waveguides, etc.). The two optical paths may be finely adjusted by acoustic waves (e.g., by physical movement caused by the acoustic waves, tuning of refractive index caused by the acoustic waves, etc.) to effect distribution of optical powers in an output(s) of the Mach-Zehnder interferometer, and therefore, detect a presence or a magnitude of the acoustic waves. Interferometer sensor 600 may be an interferometer comprising one or more couplers 602 and one or more AR optical waveguides. For example, interferometer sensor 600 may include a first arm 604 and a second arm 606 that both include AR optical waveguides. First arm 604 may be a reference arm and second arm 606 may be a sensing arm, or vice-versa. In some embodiments, first arm 604 and/or second arm 606 may include a tuning device, as described herein (e.g., with reference to FIGS. 20-35). In some embodiments, an interferometer may include a waveguide coupled to an optical port, which may be an optical input port or an optical output port. In some embodiments, the optical port may be both an optical input port and an optical output port (e.g., in an example involving reflectors). In some embodiments, a waveguide may be disposed between an input port and an output port. For example, first arm 604 and second arm 606 may be coupled to an optical input port via a coupler 602, as well as coupled to an optical output port via an additional coupler, such as second coupler 608. For example, coupler 602 may be a 1×2 coupler such as a splitter, and coupler 608 may be a 2×1 coupler such as a combiner. The two arms may have different design parameters so the phase response from them will not cancel out during interference. For example, the two arms may have (1) the same waveguide design with different lengths; (2) different waveguide design with similar length; and/or (3) different waveguide design with different lengths. In particular, case 1 uses the acoustic sensitivity of one waveguide design. To increase or maximize performance, the length difference between the two arms could be increased or maximized. Case 2 can be used when the combination of the acoustic sensitivity from the two waveguide designs is desired to achieve a special performance use (e.g., ultra-wide acceptance angle). Case 3 can be used when the longer arm (e.g., used as the sensing arm) provides the sensitivity while the shorter arm (e.g., used as a reference arm) provides other functionality (e.g., tunability).

In some embodiments, the AR optical waveguides of first arm 604 and/or second arm 606 may include a cladding or cladding regions. As an example, first arm 604 may be a reference arm, and include an acoustic responsive material. In the example, the waveguide in FIG. 3A can be used as a waveguide design for the reference arm in an interferometer and the waveguide in FIG. 3C can be used as a waveguide design for the sensing arm in the interferometer (e.g., because the waveguide design of FIG. 3C uses acoustic-responsive material for cladding 324 to increase sensitivity). However, it is understood that both arms may have the same cladding 304 as depicted in FIG. 3A or acoustic responsive material 324 in FIG. 3C. In an example, first arm 604 may be a reference arm optical waveguide including acoustic-responsive material, and second arm 606 may be a sensing arm optical waveguide with a tuning device disposed adjacent to an optical core. In an alternative example, first arm 604 may be a sensing arm optical waveguide including acoustic-responsive material, and second arm 606 may be a reference arm optical waveguide with a tuning device disposed adjacent to an optical core.

In using the MZI configuration, it will be appreciated that a larger length difference between the two arms provides a higher transduction sensitivity (% trans/nm shift); different sensitivity (sign, directionality) can be combined in one MZI; and/or if sensitivity of one arm dominates over the other, the net sensitivity of the interferometer is mostly provided by the dominating arm. As such, elongating the dominant arm can be beneficial, in some embodiments. In some embodiments, claddings and tuning devices may be placed in different arms of interferometer 600. For example, due to the incompatibility of some fabrication processes (e.g. polymer cladding and thermal heater above the waveguide), the tuning device can be assigned to another arm (e.g., a non-dominating arm).

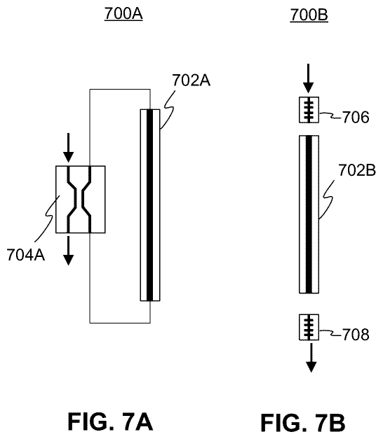

FIG. 7A depicts an embodiment of a waveguide ring resonator sensor 700A, consistent with embodiments of the present disclosure. Sensor 700A includes a resonator body 702A and a coupler 704A. Resonator body 702A may include an optical AR waveguide, and the AR waveguide may be coupled to an optical input port and output port with the coupler 704A (e.g., a 2×2 coupler). Sensor 700A may be an implementation of a resonator working as an all-pass resonator (e.g., the resonator has an all-pass configuration). It will be appreciated that while many types of acoustic responsive waveguides could be introduced, the interface between different waveguide types can reduce transduction sensitivity. In some embodiments, only one type of acoustic responsive waveguide is involved to form the resonator sensor 700A. In other embodiments, multiple types of AR optical waveguides may be involved, such as when the resonator circulation loss is so large that the transition losses do not significantly add to it. The transduction mechanism in such a resonator is similar to FIG. 6, in the case of an MZI with a periodical elongation of the interferometer with a zero-length reference arm. The resonator configuration could effectively realize a long-arm difference within a small footprint. This case can be considered as a hybrid resonator and interferometer case.

FIG. 7B depicts an embodiment of a waveguide resonator sensor 700B, consistent with embodiments of the present disclosure. Resonator sensor 700B may include one or more reflectors and a resonator body 702B having an AR optical waveguide. In an example, resonator sensor 700B may include a first reflector 706 and a second reflector 708. Reflectors 706 and/or 708 may be configured such that an optical signal is redirected. Sensor 700B may be an example of a Fabry-Perot cavity with an acoustic responsive waveguide as the cavity body. In sensor 700B, the phase change in the acoustic responsive optical waveguide effectively accumulates during multiple reflections, and the multiple reflected optical fields coherently sum up at the output port leading to a readable signal in optical power.

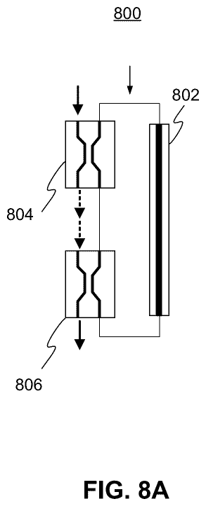

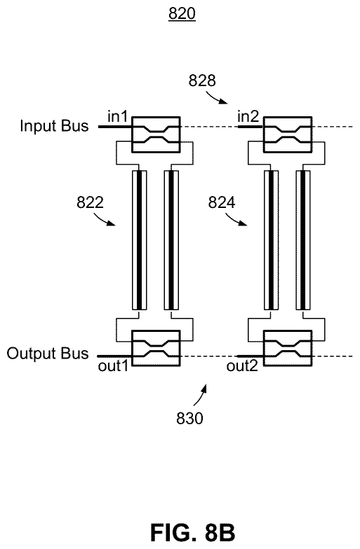

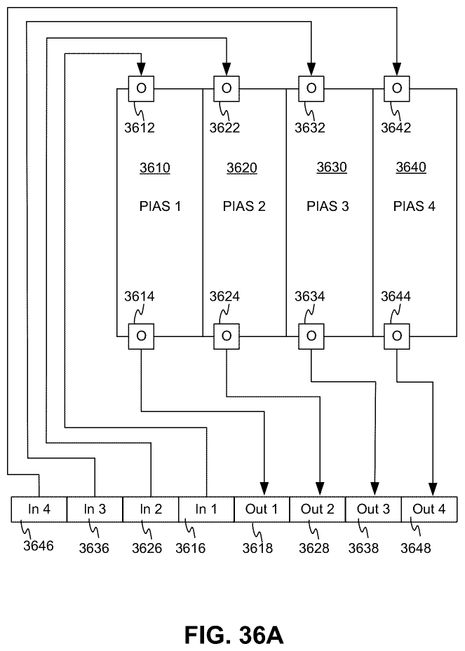

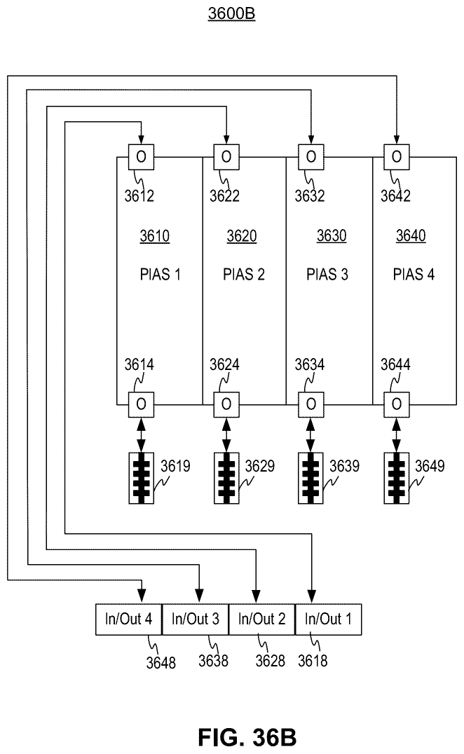

FIG. 8A depicts an embodiment of a resonator sensor 800, consistent with embodiments of the present disclosure. Resonator sensor 800 may include a resonator body 802 having an AR optical waveguide that may be coupled to a plurality of optical input and output ports with a plurality of couplers 804, 806. Resonator sensor 800 may be an exemplary implementation of an add-drop configuration, also known as an add-drop resonator. Resonator sensor 800 may include two couplers 804 and 806, which may be 2×2 couplers. Compared to an all-pass resonator/configuration, an add-drop resonator has near-zero optical power transmission when it operates off-resonance. In addition, add-drop resonators have more ports for multiple inputs and outputs, which could enable multiplexing of high-order modes, wavelength, or the like., which could enhance the signal-to-noise performance of the PIAS. FIG. 8B depicts an example of a routing configuration 820 known as shared bus. Routing configuration 820 may be an implementation of all-pass configuration and add-drop configuration. Routing configuration 820 may link multiple sensors together. For example, optical inputs 828 and outputs 830 for a first AR optical sensor 822 and a second AR optical sensor 824 can be linked together, forming shared bus waveguides, labelled by dashed lines in the figures. It will be appreciated that light waves with different optical modes (e.g. different wavelengths or mode orders) may be designed for each PIASs to avoid unwanted cross-talk and insertion loss by the shared bus configuration. For example, the shared bus waveguides could be treated as power branching or wavelength branching devices described later with respect to FIGS. 36-38.

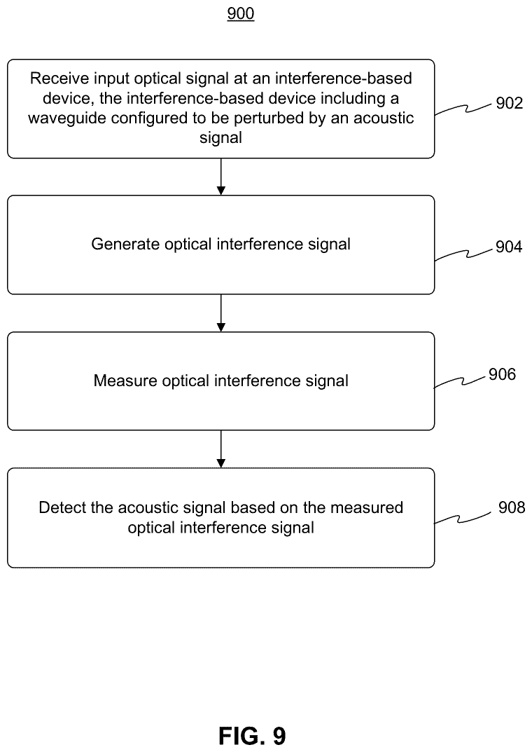

FIG. 9 illustrates a flowchart of a process 900 for imaging a medium, consistent with embodiments of the present disclosure. In some embodiments, process 900 may be described with reference to an interferometer (e.g., interferometer 600) and/or implemented using an interferometer, as described herein. Additionally, or alternatively, process 900 may be described with reference to a resonator (e.g., resonator sensor 700A, 700B, or 800) and/or implemented using a resonator, as described herein.

In some embodiments, process 900 includes a step 902 of receiving an input optical signal

at an interference-based device. An interference-based device may include any device or component configured to use interference for measuring, generating, or detecting signals. The interference-based device may include one or more optical waveguides coupled to an optical port, such as an optical input port, an optical outport port, or an optical port configured to be both an optical input port and an optical output port. In some examples, waveguides can be coupled to a port via a coupler. In some embodiments, a first optical waveguide in an interference-based device may have different properties than a second optical waveguide in the same interference-based device. For example, waveguides may have differing lengths or differing acoustic sensitivities due to, among other influences, polarization of the waveguide mode (e.g., TE mode, TM mode), differing dimensions of waveguide cores or subcores, acoustic responsive materials for waveguides cores or subcores, acoustic responsive materials for claddings, or tuning devices that can tune the waveguide.

In a first example, step 902 may include receiving an input optical signal at an interferometer. The interferometer may include a reference arm optical waveguide and a sensing arm optical waveguide. In some embodiments, the sensing arm optical waveguide may be configured to perturbed by an acoustic signal from an imaged medium (e.g., imaged medium 120). The reference arm optical waveguide and the sensing arm optical waveguide may be coupled to one or more optical ports. For example, the reference arm optical waveguide and the sensing arm optical waveguide may both be coupled to a first coupler that is coupled to an optical input port, as well as a second coupler that is coupled to an optical output port. In some embodiments, the sensing arm and/or the reference arm optical waveguides may include a cladding. In some embodiments, the sensing arm and/or the reference arm optical waveguides may include a tuning device. For example, the tuning device may be disposed adjacent to an optical core.

In a second example, step 902 may include receiving an input optical signal at a waveguide resonator. A waveguide resonator may include a resonator body, and the resonator body may include one or more optical waveguides. The one or more optical waveguides may be coupled to one or more couplers. The waveguide resonator may also include a tuning device, such as a tuning device disposed adjacent to an optical waveguide. In some embodiments, a coupler may be coupled to an input optical port and an output optical port. Step 902 may involve receiving the input optical signal at the input optical port of the waveguide resonator. In some embodiments, multiple waveguide resonators may share an input bus, and the input optical signal may be received at the shared bus.

In some embodiments, process 900 includes a step 904 of generating an optical interference signal. The optical interference signal may be generated with the interference-based device. As described herein, the acoustic signal may perturb the optical waveguide (e.g., due to the photoelastic effect and/or waveguide deformation). In some embodiments, the optical interference signal may be generated due to optical interference occurring between light propagating through waveguides (e.g., in response to the perturbation). In some embodiments, the optical interference signal may be generated due to optical interference occurring between light propagating in roundtrips of a closed-loop waveguide (e.g., such as a closed loop resonator).

For example, step 904 may involve generating an optical interference signal with the interferometer. For example, an optical interference signal may be generated due to interference between the reference arm and the sensing arm. The optical interference signal may encode a change in an optical propagation property of the sensing arm optical waveguide based on the perturbation due to the acoustic signal. The optical propagation property changed can include one or more of a refractive index, an optical path length, a, an amplitude, or a phase.

In another example, step 904 may involve generating the optical interference signal with the waveguide resonator. For example, light travelling in a closed loop resonator, can cause interference, thereby generating the optical interference signal. In some embodiments, a waveguide resonator may include one or more reflectors, and step 904 may include reflecting the optical interference signal. For example, in step 904, a phase change may be accumulated (e.g., due to the reflectors).

In some embodiments, process 900 includes a step 906 of measuring the optical interference signal from the interferometer. Measuring the optical interference signal may involve translating the response of the optical waveguide. In some embodiments, the measured optical interference signal may be optical power (e.g., measured at output ports or the coupler of the interferometer). For example, the optical waveguide may be configured to translate the response of the waveguide mode into a response in power transmission spectrum. Additionally, or alternatively, the measured optical interference signal can include a phase difference, wavelength or frequency response, or the like. In some embodiments, the measured optical interference signal may be an output electrical signal, such as when the interferometer-based device includes a photodiode.

In some embodiments, process 900 includes a step 908 of detecting the acoustic signal based on the measured optical interference signal. From the translated response of the waveguide, such as an optical power signal, a change in optical power, or a response in power transmission spectrum, the acoustic signal corresponding to the imaged medium can be detected. For example, detecting the signal can involve processing the signal, such as with signal processor 166.

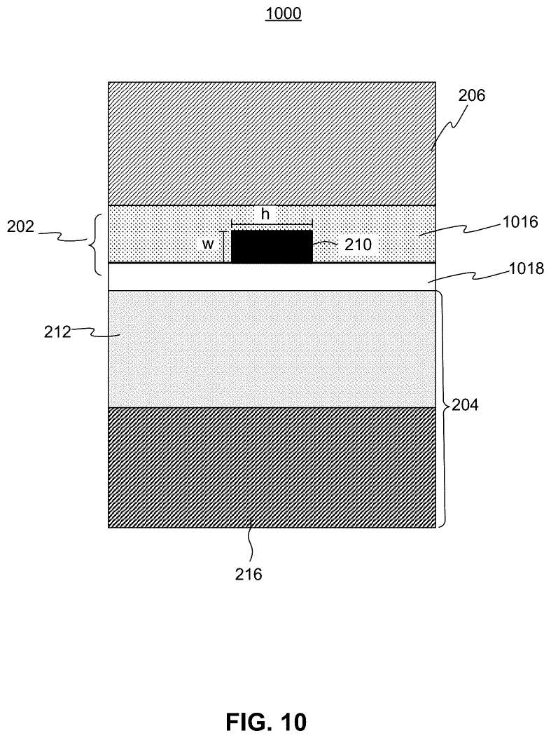

FIG. 10 depicts a cross-section of an AR optical sensor 1000, consistent with embodiments of the present disclosure. AR optical sensor may include a substrate 212. The substrate 212 is characterized by a first impedance value, which may be an acoustic impedance. Optical layer 202 may be disposed on the substrate 212, and the optical layer 202 may include an AR waveguide, as described herein. In some embodiments, the AR optical waveguide may include a core 210, a cladding 1016, and a top layer 206. The optical layer 202 may be between the backing layer 204 and the top layer 206. The top layer 206 may be an acoustic matching layer, and can be characterized by a second impedance value and provides an acoustic impedance gradient for reflected acoustic waves to smoothly return for detection. The second impedance value is an acoustic impedance. In some embodiments, the second impedance value is less than the first impedance value. The matching layer may include one or more layers of epoxy, polyurethane, polystyrene, or other suitable material with a desired acoustic impedance. The top layer 206 helps transfer the ultrasound energy between the array and tissue or medium being scanned by providing an acoustic impedance gradient. It will be recognized that, without a top layer, the differences in impedance between the transducer array and medium being scanned (e.g., tissue) can disrupt and scatter the ultrasound waves as they are received by the transducer. In some embodiments, sensor 1000 includes a tuning device and optical waveguide in a single layer in a photonic chip. For example, an integrated tuning device may be disposed in optical layer 202, and the corresponding optical waveguide may have a mode refractive index that can be tuned as described herein. Additionally, or alternatively, the tuning device and the optical layer may be disposed in separate layers. For example, top layer 206 may include a tuning device (e.g., an external heater) that may be adjacent to the optical layer 202, and the tuning device may tune the mode refractive index of the waveguides in the optical layer 202 as described herein with respect to FIGS. 20-35. In some embodiments, the photonic chip may be a silicon/silicon nitride photonic chip, a lithium niobate photonic chip, a glass-based planar Lightwave circuit, or a polymer integrated photonic chip. In some embodiments, the photonic chip may be fabricated using at least one of a silicon-on-insulator wafer, silicon-nitride on insulator wafer, silicon carbide on insulator wafer, lithium-niobate-on-insulator wafer, gallium-phosphorus-on-insulator wafer, gallium-nitride-on-insulator wafer, gallium-arsenide-on-insulator wafer, aluminum-nitride-on-insulator wafer, diamond-on-insulator wafer, indium-phosphorus-on-insulator wafer or Spin-on/deposit layer (polymer, oxide) on lower-index substrate. The insulator could be fused silica, sapphire and the like, whose refractive indices are lower than those of the top layers.

The AR sensor 1000 may include a backing block 216. The substrate 212 may be arranged between the optical layer 202 and the backing block 216. The backing block 216 is arranged to attenuate an acoustic wave (e.g., an acoustic wave that travels through the top layer 206, the optical layer 202, and the substrate 212). In some embodiments, the backing block 216 may include a loaded polymer structure such as epoxy combined with tungsten or aluminum oxide. Backing block 216 may have high attenuation such that it can absorb and attenuate stray ultrasound energy and thus prevent adding noise or reverberation to the received signals. In addition, backing block 216 may have an appropriate acoustic impedance to avoid acoustic reflection on the boundary between backing block 216 and substrate 212 and attain a damping desired for the acoustic design.

In some embodiments, the second impedance value (e.g., that of the top layer 206) may be greater than an impedance value of the imaged medium so to minimize loss or degradation of the acoustic wave transmitted through the imaged medium before being transmitted to the optical layer 202 and thereby the AR optical waveguide. Optical layer 202 may be arranged so that changes to light transmitted through the waveguide are used to detect the acoustic wave incident on the waveguide. In some embodiments, sensor 1000 includes a cladding 1016, as described herein. For example, cladding 1016 may be a cladding region of optical layer 202, and cladding 1016 may include an acoustic responsive material, such as a polymer. In some embodiments, sensor 1000 may include a second cladding 1018. For example, second cladding 1018 may be a buried oxide layer of an SOI wafer.

In some embodiments, AR optical waveguide core 210 may be characterized by a height h and a width w. The width of the core 210 can be wider than a single-mode waveguide and/or height of the core 210 is equal to a height of a single-mode waveguide. In some embodiments, the core 210 is made wider to be more responsive to an acoustic signal. In some embodiments, a high refractive index material other than silicon is used.

In some embodiments, sensor 1000 may include a tuning device. As described herein, tuning devices may modify, modulate, or otherwise influence properties (e.g., optical propagation properties of a waveguide). For example, tuning devices adjacent to an acoustic responsive waveguides can affect a waveguide through thermo-optical effect, free-carrier injection, electro-optical effect, mechanically induced strain/stress and/or other effects. In the example, a tuning device can affect the mode refractive indices of a waveguide. In some embodiments, a tuning device may include a heater. For example, sensor 1000 may include an integrated heater, such as a heater disposed in the optical layer 202 or disposed in the cladding 1016. Additionally, or alternatively, a heater may be arranged next to the cladding 1016 by flip-chip bonding. In some embodiments, sensor 1000 may include one or more waveguides. For example, a first waveguide may be for a sensor arm and a second waveguide may be for a reference arm. These embodiments will be described herein.

In some embodiments, backing layer 204 may be curved. For example, backing layer 204 may include a curve or bend. In such an example, top layer 206 may include a flexible superstrate. The flexible superstrate may support optical layer 202 and may be disposed above optical layer 202. The flexible superstrate, or the optical layer 202, may be bonded to the curved backing layer 204. In some embodiments, a flexible superstrate may be a part of a external circuit stack, as will be described herein.

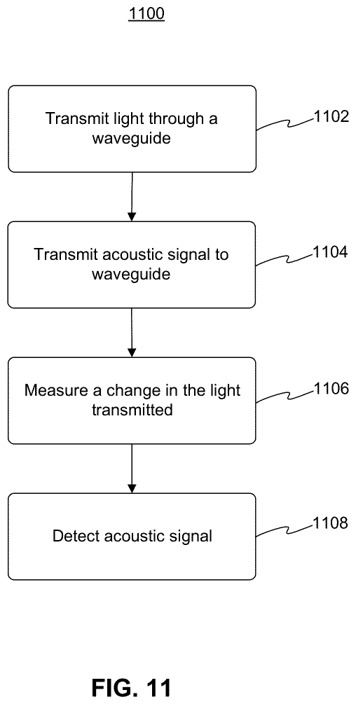

FIG. 11 illustrates a flowchart of a process 1100 for using an acoustic-responsive sensor, consistent with embodiments of the present disclosure. Process 1100 may include a step 1102 of transmitting light through a waveguide. For example, light is transmitted through waveguide in optical layer 202. The waveguide may include a core and a cladding and may be disposed on a substrate, as described herein. The light may be received from a light source, such as laser. In some examples, the light source may be tunable.

Process 1100 may include a step 1104 of transmitting an acoustic signal to an AR optical sensor. Step 1104 may involve transmitting an acoustic signal through an optical layer, the substrate, and to a backing block. The acoustic signal may correspond to an imaged medium. In an example involving ultrasound probe 104, a waveform generator may transmit acoustic signals (e.g., based on waveform generator) and receive an acoustic signal corresponding to an imaged medium. In some embodiments, an acoustic signal may be received at a matching layer that has an impedance between that of an imaged medium and the backing layer comprising the substrate and the backing block, and then transmitted to the waveguide. For example, an acoustic signal is transmitted through the top layer 206 including a matching layer, the optical layer 202 including a waveguide, the substrate 212, and to the backing block 216 of backing layer 204 in FIG. 10. As described herein, the substrate 212 may be characterized by a first impedance value that is an acoustic impedance, the waveguide may be between the substrate and the top layer 206. The matching layer may be characterized by a second impedance value that is an acoustic impedance, and the second impedance value may be less than the first impedance. The substrate 212 may be arranged between the waveguide and the backing block 216, and the backing block 216 may be arranged to attenuate an acoustic wave.

In some embodiments, step 1104 may include transmitting an acoustic signal through a top layer (e.g., including a matching layer), a waveguide, and a backing layer. The sensor in step 1104 may optimize the transduction sensitivity of an interference-based transduction mechanism, as described herein. Step 1104 may include the tuning of individual sensors to optimize such transduction sensitivity. For example, tuning of individual sensors can occur in real-time against fabrication errors or ambient perturbations.

Process 1100 may include a step 1106 of measuring a change in light transmitted through the waveguide as the acoustic signal is transmitted through the waveguide. As described herein, an acoustic signal incident on a waveguide may induce changes in the waveguide (e.g., due to PE sensitivity and/or deformation sensitivity). The changes in the waveguide may correspond to one or more changes in an optical propagation property of the waveguide and thereby a change in the light transmitted. For example, step 1106 may involve observing and/or measuring a change in optical path length of light in the waveguide. Step 1106 may involve one or more signal transduction mechanisms that can provide an enhanced signal. For example, step 1106 may involve measuring a change in light with an interferometer, aresonator, or the like, as described in FIGS. 6-9 and elsewhere in this disclosure.

Process 1100 may include a step 1108 of detecting the acoustic signal based on the change in light. Step 1108 may involve detecting and/or measuring the change in light transmitted through the waveguide as the acoustic signal is transmitted through the waveguide. For example, a change in optical path length is measured and correlated to a change in refractive index of the waveguide. In some examples, step 1108 may involve processing of the signal, such as with signal processor 262.

### Exemplary Waveguide Implementations

In some embodiments, larger total length of an acoustic responsive (AR) waveguide can be preferable for a higher ratio between response to acoustic signal and noise in optical phase. On the other hand, the optical loss of acoustic responsive waveguide also increases with the total length, which reduces the overall acoustic sensitivity in optical power. Therefore, the total length of acoustic responsive waveguide for a sensor should be a balanced choice between the waveguide loss, required sensitivity, and the sensor footprint. It should be noted that given a certain range of total length, a smaller footprint, especially in lateral width, benefits the receiving angle of the sensor. Thus, in some embodiments, the layout of the AR waveguide may be optimized to maximize the waveguide density. For example, the disclosed embodiments may involve maximizing the total length of the waveguide while maintain a small overall dimension, thereby increasing density while maintaining a small footprint. The design of an AR waveguides may involve various parameters, such as the minimum waveguide spacing (dₛₚ) and bending radius (r_{wg}). Minimum waveguide spacing may influence how densely AR waveguides can be arranged within the outline, while the bending radius determines whether overall optical path could be realized with a low or minimal optical loss.

As described herein, interference-based signal transduction may use a long AR sensing optical path and corresponding optical coupling to complete the interference (e.g., see FIGS. 6-9). Though there are many possible layout designs, some considerations for increasing or maximizing optical path length and reducing or minimizing bending-induced loss are described below.

In some embodiments, the sensing optical path may include straight waveguides and rounded waveguides (arc bend). Considering the large-aspect-ratio nature of the sensing outline (Wₑₗₑ>>Pitch), a large contributor of the total length may be having multiple straight waveguides parallel with an elevation side. In this way, the elevation width of the element outline is sufficiently used with reduced or minimal bending. A fold number can represent how many straight waveguides are used (e.g., in a cross-sectional width). The average length of the straight waveguides can be defined as lₛₛ, or sensor length. For a m-fold PIAS with lₛₛ, mlₛₛ provides a reasonably good estimation of the total length of the sensing optical path. The lₛₛ<Wₑₗₑ. Various embodiments of the basic building block will be discussed in more detail below.

It will be recognized that having r_{wg} significantly greater than dₛₚ may not be ideal. In some embodiments, the spacing of the straight waveguides may be equal to or larger than dₛₚ. To link multiple waveguides into one optical path, the arrangement of the waveguides may also limited by the minimum bending radius r_{wg}. In some embodiments, two adjacent waveguides may be linked with a circular U-bend with a bending radius of r_{wg} to form a Zig-Zag optical path. This design involves the spacing between the straight waveguides also being equal to or larger than 2r_{wg}.

In some embodiments, such as when the fold number is 2, a racetrack loop could be formed instead of a simple U-bend, which could be applied to form AR waveguides shown in FIGS. 7 and 8. However, this design could be space-consuming if r_{wg}>dₛₚ/2. A spiral-base layout, in this case, could enable a much longer optical path within the outline.

FIGS. 12-18 illustrate exemplary waveguides, consistent with embodiments of the present disclosure. The waveguide traces described in FIGS. 12-18 may be examples of waveguides described herein. For example, waveguides described with respect to FIGS. 12-18 may include waveguide core 210. As described herein, a refractive index of an optical waveguide and/or a group velocity associated with a guided mode of an optical waveguide can change in response to ultrasound signals reflecting from an imaged medium. In some embodiments, a layout design of a waveguide trace for an acoustic-responsive sensor comprises a substrate and a waveguide disposed on the substrate in a trace pattern. In some embodiments, as illustrated in FIGS. 12-18, waveguides can include a spiral shape having a first end, a second end opposite the first end, and a middle portion between the first end and the second end. A waveguide trace may have an outside length that is the distance from the outside of the first end to an outside of the second end. The spiral shape may be characterized by a maximum outside length and a maximum outside width. For example, the maximum outside length may be greater than the maximum outside width. In some embodiments, an outside width of the trace pattern measured at the first end is larger than an outside width of the spiral shape measured at the middle portion. In some embodiments, the maximum outside length may be equal to or greater than 5, 10, or 100 times the maximum outside width. For example, the traces illustrated below are much taller than they are wide. In some embodiments, waveguide trace patterns may include any number of folds, such as seven, eight, or more folds. In some embodiments, the spiral shape is symmetrical, while in other embodiments, a spiral shape may be asymmetrical. In FIGS. 12-18, the illustrated waveguides can include a plurality of straight portions and a plurality of bend portions. The plurality of straight portions and the plurality of bend portions may be disposed within the width of the first sensor.

In some embodiments, a spiral waveguide trace with a rectangular outline can be used to increase or maximize a fold number withing a given lateral width. FIG. 12 illustrates an exemplary waveguide 1200, consistent with embodiments of the present disclosure. The trace pattern can include multiple folds in a spiral shape extending from an s-bend, such the s-bend 1202 (e.g., illustrated by the dashed lines) in waveguide 1200. Setting the s-bend in the center as shown in waveguide 1200, may result in an overall lateral width of an m-fold spiral waveguide ≥(m−1)dₛₚ+2r_{wg}. This equation holds true for circular and other parametric curves under the assumption that local bending radius >r_{wg·min} holds true for every point. In some embodiments, a direction of optical waveguide propagation in a straight portion (e.g., portion 1220) may be opposite to a direction of optical wave propagation in an adjacent straight portion (e.g., portion 1224). Additionally, or alternatively, a direction of optical waveguide propagation in a bend portion (e.g., portion 1222) may be opposite to a direction of optical wave propagation in an adjacent bend portion (e.g., portion 1226).

Spacing of the straight waveguides may be equal to or larger than the minimum waveguide spacing dₛₚ, while an achievable fold number is related to (e.g., determined) by the bending radius r_{wg}. In some embodiments, to prevent significant bending loss, r_{wg} is much larger than dₛₚ. Therefore, a zig-zag link of straight waveguides is more space-consuming than a link of the straight waveguides as a spiral. In some embodiments, L-bend (<180 degree), U-bend (180-degree) and S-bend (routing displacement) may be implemented with circularly bent waveguide, Euler curve waveguide, Bezier curve waveguide or waveguides of other mathematical curves. In some embodiments, the curve associated with the bent waveguide may be a modified or hybridized version of the existing mathematical curves, such as the modified Bezier curve and Euler-circular curve. These bent waveguides are designed to reduce the optical bending loss and benefit the signal to noise ratio during the readout of sensing signals encoded in optical power. Further, a reduced bending loss makes the optimal bending radius smaller and increases the layout density of AR waveguides. In some embodiments, a waveguide cross-sectional shape does not violate an assumption that the optical layer's thickness is significantly smaller than the acoustic wavelength. Therefore, a different shape should not affect how acoustic wave, or the pressure field, propagates through the optical layer. An exception can be using a suspended waveguide with undercut structures. The undercut region could break the optical layer thickness.

Waveguide 1200 may be an embodiment of a 7-fold slim rectangular spiral. A variation of a Fermat's spiral is shown, where the arc bending has a radius of r_{wg} and the waveguide spacing is kept as dₛₚ. The spiral has an s-bend. By setting the s-bend in the center as shown in the figure, an overall lateral width of an m-fold spiral waveguide ≥(m+1)dₛₚ+2r_{wg}.

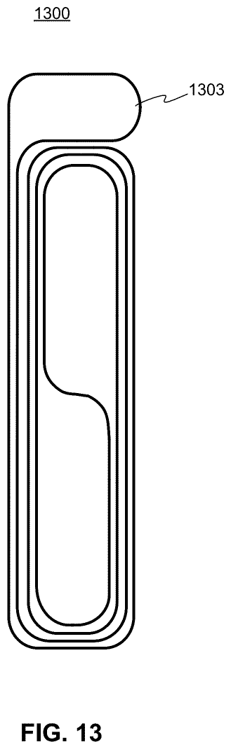

FIG. 13 illustrates an exemplary waveguide 1300, consistent with embodiments of the present disclosure. Waveguide 1300 may demonstrate forming a loop based on a rectangular spiral. Waveguide 1300 may be an embodiment of an 8-fold slim rectangular spiral loop. In some configurations, a waveguide loop is used, and the spiral waveguide of waveguide 1200 could be completed into a loop 1303 as shown in waveguide 1300. To complete the loop, a u-shape bend is used. In waveguide 1300, the u-bend is arranged such that an extra lateral width (e.g., minimal) is introduced. In this way, a larger fold number can be achieved within the lateral pitch defined by the receiver array. The type of loop in waveguide 1300 can be referred to as a slim rectangular spiral loop. A spiral loop can be applied to form an interference-based sensor (e.g., such as those illustrated in shown in FIGS. 7 and 8, and the couplers could be assigned along the optical paths based on the design of global optical layout (e.g., see FIGS. 36-38).

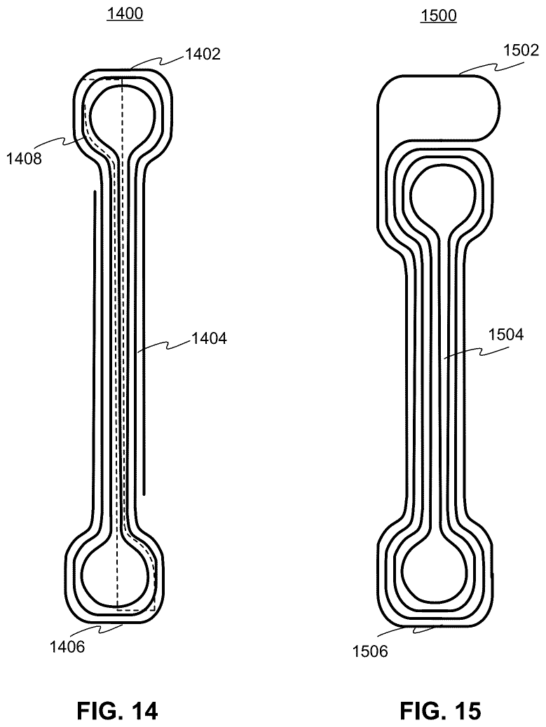

In some embodiments, a waveguide may include a dipole spiral, dipole spiral loop, and an interferometer (e.g., an MZI) may include a waveguide with a dipole spirals. It will be appreciated that a dipole spiral can accommodate more waveguides in a narrow area. FIGS. 14-17 illustrate examples of waveguides with dipole spirals.

FIG. 14 depicts an embodiment of a waveguide 1400, consistent with embodiments of the present disclosure. Waveguide 1400 may include a first end 1402, a middle portion 1404, and a second end 1406. The middle portion 1404 may have an outside width that is smaller than an outside width of first end 1402 and/or second end 1406. Waveguide 1400 may be a 7-fold dipole spiral. Waveguide 1400 may have a symmetrical spiral, as illustrated by an s-bend in the middle of the dipole trace. The spiral path could be applied to form AR waveguides shown in FIGS. 6 and 9. In a rectangular spiral (loop), two vacancies of waveguide caused by the s-bend are presented in a middle of the structure, as seen in FIGS. 12 and 13. Noting that the sensitivity of the structure is directly provided by the waveguides, such structure may introduce a wider and non-continuous effective sensitive aperture of a single sensor, which may reduce the sensor performance to angled acoustic input as well as increase crosstalk of an array. To reduce or solve this, a variation of the slim rectangular spiral waveguide can be used, such as waveguide 1400, which may be a dipole spiral. The s-bend causing the waveguide vacancies is separated into two halves and moves to two ends of the elevation side (labeled by the dashed line 1408. Such a design will not change the relation between the overall elevation width (on the elevation end) and the fold number, but would achieve a narrower and single-piece effective sensing aperture. It should be noted that the U-bend on each side of the dipole spiral may include S-bends, L-bends, U-bends, and transitions between bends and straight waveguides to address the difference in minimum bending radius and the minimum waveguide spacing. Bezier curves, other mathematical curves, arcs with varying radius could be introduced to reduce the bending loss.

FIG. 15 depicts an embodiment of a waveguide 1500, consistent with embodiments of the present disclosure. Waveguide 1500 may include a first end 1502, a middle portion 1504, and a second end 1506. The middle portion 1504 may have an outside width that is smaller than an outside width of first end 1502 and/or second end 1506. Waveguide 1500 may be an 8-fold dipole spiral loop. Waveguide 1500 may include a spiral loop based on a dipole spiral. The spiral loop could be applied to form interference-based sensors, as described herein, and couplers could be assigned along the optical paths based on the design of global optical layout (e.g., FIGS. 36-39).

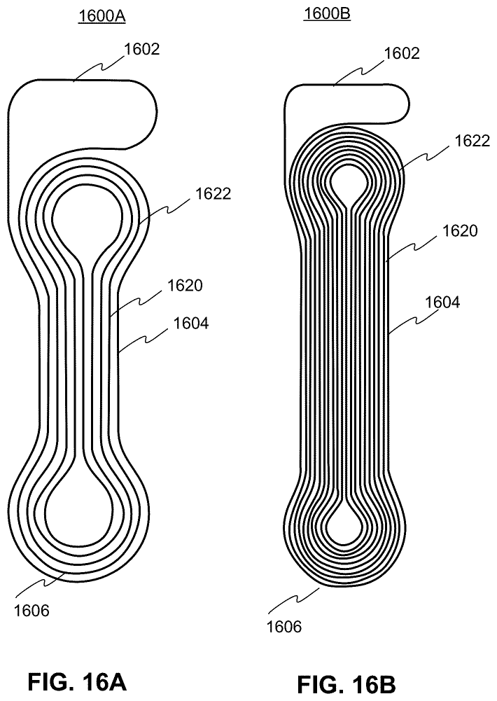

FIGS. 16A-16B illustrate embodiments of a waveguides 1600A and 1600B, respectively, consistent with embodiments of the present disclosure. In some configurations, waveguides 1600A, 1600B may be a preferred embodiment. For example, in larger-elevation sensors, the middle portion of the sensor can occupy a majority of the sensor, which can result in a smaller average lateral width of the sensor. The width of the waveguides may thus also be smaller in such a configuration, which can result in larger bending losses. Waveguides 1600A, 1600B may reduce bending losses (e.g., over waveguide 1200 or waveguide 1300). Waveguides 1600A, 1600B may include a first end 1602, a middle portion 1604, and a second end 1606. The middle portion 1604 may have an outside width that is smaller than an outside width of first end 1602 and/or second end 1606. Waveguides 1600A, 1600B may include u-bends on the sides of a dipole spiral. The u-bends may be comprised of two Bezier S-bends, followed by a half-circle u-bend with varying radius. In some embodiments, waveguides 1600A, 1600B may include a straight portion 1620 of a plurality of straight portions, as well as bending portion 1622 of a plurality of bending portions. The plurality of straight portions may have spacings between them that may be approximate to or less than the minimum bending diameter of the waveguide. For example, the plurality of straight portions may have an average spacing (e.g., average spacing between straight portions) that is smaller than the smallest bending diameter of the bending portions. In such an example, the plurality of straight portions and the plurality of bend portions may be disposed within the width of an optical sensor. For example, the maximum outside width of the waveguide may be substantially the same as, or lesser than, the minimum width of the optical sensor. As such, waveguides 1600A, 1600B can reduce the transition between waveguide portions with different curvature (e.g., bending in a positive referential direction, bending in a negative referential direction, or straight portions), which can thereby reduce insertion losses due do mode mismatch. In addition, waveguides 1600A, 1600B may have half circle u-bends with radii that increase towards the outer traces. For example, the most outside layer may have a radii greater than the second-most outside layer. As such, the average bending radius increases, thereby reducing insertion loss and/or bending losses. Furthermore, waveguides 1600A, 1600B may provide more efficient tuning. As the straight portions of waveguide 1600A, 1600B may be condensed or packed closely together (e.g., lower average spacings), tuning can be delivered to more portions of the waveguide. For example, heating a region of the waveguide can result in multiple straight portions receiving the heating, as opposed to configurations with larger spacing between straight portions.

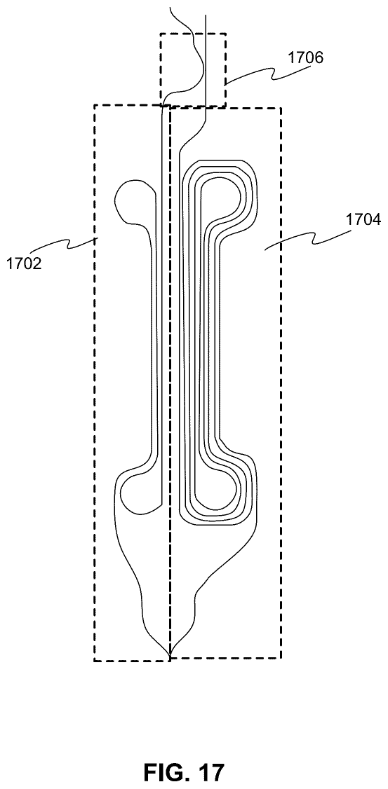

FIG. 17 depicts an embodiment of waveguides traces of an interferometer, consistent with embodiments of the present disclosure. In some embodiments, FIG. 17 may be an example of an interferometer 600, as illustrated in FIG. 6. Interferometer 600 may include a first arm 604 and a second arm 606. In an example, first arm 604 may be a reference arm, and second arm 606 may be a sensing arm of an interferometer, such as an MZI. The first arm 604 and the second arm 606 may include an asymmetric dipole spiral loop. An asymmetrical dipole spiral shape (e.g., asymmetrical along a length of the spiral shape) may involve the s-bend being off-centered or not-centered in a width of the dipole trace in relation to the ends of the dipole. In FIG. 17, a sensing arm may include an asymmetric dipole spiral waveguide 1704, and a reference arm may include an asymmetric dipole spiral waveguide 1702, which may be disposed on substrates for an Interferometer. In some embodiments, the reference arm spiral waveguide 1702 may be shorter than the sensing arm spiral waveguide 1704. As described herein, interferometer 600 may use a directional coupler 1706 (DC) to split light between the two arms. In FIG. 17, the center of the s-bend of waveguide 1702 or 1704 is shifted to not be in the center of the spiral so that the spiral shape of the sensing arm does not have a lengthwise axis of symmetry. Similarly, the spiral shape of the reference arm is also asymmetrical. The dipole spiral waveguide (e.g., dipole) has an advantage to form an interferometer (eg. MZI) within the large-aspect-ratio element outline.

In some embodiments, a waveguide may include interleaved dipole-shape structures. An interleaved dipole-shape sensors can be introduced, which causes overall lateral width to be ≥(m−1)dₛₚ+2r_{wg}. It can be desirable to have as long of a waveguide as possible, unless the total length is so long that the insertion loss is too high, which is determined case-by-case among material platform, design, and foundries.

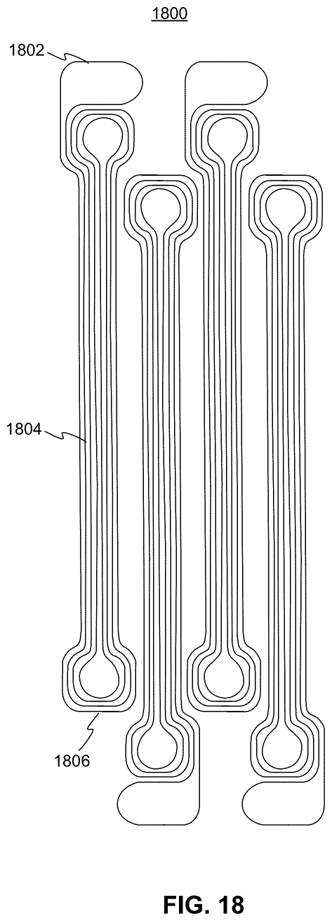

FIG. 18 depicts an embodiment of traces 1800 for a sensor array, consistent with embodiments of the present disclosure. Waveguides of traces 1800 may each include a first end 1802, a middle portion 1804, and a second end 1806. The middle portion 1804 may have an outside width that is smaller than an outside width of first end 1802 and/or second end 1806. In FIG. 18, traces 1800 illustrate interleaved dipole spiral loop. For example, a PIARA may be a compact array formed by dipole spiral loops, such as traces 1800. The sensor array may be formed by offset dipole spiral loops. In some embodiments, when an average length of the straight waveguides lₛₛ is very large (e.g., >20×pitch), a small elevational shift in the effective sensing aperture between neighboring sensors can be tolerable without introducing significant acoustic delay uncertainty or non-uniformity in ultrasound imaging reconstruction. In this case, interleaved dipole-shape sensors such as traces 1800 can be introduced, which causes overall elevation width to be ≥(m+1)dₛₚ+2r_{wg}. A gap between the neighboring sensors is kept for bus waveguides with couplers.

In some embodiments, a resonator-based sensor in ring-shape trace or racetrack-shaped trace could be used. For example, such configurations could be used in cases involving (1) Wₑₗₑ˜Pitch or (2) special AR waveguide design that do not support dense spiral waveguides. In some embodiments, the relation Wₑₗₑ>>Pitch may not hold. Such a constraint may arise from design considerations for a 1-dimensional array for effective lateral beam forming (pitch˜acoustic wavelength in imaging target) and sufficient elevation focusing. Therefore, such relation may not hold in situations like higher-dimensional array, transducers with axial imaging mode, separate-body mixed transducer, etc. In those cases, ring-shape loops, racetrack loops, spiral-based structures with circular or square shape could be applied to form sensors in a sensor array (e.g., PIASs in a PIARA).

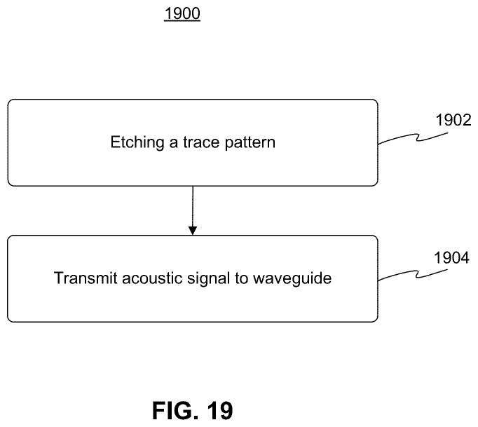

FIG. 19 illustrates a flowchart of a process 1900 for fabricating an acoustic-responsive

sensor, consistent with embodiments of the present disclosure. Process 1900 may include a step 1902 of etching a trace pattern for a waveguide (e.g., for a waveguide core). A trace pattern may be etched in a device layer, which may refer to a layer fabricated on a substate and including active components. For example, step 1902 may involve etching trace patterns illustrated in FIGS. 12-18 in a device layer of an SOI wafer. The trace pattern can include multiple folds in a spiral shape extending from an s-bend. In some embodiments, the trace pattern may include a s-bend, as described herein.

Process 1900 may involve a step 1904 of covering a trace pattern with cladding material. In step 1904, the trace pattern etched in step 1902 covered by a cladding material. For example, the etched device layer of the SOI wafer can be covered with a cladding material such as silicon dioxide.

### Chiplets

In some embodiments (e.g., for medical ultrasound imaging scenarios), large lateral aperture sizes (Lₗₐₜ>40 mm) could be used. However, the largest chip size could be constrained by one or more fabrication processes. On the other hand, the fabrication and packaging yield of a single-chip sensor array (e.g., a PIARA) may reduce with a larger size and larger channel count. Therefore, in some embodiments, a sensor array may be formed by multiple chiplets. Chiplets may include modular semiconductor die (e.g., individual chips) that can be interconnected to form a processor or system-on-chip. To realize an uninterrupted PIARA, the sensor arrays could populate the whole lateral size of the chiplets. Additionally, or alternatively, the optical and/or electrical routing may be compact enough without introducing gaps between sensor elements. In addition, the chiplets can be assembled with a reduced or minimum gap (e.g., <50 μm gap is used without introducing significant interruption of the array). Possible assembly errors can be compensated by adjusting the ultrasound imaging beamforming software (e.g., a one-time calibration by the assembly fixing parameters in the software). For chips that are not bendable, chiplets can provide flexibility to form a PIARA with a non-flat geometry (e.g., a curved array, multiple-facing endoscopic array, etc.).

### Sensor Tuning

As described herein, the disclosed embodiments may include tuning for AR optical sensors. For a sensor array including one or more sensors, individual sensor control may refer to the tuning control of different sensors. In some embodiments, individual sensor controlling can be enabled by introducing tuning devices for each sensor. Tuning devices may modify properties of light and/or optical responses to acoustic signals. In this way, individual sensors can be tuned so that multiple channels can share the same optical source. In some examples, tuning devices may include phase shifters. For example, the disclosed embodiments may involve tuning an optical propagation property, such as one or more of a refractive index, an optical path length,, an amplitude, or a phase of the optical path length, of a waveguide. In some embodiments, an optical sensor may be tuned according to a signal (e.g., an input signal). For example, a tuning device may assist in shifting a desired operation point in the optical power transmission spectrum of a sensor to align with a wavelength of an input signal. The tuning can be realized by (1) thermo-optical effect; (2) free-carrier injection (e.g., electro-refractive effect); (3) electro-optical effect (e.g., Pockels effect), (4) mechanically induced strain/stress (e.g., photoelastic effect) and/or (5) other effects. It will be appreciated that the disclosed embodiments of tuning may be performed separately and/or in combination with one another. For example, thermo-optical tuning may be performed with free-carrier injection in some embodiments, while other embodiments may involve only free-carrier injection.

FIGS. 20-24 illustrate exemplary configurations of controlling for sensors, consistent with embodiments of the present disclosure. In some embodiments, sensor control can occur on the waveguide-level, such as tuning waveguide(s) of different sensors. FIGS. 20-24 relate to embodiments of waveguide-level controller designs. In FIGS. 20-24, darker colored components may represent a higher conductivity (e.g., intrinsic/doped semiconductors, heaters, conductors).

FIG. 20 illustrates an example of thermo-optical tuning in a cross-section of sensor 2000, consistent with embodiments of the present disclosure. The disclosed embodiments may provide thermo-optical tuning by thermal controllers, which may also be referred to as thermo-optical tuning devices. Thermal controllers may include heaters. The cross-section of 2000 may illustrate thermo-optical tuning by conductor heater. The cross-section of sensor 2000 may include a waveguide core 2002, a first cladding 2004, a second cladding 2006, and a heater 2008. A heater may include a component or structure that can locally increase conductivity to form a resistor. With the passage of an electric current, the resistor produces heat and raises the temperature of a region. Heater 2008 may adjust the refractive index of an AR optical sensor (e.g., via the thermo-optic effect). A heater may include a single strip or multiple stripes in parallel and/or sequentially linked. As a non-limiting example, heater 2008 can be made of titanium, titanium nitride, or the like. In some embodiments, heater 2008 can be fabricated directly above the waveguide core 2002. An electrical controlling signal can be delivered to heater 2008 by metal traces (e.g., aluminum, copper, or the like) and by vias linking the traces (not illustrated in the figure) to the heaters.

FIG. 21 illustrates an example of thermo-optical tuning in a waveguide cross-section 2000, consistent with embodiments of the present disclosure. In particular, FIG. 21 illustrates thermo-optical tuning by heavy doping of semiconductors. It will be appreciated that doping can increase conductivity of a material, thereby providing resistive heating when a current is applied. For example, the cross-section of sensor 2000 may include heaters 2108 and/or 2110 that are doped semiconductors. The doped semiconductor can be selected according to materials in the AR optical sensor. If the PIAS has a semiconductor layer like silicon, conducting heaters 2108 and/or 2110 could be realized by heavily-doped silicon. The electrical controlling signal could be delivered to the heater layers by metal traces, as described herein. A heater can be disposed adjacent to waveguide core 2002. In some examples, the heaters 2108 and 2110 can be connected with the waveguide core 2002 for better thermal conduction.

FIG. 22 illustrates an example of optoelectronic tuning in sensor 2000, consistent with embodiments of the present disclosure. In particular, FIG. 22 illustrates tuning by free-carrier injection. Free-carrier injection can involve applying an electrical signal to locally control the carrier density in semiconductor, thereby altering the refractive index of a waveguide. For example, in the cross-section of sensor 2000, a PIN junction is formed across waveguide 2002 by adjusting the doping depth for waveguide 2002. When applying a controlling voltage (e.g., based on a received electrical control signal) across the PIN junction, a new carrier-hole equilibrium can be formed across the waveguide cross-section, changing the mode refractive index, and thus tuning the power transmission spectrum of sensor 2000. In some embodiments, a waveguide may include free-carrier injection in addition to a heater, such as conducting heaters 2208 and 2210. The optical index of the waveguide core could be tuned by varying the controlling voltage. In some embodiments, electrical controlling signal could be delivered by metal traces (Al, Cu, etc.) and/or by vias linking the traces to the heaters.

FIG. 23 illustrates an example of electro-optical tuning in a waveguide cross-section 2000, consistent with embodiments of the present disclosure. Electro-optical tuning may include modifying optical properties of a material or component by applying an electric field. The cross-section of sensor 2000 may include a waveguide 2002 and one or more claddings, such as first cladding 2004 and second cladding 2006. In some embodiments, optical materials that host the optical mode, such as waveguide core 2002 or cladding 2004 and/or second cladding 2006, may have a non-vanishing electro-optical coefficient. For example, such materials may include lithium niobate or electro-optical polymers (e.g., poled polymers containing azo-dye). The optical mode index could then be directly tuned by applying voltage from metal electrodes, such as electrodes 2330, 2332, or 2334. The position of electrodes can be designed to increase or optimize the overlap between electro-optical material and the controlling electrical fields. For example, electrodes may be positioned adjacent to the waveguide core 2002 (e.g., above) and/or connected to the waveguide core 2002. Varying amounts of electrodes can be used to apply the electric field. In some embodiments, two electrodes (e.g., electrodes 2030 and 2032) may be sufficient to apply the electric field. In some embodiments, three electrodes (e.g., electrodes 2030, 2032, and 2034) may be utilized to apply the electric field.

FIG. 24 illustrates an example of thermo-optical tuning in a waveguide cross-section 2000, consistent with embodiments of the present disclosure. In particular, thermo-optical tuning with hybrid cladding is shown in FIG. 24, which illustrates a waveguide core 2002, a first cladding 2004, a second cladding 2006, and a third cladding 2436. In some embodiments, third cladding 2436 may be an acoustic responsive cladding. As acoustic-responsive claddings are usually not compatible with a fabrication process of electrical controllers (e.g. heater 2008 or electrode 2332), one or more doped semiconductor heaters can be introduced to bridge the two cladding materials. Such bridging can allow for positioning of heaters closer to the waveguide (e.g., <5 μm in some examples) for claddings that might not be compatible with certain heaters, thereby also reducing the need for external heaters. For example, heaters 2042 and 2044 may be doped semiconductor heaters having the same or substantially similar base materials as the waveguide core 2002. In some embodiments, the first, second, and third claddings may be different from one another. The electrical controlling signal can be delivered to the heaters 2440 and 2442 by metal traces and/or by vias linking the traces to the heaters in cladding 2004.

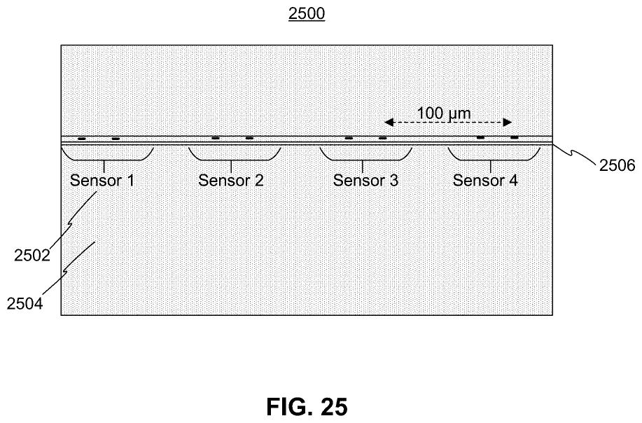

FIGS. 25-27 illustrate an example of conductor heaters for tuning, consistent with embodiments of the present disclosure. Exemplary design considerations for heaters may include tuning efficiency (e.g., measured by free-spectrum range tuning, crosstalk ratio, and power consumption).

### Example Design of Heaters in an Oxide Cladding Sensor

FIGS. 25-27 provide a design embodiment of conductor heaters for individually tuning the resonant wavelengths of a spiral loop resonator. For example, the design of tuning devices may realize a tuning authority of at least 1 free-spectrum range (FSR) to allow the alignment of the operating points of multiple sensor elements to the wavelength of a shared optical source. A FSR may be the spacing between consecutive resonance frequencies or wavelengths. When operating an array of AR optical sensors via individual tuning of sensors, design considerations may include (1) primary tuning efficiency; (2) crosstalk; and (3) primary tuning bandwidth. The primary tuning efficiency could be measured by the power required to tune the corresponding sensor by one FSR. The primary tuning efficiency may determine the average power consumption of stabilizing the operation of the PIARA (optical power not included). The crosstalk, usually measured by a percentage with respect to the primary tuning, measures the tuning devices' impact to adjacent sensors. As described herein, reducing crosstalk, such as obtaining low crosstalk (e.g. less than 15%) is desired, as otherwise the robustness of the array operation could be hindered. For example, the loss of stabilization of one sensor could affect the stabilization of other sensors. For unipolar tuning like thermo-optical tuning, a high crosstalk could cause loss of stabilization because the summation of the crosstalk impacts leads to a requirement of primary cooling, which is not achievable with typical integrated heaters. A sufficient primary tuning bandwidth (e.g. >50 Hz) should also be realized, compared to the typical bandwidth of ambient interruptions (e.g., temperature, pressure, or the like)

FIG. 25 depicts a cross-section of a sensor array 2500, consistent with embodiments of the present disclosure. Sensor array 2500 may include one or more AR optical sensors 2502 having integrated heaters as tuning devices. In FIG. 25, only 4 sensor elements are illustrated in the model for convenience of illustration. Sensor 2502 may include a stack comprising a substrate 2504, a cladding 2506, and one or more waveguide cores (not shown) disposed in the cladding. For example, substrate 2504 may be a 750 μm silicon substrate, cladding 2506 may be a 6 μm silicon dioxide cladding, and the waveguide cores may be silicon waveguides buried in the oxide cladding.

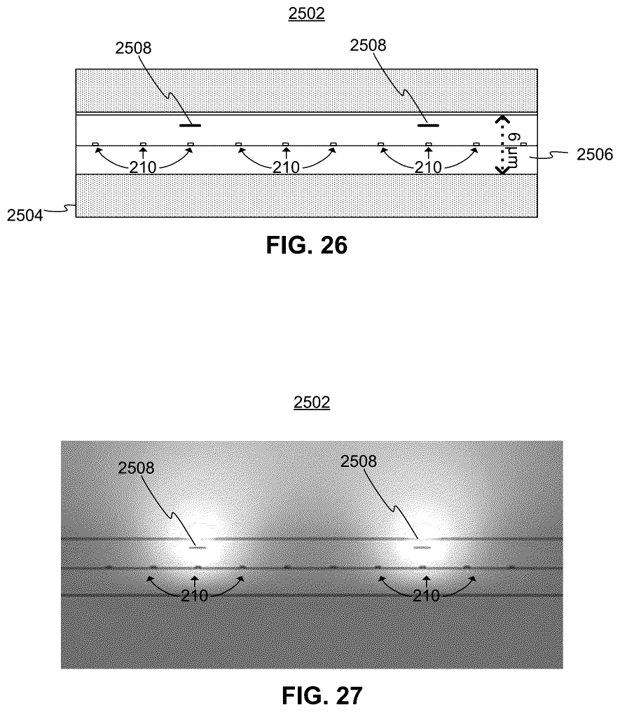

FIG. 26 depicts a zoomed-in view of an element of sensor array 2500. For example, FIG. 26 may illustrate a zoomed-in view of sensor 2502, displaying a stack. In some embodiments, sensor 2502 may include a single waveguide core 210. Alternatively, sensor 2502 may include two, three, four, or more waveguide cores 210. Sensor 2502 may include one or more integrated heater(s) 2508. In this case, integrated heaters 2508 may be two TiN heater strips in series used over the waveguide cores 210 for sensor 2502 (e.g., sensor 1), in which current is passing through to generate heat. Consequently, the generated heat can elevate the temperature on the waveguides, thereby changing the effective mode index, which results in wavelength change.

FIG. 27 depicts a FEM simulation result for the temperature profile of an embodiment of a heated element, such as sensor 2502. As an example, for the TM mode case, FSR is around 223 picometer and calculations show a 13-milliwatt power can be used for one FSR tuning. Assuming a parallel scheme for both heaters, ohmic resistance is 1050 Ω in total. The current and voltage to cover 1 FSR tuning are 3.5 mA and 3.7 volts. Moreover, crosstalk at sensors 2, 3, and 4 (e.g., illustrated in FIG. 25) are calculated as 11%, 7% and 6% respectively for the case of TM mode. It will be appreciated that while all waveguide cores shown in FIG. 27 belongs to the same sensor 2502 (e.g., sensor 1), only a few waveguide cores 210 overlap with the localized field of temperature rise (e.g., due to heaters 2508), as illustrated in the simulation. Such overlap is important for a high primary tuning efficiency, as well as a low crosstalk ratio, (e.g., due to the comparison between the local heating and a much weaker global heating). Although adding more heaters could further benefit limiting the crosstalk ratio, doing so could also raise the 1-FSR tuning power, as a larger cross-sectional area other than waveguides would be heated.

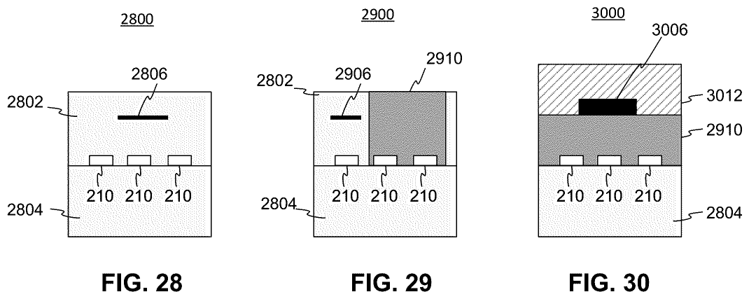

FIGS. 28-30 illustrate embodiments of thermo-optical controller designs, consistent with embodiments of the present disclosure. FIG. 28 displays a cross-section of an AR optical sensor 2800. Sensor 2800 may include one or more optical cores 210. It will be appreciated that optical cores shown in FIGS. 28-30 may belong to the same sensor element, and the number of cores in the cross-section is not limited to three cores as illustrated. For example, a sensor may include one, two, three, or more cores. Multiple cores could be linked with the spiral shape or other shapes as described herein. Sensor 2800 may include a first cladding 2802 and a second cladding 2804, with a thermal controller 2806 embedded in the first cladding 2802. For example, the thermal controller 2806 may be a heater, as described herein. In some embodiments, first cladding 2802 may include the same material as second cladding 2804. In other embodiments, first cladding 2802 may be different from second cladding 2804. As an example, thermal controller 2806 can be available from foundry process design kits (PDKs), and first cladding 2802 and second cladding 2804 may be standard claddings.

In some embodiments, individual sensor controllers can be realized in back-end-of-line (BEOL) processes. It will be appreciated that BEOL structures can use process-specific claddings. As such, some sensors may include claddings with specialized properties, such as acoustic responsive claddings. For example, similar to FIGS. 20-24, sensor 2800 in FIG. 28 may include sensor controllers (e.g., heaters) that are arranged close to, if not horizontally overlapped, with the optical waveguides to provide efficient tunability with reduced crosstalk. Accordingly, without special design, the individual sensor controller may not be compatible with non-standard acoustic responsive cladding, like acoustic responsive polymers, because polymers usually have a low thermal conductivity where the field of temperature rise attenuates sharply with as small as 10-um-offset. For example, a standard cladding material may be oxide.

FIGS. 29 and 30 display embodiments of thermo-optical controller designs with acoustic responsive cladding. FIG. 29 displays a cross-section of an AR optical sensor 2900. Sensor 2900 may include one or more optical cores 210, cladding 2802, cladding 2804, and a thermal controller 2906. In some embodiments, thermal controller 2906 may be the same as thermal controller 2806 of sensor 2800. Alternatively, thermal controller 2906 may have different properties from thermal controller 2806, such as being larger or smaller (e.g., shorter or longer, more wide or less wide) than thermal controller 2806, or being comprised of different materials than thermal controller 2806. It will be appreciated that such different properties can provide for differing localized heat fields than that of sensor 2800. Sensor 2900 may include an acoustic responsive cladding 2910. In some embodiments, optical cores 210 may be partially embedded in acoustic responsive cladding 2910 and partially equipped with thermal controllers, respectively. For example, some optical cores 210 may be adjacent to a thermal controller 2806, while other cores may be disposed in acoustic responsive cladding 2910 (e.g., and away from a localized field of temperature rise due to thermal controller 2906). As such, it will be appreciated that sensor 2900 may be an example of a hybrid configuration of a thermal controller, in which different selections and placements of thermal controllers and/or claddings can provide further fine tuning and individual controllability. In one example, the two types of optical cores could be arranged as two arms of an interferometer, such as when a first arm includes optical core 210 having a thermal controller 2906 disposed above it, and the second arm includes optical cores 210 disposed in an acoustic responsive cladding 2910. In such an example, one of the first arm or the second arm could be a sensing arm, and the other arm could be a reference arm. In an additional example, core 210 with thermal controller 2806, as well as cores 210 disposed in acoustic responsive cladding 2910, could be arranged as a resonator loop with cladding facets. It will be appreciated that such hybrid configurations of sensors can provide and/or enhance the individual controllability of the sensor as compared over sensors with monolithic-cladding resonator loop. It will also be recognized that using such hybrid solutions can involve a balance in view of single-pass optical nature and possible extra reflection/scattering loss at the cladding facets for the interferometer design and the hybrid resonator loop, respectively. For example, a hybrid design such as the configuration displayed in FIG. 29 may involve a reduced interference transduction efficiency characterized by a change in transmission power per unit spectral shift.

FIG. 30 illustrates a cross-section view of an AR optical sensor 3000. Sensor 3000 may include one or more cores 210, a cladding 2804, and an acoustic responsive cladding 2910. In some embodiments, sensor 3000 may include an external circuit (EC) stack 3012. An EC stack may include circuitry and cables. In some embodiments, an EC stack may be rigid or include rigid portions. Additionally, or alternatively, an EC stack may be flexible or include flexible portions. In some embodiments, an EC stack may include one or more electronic components capable of flexing (e.g., bending, folding, or twisting), such as flexible cables. For example, EC stack 3012 may be an assembly of layers of circuit components or printed circuit boards. In sensor 3000, thermal controller 3006 may be realized on the surface or close to the surface of EC stack 3012. For example, thermal controller 3006 may be fabricated on EC stack 3012, or thermal controller 3006 and EC stack 3012 can be fabricated separately and packaged together. EC stack 3012 may be adjacent to the optical layer of sensor 3000. As an example, EC stack 3012 may be disposed on top of an optical layer including cores 210. It will be appreciated that sensor 3000 can achieve a high controlling efficiency via the thermo-optical effect and/or thermally-induced solid mechanical field, such as when EC stack 3012 flexes in response to thermal modulations due to thermal controller 3006. In some embodiments, the acoustic responsive cladding 2910 can be thinner than some cladding layers of sensors described herein (e.g., sensor 2900 of FIG. 29) as the optoelectrical devices and links can be placed in EC stack 3012 (e.g., rather than in an optical layer), simplifying the complexity of the BEOL structures and/or reducing the cost of the wafer. Thus, it will be appreciated that introducing an external thermal controller, such as thermal controller 3006, in external EC stack 3012 can provide high interference transduction efficiency, while reducing possible incompatibility between the thermal controller and the acoustic responsive cladding. In some embodiments, attachment between an optical layer and an external heater layer could be realized with either the acoustic responsive material itself or adhesive (e.g., 5-10 um of extra adhesive). For example, in sensor 3000, EC stack 3012 including thermal controller 3006 can be connected to an optical layer having cores 210 via adhesives. EC stack 3012 may be realized with a polymer substrate or flexible glass substrate with sub-100-micron thickness. The EC substrate, the electrical traces, and/or the thermal controllers, (and adhesives, if applicable) can be considered in the acoustic design. It will be appreciated that, by moving electrical traces into EC stack 3012, the layer number in chip fabrication could be reduced, thereby enabling simpler manufacturing and reduced costs. In some embodiments, EC stack 3012 may provide acoustic matching. For example, FC stack 3012 may be a matching layer, such that an acoustic impedance of EC stack 3012 can be matched to that of an imaged medium. In such cases, the thickness of the EC stack 3012 can be configured to provide optimal matching. Additionally, or alternatively, sensor 3000 may include a separate matching layer, as described herein. In some embodiments, EC stack 3012 could extend further out from a receiver chip, thereby saving extra electrical packaging processes in PIARA manufacturing.

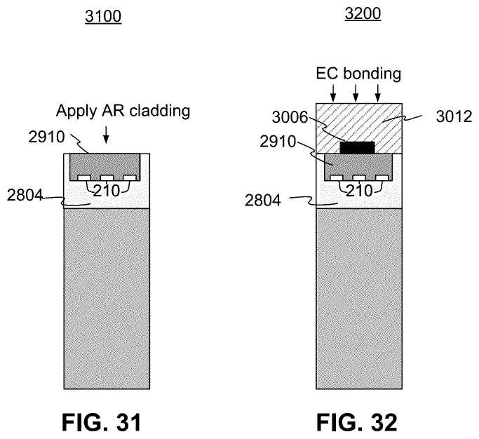

FIGS. 31-35 illustrate embodiments of a flexible receiving array with an external circuit (EC) stack, consistent with embodiments of the present disclosure. As described herein, an EC stack may be configured to flex (e.g., through flexible cables or circuitry). It will be appreciated that the introduction of an EC stack enables the design of a flexible receiving array (e.g., PIARA), which could broaden the applications of PIARA in curved ultrasound probes and endoscopic ultrasound probes with special considerations. FIGS. 31-35 may illustrate a cross-sectional view of a process flow diagram for manufacturing of a receiving array. FIGS. 31 and 32 depict a fabrication process of a receiving array including a sensor design such as sensor 3000 of FIG. 30. In step 3100, the acoustic cladding 2910 can be applied to cores 210 or a handling substrate of the core 210.

In step 3200, EC stack 3012 can be bonded and flipped to the chip. As described herein, EC stack 3012 can include thermal controller 3006, thereby providing an external thermal controller. In some embodiments, AR cladding 2910 can serve as an adhesive layer for EC stack 3012.

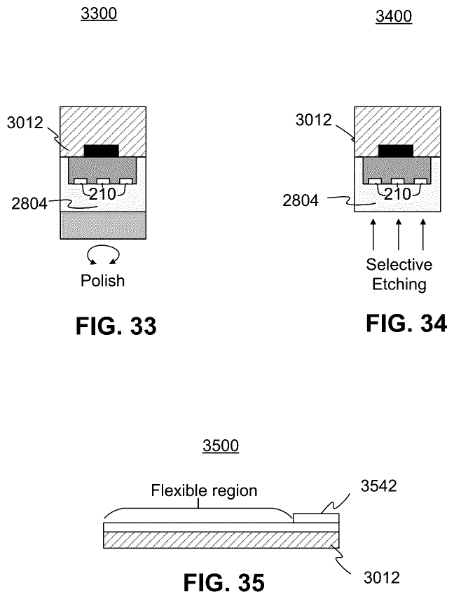

In some embodiments, manufacturing of a flexible receiving array can involve additional steps. As shown in FIGS. 33 and 34, step 3300 may involve polishing, and step 3400 can involve selective etching. In step 3300, a handling substrate of the chip can be removed by polishing and etching. As an example, in using a silicon-on-insulator (SOI) based platform, the silicon handling substrate is typically ˜725 um thick. Back-side polishing can reduce its thickness down to ˜100 μm or thinner.

In step 3400, selective etching may be applied. For example, Xenon difluoride etching can provide the selective etching with extremely high selectivity to silicon with respect to aluminum, photoresist, glass, polymer, or the like. After the etching process, the single-crystalline silicon substrate is removed. Steps 3100, 3200, 3300, and/or 3400 can provide a photonic circuit layer embedded in its original cladding, which has a total thickness <10 um and is thus flexible. EC stack 3012, while serving as the mechanical support, also embeds electrical paths, avoiding some electrical packaging processes (wire bonding, flip chip bonding, or the like.) that can be highly non-trivial for flexible photonic integrated circuits (PICs).

In step 3500 a receiver array can be packaged, such as by flipping (e.g., flip-chip bonding). It will be recognized that optical attachment can involve sub-micron alignment accuracy, especially in the case of a flexible or curved PIC. As such, a stiffener could be introduced prior to or after selective etching of step 3400, in some embodiments. For example, FIG. 35 illustrates that receiving array may include a flexible region 3540 and a stiffener 3542. In some embodiments, a part of the handling substrate could be protected by a photoresist layer and serve as the stiffener. During optical attachment, the stiffener can provide mechanical support for coupler alignment and/or sufficient side facet for side bonding.

In some embodiments, an advantage of a flexible PIARA is that the acoustic substrate of this array can be the material forming the EC stack instead of the handling substrate. As described herein, some embodiments of receiving arrays may include matching layers. Due to the photonic circuit layer being negligibly thin compared to ultrasonic wavelengths (e.g., medical ultrasonic wavelengths), a function of matching layers can be to match the difference in acoustic impedance between the tissue and the handling substrate. For example, a matching layer may be disposed between the PIARA chip and the imaged medium. Thus, compared to standard handling substrates like silicon, an advantage of sensors including a EC stack is that the acoustic impedance of the EC substrate can be much closer to that of the imaged medium, which can simplify the design of matching layers or even allow for configurations without matching layers.

It will be appreciated that the process shown in FIGS. 31-35 is not limited to sensor 3000 shown in FIG. 30. For standard-cladding PIAS, the EC stack can also be introduced to flip-chip bonded to surface pads. An underfill layer between the EC stack and the photonic circuit layer can be added for the acoustic design.

### Sensor Array and Signal Reading

Sensor arrays may have various options for routing input and output signals. As described herein, a sensor array may refer to a receiver array, and may include a plurality of optical sensors (e.g., a PIARA). In some embodiments, ultrasound imaging uses a receiver array with a channel count as high as 256 (or higher), corresponding to 256 or higher individual sensors (e.g., PIASs). FIGS. 36-39 illustrate different designs for providing input and output channels to sensors, consistent with embodiments of the present disclosure. It will be recognized that although the individual sensor elements could be defined by photolithography with high accuracy, it is not likely that the overall phase shift from input to output of different sensors are aligned with an error much smaller than 2π. Therefore, without specific design, sensor arrays may use an individual light source or be tuned individually to realize optimal signal transduction. Further, the optimal configuration of a sensor array can be determined by concerns in form factor, system cost, application scenario, or the like. For example, individual tunable light source array could be expensive, but allow for a simpler all-optical receiving array with superior electromagnetic compatibility and potentially smaller form factor (e.g., and therefore may be a preferred design for smaller-scale endoscopic PIARA and/or multimodality imaging). However, with a large channel count for hand-held transducers, individual tuning devices could realize the operation of the PIARA with single or few optical sources with fixed wavelengths, which could reduce the cost of the system without compromising noise performance (e.g. intensity noise and/or phase noise) of the optical sources for small footprint and tunability. An additional consideration for input and output routing can be cable complexity. As will be described below, power splitting could be introduced to reduce the count of input optical cables, while wavelength multiplexing could be introduced to reduce the count of both input and output optical cables. In some embodiments, the inclusion of wavelength division multiplexers and/or demultiplexers can introduce an overall optical power crosstalk suppression, such as by reducing overlap or mixing of signals from different sources. While FIGS. 36-39 may show sensor arrays having four sensors, it will be appreciated that the displayed number of sensors is for convenience of illustration, and the disclosed embodiments include sensor arrays having any number of sensors (e.g., one, two, three, four, five, 10, 128, 256 or more sensors).

FIG. 36A depicts an embodiment of a circuit schematic for a sensor array 3600A, consistent with embodiments of the present disclosure. Array 3600A may include a plurality of optical sensors. Sensors, as described herein, can be configured to receive an input signal and transmit an output signal. For example, an input signal and the output signal can be optical signals, and the output signal can contain information about an acoustic wave incident on the sensor. The plurality of optical sensors in Array 3600A can include first optical sensor 3610, second optical sensor 3620, third optical sensor 3630, and fourth optical sensor 3640. Optical sensors 3610, 3620, 3630, and 3640 may include a waveguide, as described herein. The waveguide for the optical sensors may be coupled to an optical input port and an optical output port. In some embodiments, the waveguide may be disposed between the optical input port and the optical output port. An optical port may include any interface or aperture for receiving signals (e.g., electrical signals, ultrasound signals, light, or the like). For example, sensor 2610 may have an optical input port 3612 which can receive an input corresponding to sensor 2610. Optical input port 3612 may receive an input from first channel 3616, which can correspond to an input source (e.g., a light source). Optical output port 3614 may transmit an output signal to output channel 3618. Similarly, respective optical sensors 3620, 3630, and 3640 may be coupled to optical input ports 3622, 3632, 3642, linked to corresponding to input channels 3616, 3626, 3636, 3646 respectively, and the respective sensors may also be coupled to optical output ports 3624, 3634, 3644, linked to corresponding to output channels 3628, 3638, and 3648. It will be appreciated that, in sensor array 3600A, individual tuning of input channels, such as tuning different lasers, can propagate tuned signals to their corresponding sensors. Sensor array 3600A may be referred to as “All-Optical Individual-Input-Individual-Output,” in which the number of total optical ports is two times that of the PIARA channel count.

FIG. 36B depicts an embodiment of a circuit schematic for a sensor array 3600B, consistent with embodiments of the present disclosure. Sensor array 3600B may be a variation of sensor array 3600A. In some embodiments, sensor array 3600B may include reflectors coupled to optical ports. A reflector may redirect signals back to the input of the signal. For example, sensor array 3600B may include a reflector 3619 coupled to optical output port 3614, a reflector 3629 to optical output port 3624, a reflector 3639 coupled to optical output port 3634, and a reflector 3649 to optical output port 3644. The reflectors may direct the signal back through the optical output ports and to I/O channels 3618, 3628, 3638, 3648, which serves as both input and output channels corresponding to optical sensors 3610, 3620, 3630, and 3640, respectively. . . . As such, it will be appreciated that the total number of optical inputs and outputs can be reduced by half. In some examples, an input signal (e.g., light) may be received at I/O channels 3618, 3628, 3638, and 3648. Sensor array 3600B may be referred to as “All-Optical Reflector-based Single-Input-Output-Port.”

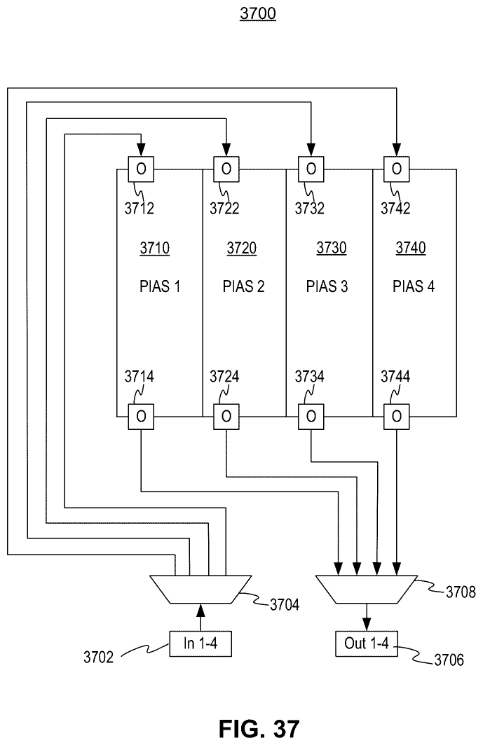

FIG. 37 depicts a circuit schematic for a sensor array 3700, consistent with embodiments of the present disclosure. Sensor array 3700 may include first sensor 3710, second sensor 3720, third sensor 3730, and fourth sensor 3740, each including a waveguide coupled to an optical input port and an optical output port. For example, sensor 3710 may be coupled to optical input port 3712 and optical output port 3714. Similarly, sensor 3720, sensor 3730, and sensors 3740 may be coupled to optical input ports 3722, 3732, 3742, respectively, as well as optical output ports 3734, 3734, and 3744, respectively. In some embodiments, the waveguide may be disposed between a sensor's optical input port and optical output port. Sensor array 3700 may include inputs and/or shared outputs shared between sensors. In some embodiments, sensor array 3700 may receive a mixed input signal. A mixed input signal may be an input signal including a plurality of signals. For example, input channel 3702 may include a plurality of input optical signals, and the input optical signals may have different or unique wavelengths. In some embodiments, sensor array 3700 may include a demultiplexer 3704. Demultiplexer 3704 may be any component or device configured to split the mixed input signal into separate signals. In the example, demultiplexer 3704 may be a dense wavelength-division demultiplexer (dWDM) where every sensor receives light at different wavelength, that is coupled to the optical input channel 3702. Based on the wavelengths of the signals in the mixed input signal, demultiplexer 3704 may demultiplex the input into a plurality of input optical signals (e.g., with unique wavelengths). Demultiplexer 3704 may be coupled to optical input ports 3712, 3722, 3732, and 3742 for respectively receiving the plurality of input optical signals. In some embodiments, demultiplexer 3704 may separate a first input signal from a second input signal before the first input signal is received by the first optical sensor 3710 and the second signal is received by second optical sensor 3720. Sensor array 3700 may include a multiplexer 3708, which can combine signals from different sensors. For example, multiplexer 3708 may be a wavelength-division multiplexer (WDM) that is coupled to optical output ports 3714, 3724, 3734, and 3744 to multiplex the plurality of output optical signals into a single output channel. Each of the output optical signals may have a unique wavelength associated therewith to match the wavelength of a corresponding one of the input optical signals. Multiplexer 3708 may be coupled to an output channel 3706 to output the plurality of output optical signals as a mixed output signal to an output channel 3706. Thus, it will be appreciated that the introduction of a wavelength division multiplexer (WDM) could reduce the number of optical ports. optical fibers, and on-chip I/O ports. Sensor array 3700 may be referred to as an exemplary configuration of All-Optical WDM-based Shared-Input-Shared-Output.

In some embodiments, a first optical port part of the first sensor is arranged so that the first input signal is received at the first optical port, a first reflector is part of the first sensor arranged so that the first output signal is reflected off the first reflector and to the first optical port, a second optical port is part of the second sensor arranged so that the second input signal is received at the second optical port, and a second reflector is part of the second sensor arranged so that the second output signal is reflected off the second reflector and to the second optical port (e.g., see FIG. 37).

In an alternative embodiment, a plurality of optical input ports is provided for respectively receiving a plurality of input channels. In this embodiment, each of the input channels carries a plurality of input optical signals, where each of the input optical signals within each of the input channels has a unique wavelength associated therewith. A power splitter may be in communication with the plurality of optical input ports for splitting each of the input channels into a plurality of sub-channels carrying a plurality of input optical sub-signals. A wavelength-division demultiplexer is coupled to the power splitter to demultiplex each of the plurality of input optical sub-signals, and a plurality of optical sensors are coupled to the wavelength-division demultiplexer for respectively receiving the plurality of input optical sub-signals and outputting a corresponding plurality of output optical signals. Each of the output optical signals may have a unique wavelength associated therewith matching the wavelength of a corresponding one of the input optical sub-signals. A wavelength-division multiplexer is coupled to the plurality of optical sensors to multiplex the plurality of output optical signals into a plurality of output channels. A plurality of optical output ports is coupled to the wavelength-division multiplexer for outputting the plurality of output optical signals in the plurality of output channels. In this embodiment, the total number of the plurality of output channels is equal to a total number of the output optical signals divided by a total number of the input channels.

In some embodiments, sensor array configurations 3600A, 3600B, and 3700 can be selected for smaller-scale PIARA use cases, such as applications like mechanical scanned ultrasound probes and endoscopic ultrasound probes. Such use cases may also include when the channel count may be small or where constraints (e.g., cost) can limit the number of lasers. For example, sensor array configurations 3600A, 3600B, and 3700 may be all-optical configurations that use a laser for each optical sensor element, and the laser's signal is used at the same time for imaging reconstruction.

In some embodiments, a design goal of receiver array routing is to reduce the number of light sources, since optical sensors as described herein may include interference-based sensors that can use narrow-linewidth light source with low phase noise. It will be recognized that such sources can greatly contribute to the system cost. In addition, it will be recognized that optical sensors on the same chip may not be able to share the same light source. This is because, although the spectrum of an optical sensor can be determined by its layout and the mode index, fabrication uncertainty can make prediction of the wavelength of the spectral slope (e.g., a rate of change in intensity or amplitude of a signal) challenging, especially for resonators with high quality numbers (e.g., Q>105) and/or interferometers with small free spectrum ranges (e.g., FSR<0.05 nm). The disclosed embodiments may provide individual tuning (e.g., of optical sensors) as a way to overcome such challenges.

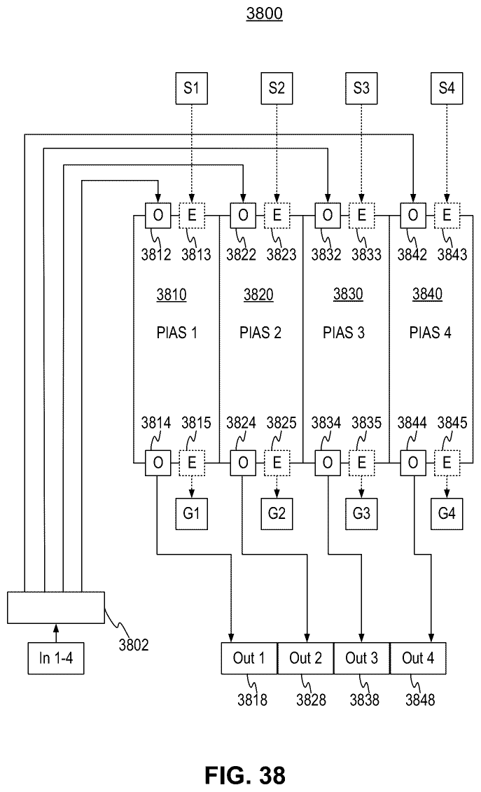

FIG. 38 depicts a circuit schematic for a sensor array 3800, consistent with embodiments of the present disclosure. Sensor array 3800 may include shared inputs and individual outputs for first sensor 3810, second sensor 3820, third sensor 3830, and fourth sensor 3840, which may each include an optical waveguide or multiple optical waveguides. Sensor 3810 may be coupled to optical input port 3812 and optical output port 3814. Similarly, sensor 3820, sensor 3830, and sensors 3840 may be coupled to optical input ports 3822, 3832, 3842, respectively, as well as optical output ports 3824, 3834, and 3844, respectively. In some embodiments, the waveguide of a sensor may be disposed between an optical input port and optical output port (e.g., first optical sensor 3810 may be disposed between optical input port 3812 and optical output port 3814). In some embodiments, sensors of sensor array 3800 may include tuning devices. For example, first sensor 3810 may include an integrated tuning device (e.g., disposed in an optical layer or adjacent to a waveguide core of first sensor 3810). Additionally, or alternatively, first sensor 3810 may include an external tuning device, such as a tuning device in a EC stack (e.g., as illustrated in FIG. 30). By introducing an optoelectrical signal trace to a sensor of sensor array 3800, an electrically controlled tuning device (e.g., a tuning device such as a thermo-optical tuning devices, doped-silicon optoelectronics tuning devices, Pockels-based tuning devices, or the like) could be introduced into the sensor. In some embodiments, sensor array 3800 may include electrical input and output ports for transmitting or receiving electrical inputs that can control a tuning device. First sensor 3810 may include an electrical input port 3813 and electrical output port 3815. Electrical input port 3813 may receive an electrical signal for controlling a tuning device. In some embodiments, electrical outport 3815 may be connected to ground. Similarly, second sensor 3820, third sensor 3830, and fourth sensor 3840 may be coupled to electrical input port 3823, 3833, and 3843, respectively, as well as electrical output port 3825, 3835, and 3845, respectively. The electrical input ports may receive electrical signals specific to a given optical sensor. For example, signal S1 may be an electrical signal transmitted to electrical input port 3813 for controlling a tuning device of first sensor 3810. Signal S1 may tune optical sensor 3810, including with tuning devices described herein. In some embodiments, sensor array 3800 may include a shared input signal 3802. For example, input signal 3802 may be a light source. In some embodiments, the shared input signal 3802 may be branched into various signals corresponding to various optical sensors. For example, input signal 3802 may be branched (e.g., by a wavelength division DEMUX or other DEMUX, beam splitters, or the like) into a plurality of input signals received by input optical ports 3812, 3822, 3832, and 3842. Output signals may be transmitted from output optical ports 3814, 3824, 3834, and 38344 to corresponding output channels 3818, 3828, 3838, and 3848. Sensor array 3800 may referred to as a configuration of “Optoelectrical-based Shared-Input-Individual-Output.”

It will be appreciated that, while the acoustic responsive waveguide can translate MHz-level ultrasound signal into a small phase signal, a low frequency (sub-MHz) phase shift bias could be induced by tuning devices (e.g., such as a optoelectrical tuning devices) to compensate the total phase shift difference caused by possible fabrication errors, enabling multiple optical sensors to reach increased or optimal signal transduction with the same light source. Although both the acoustic response signal and the controlling bias can be encoded in the phase of the waveguide and transduced into an optical power signal, they could be split by electrical filtering. In this way, receiving array 3800 can share one light source, such as shared input 3802. Thus, it will be appreciated that the disclosed embodiments can provide advantages such as increased tunability and using less light sources (and thereby reduced costs of light sources), especially for receiver arrays with more than tens of channels.

Thus, for a large-scale receiving array (e.g., channel count>32), the configuration shown in FIG. 38 could be preferrable in some embodiments. For example, with enough optical power, a PIARA containing 128 channels could be driven by a single fixed-wavelength light source with a 1×128 power branching (e.g., using multiple-stage branching). If the last power-branching stage is 1×8 branching, the PIARA may have 16 inputs (128/8) and 128 outputs. However, the configuration in FIG. 38 has not only optical inputs/outputs, but also electrical inputs/outputs to realize the individual tunability. If assuming 8 PIASs shares a common ground, the 128 channel PIARA has 16 ground contacts and 128 signal electrical inputs. The space along a lateral side of a chip is can be used for inputs/outputs, since the size of this side may scale with the array size. It will be recognized that, due to constraints of packaging processes, optical and electrical inputs/outputs might not overlap in the lateral axis without special design considerations. A solution to this layout challenge can be a combination of different configurations. For example, a 4-wavelength WDM (e.g., FIG. 38) can be added to the aforementioned 128-channel PIARA by changing the last stage 1×8 branching to a 1×2 power branching cascade with a 1×4 wavelength branching. An optical input/output count could be reduced to 16 inputs and 32 outputs. In some embodiments, sensor array 3800 may include reflectors. For example, reflectors may be coupled to optical output sensors 3814, 3824, 3834, or 3844. If reflective structures are introduced (e.g., similar to FIG. 37) in each PIAS, the 1×2 power branching can be removed (otherwise the merged output signal pumped by the same wavelength would not be separated). Accordingly, a total of 32 optical input/output could support one PIARA. The 4-wavelength WDM increases the number of light sources from 1 to 4, but the output power of each source may be reduced (e.g., ¼ of) from the single-source case (e.g., of FIG. 38).

In some embodiments, the first input signal is from light from a laser, and the second input signal is from light from the laser/and/or the apparatus comprises a beam splitter for splitting light from a laser to provide the first input signal and the second input signal (e.g., see FIG. 38).

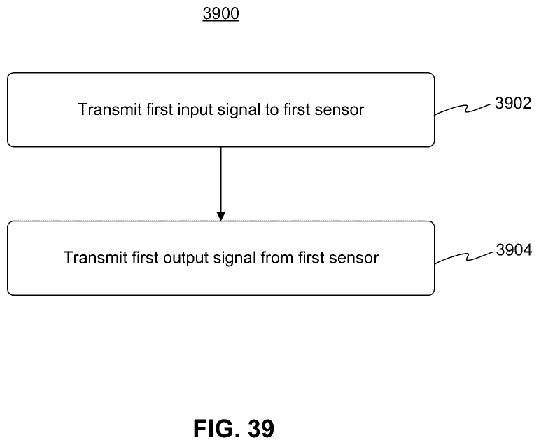

FIG. 39 illustrates a flowchart of an embodiment of a process 3900 for using a sensor array for acoustic sensing. In some embodiments, process 3900 includes a step 3902 of transmitting an input signal to a first sensor. For example, a first input signal, In 1, is transmitted to PIAS 1 in FIG. 36A. In some embodiments, step 3902 may involve transmitting a second input signal to a second sensor. For example, a second input signal, In 2, is transmitted to PIAS 2 in FIG. 36A. The first and second input signals may be transmitted at the same time or at a substantially similar time. For example, PIAS 1 and PIAS 2 in FIG. 36 may be configured to receive the first and second input signals in parallel. In some embodiments, process 3900 includes a step 3904 of transmitting a first output signal from the first sensor. For example, Out1 is transmitted from PIAS 1 in FIG. 36A. The first output signal may contain information about an acoustic wave incident on the first sensor that modifies the first input signal. In some embodiments, step 3902 may involve transmitting a second output signal from the second sensor. For example, Out2 is transmitted from PIAS 2 in FIG. 36A. The second output signal may contain information about the acoustic wave incident on the second sensor that modifies the second input signal. The first input signal, the first output signal, the second input signal, and the second output signals may be optical signals. In some embodiments, the first sensor and the second sensor may be part of a sensor array.

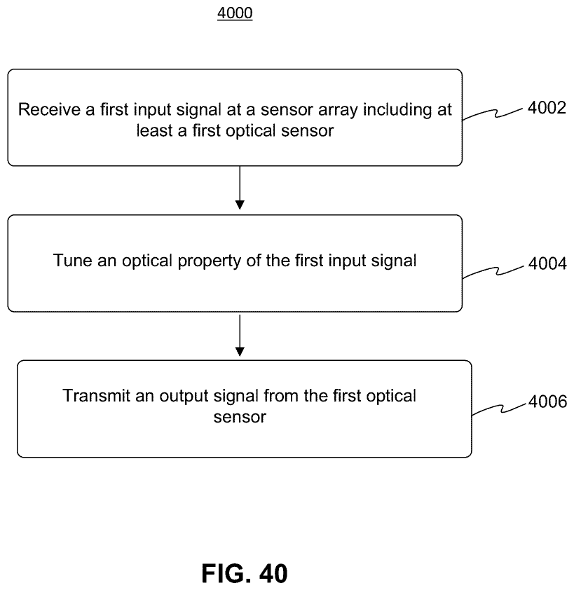

FIG. 40 illustrates a flowchart of a process 4000 for reading signals from a sensor array, consistent with embodiments of the present disclosure. In some embodiments, process 4000 may be described with reference to sensor arrays described herein, including any of sensor arrays 3600A, 3600B, or 3700, and/or implemented using any of sensor arrays 3600A, 3600B, or 3700.

In some embodiments, process 4000 includes a step 4002 of receiving a first input signal at a sensor array including a plurality of optical sensors. Each optical sensor may include one or more optical waveguides disposed between an optical input port and an optical output port of the sensor. The first input signal may correspond to a first optical sensor, and the first input signal may be received at an optical input port of the first optical sensor. The first input signal may correspond to a first input source, such as a laser in some examples. In some embodiments, step 4002 may involve receiving additional input signals, such as a second input signal corresponding to a second optical sensor. It will be appreciated that the disclosed embodiments are not limited to a particular number of input signals and corresponding optical sensors, as described herein. The sensor array may be configured to receive the first input signal, the second input signal, and/or additional input signals in parallel.

In some embodiments, process 4000 includes a step 4004 of tuning an optical property of the first input signal. For example, optical properties of the first input signal may include wavelength, power, amplitude, or the like. The first input signal may be tuned based on an operation point of the first optical sensor. For example, the first input signal may be tuned at the input source, such as tuning the input signal to match an optical property of the optical sensor. In some embodiments, step 4004 may include tuning additional input signals, such as tuning a second input signal based on a second optical sensor.

In some embodiments, process 4000 includes a step 4006 of transmitting a first output signal from the first optical sensor. An output signal may include an optical interference signal, as described herein. For example, a first output signal may include an optical power response generated from the first optical sensor due to interference. The first output signal may be transmitted from an optical output port of the first optical sensor. In some embodiments, step 4006 includes transmitting a second output signal from a second optical sensor.

In some embodiments, process 4000 may be applied to a sensor array configured to receive a mixed input signal, such as sensor array 3700. For example, step 4002 may involve receiving a mixed input signal. A mixed input signals may include a plurality of signals, as described herein. The plurality of input signals may each correspond to an optical source. Step 4002 may involve demultiplexing the mixed input signal into a plurality of input signals, and receiving the plurality of input signals at the sensor array. For example, a wavelength division multiplexer can split the mixed signals into a plurality of input signals based on wavelength. In such a case, step 4004 may involve receiving an electrical control signal (e.g., an electrical tuning signal) for each optical source. The electrical control signal may shift the wavelength to according to an optical sensor. For example, a first electrical control signal may shift the wavelength of a source to match that of a first optical sensor.

In some embodiments, process 4000 may be applied to a sensor array configured to reflect signals. For example, step 4006 may include reflecting a signal. In such an example, optical sensors of sensor array 3700 may include reflectors coupled to the output port of the optical sensor. The reflectors may be configured to reflect an output signal.

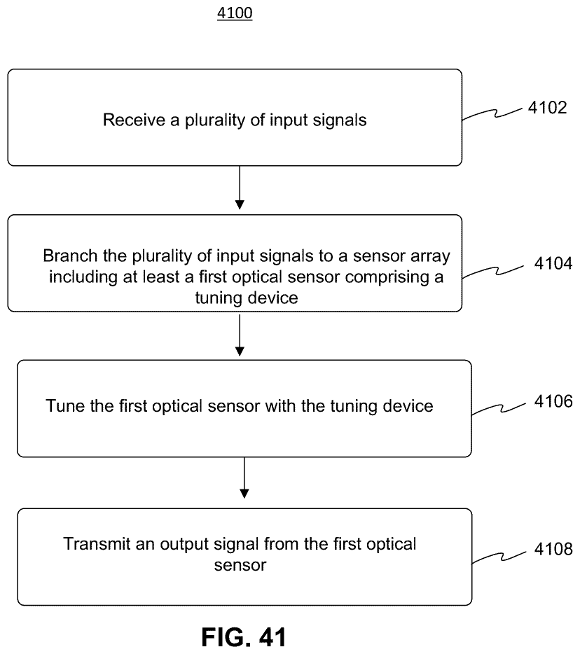

FIG. 41 illustrates a flowchart of a process 4100 for reading signals from a sensor array, consistent with embodiments of the present disclosure. In some embodiments, process 4000 may be described with reference to sensor arrays described herein, including sensor array 3800, and/or implemented using sensor 3800.

In some embodiments, process 4100 includes a step 4102 of receiving a plurality of input signals from an input source. For example, the plurality of input signals may be received from a shared or multiple light sources.

In some embodiments, process 4100 includes a step 4104 of branching the plurality of input signals to a sensor array comprising at least one optical sensor. In some embodiments, the sensor array includes a plurality of optical sensors. The optical sensors may include one or more optical waveguides, which may be disposed between an optical input port and an optical output port, and one or more acoustic responsive cladding regions. The optical sensors may additionally include a tuning device and an electrical input port. In some embodiments, the optical sensor may include a top player disposed adjacent to an optical layer. The top layer may include an external tuning device, an acoustic matching layer, an acoustic interference layer, or an acoustic lens, as described herein. Additionally, or alternatively, the optical layer may include a tuning device (e.g., an integrated tuning device). Branching the plurality of signals may include splitting the plurality of signals, such that different signals may be received by corresponding sensors. For example, branching may involve couplers, splitters, demultiplexers (e.g., wavelength demultiplexers), or the like. Each optical sensor may receive an input signal at an optical input port. For example, a first input signal may correspond to a first optical sensor and the first input signal may be received at a first optical input port. In some embodiments, step 4104 may involve receiving additional input signals corresponding to optical sensors. In some embodiments, the sensor array (e.g., sensor 3800) may be configured to receive a first input signal in parallel with a second input signal. In some embodiments, the sensor array may receive a plurality of electrical control signals at electrical input ports for the optical sensors. For example, based on the various input signals or optical sensors corresponding to the input signals, the sensor array may receive a corresponding number of electrical control signals.

In some embodiments, process 4100 includes a step 4106 of tuning the first optical sensor with the tuning device. One or more tuning devices may assist with tuning optical sensors according to a wavelength of the optical source, as described herein. Step 4106 may involve controlling the tuning devices with the plurality of electrical control signals. For example, a first electrical control signal may control the tuning of a first tuning device disposed in a first optical sensor, and a second electrical control signal may control the tuning of a second tuning device disposed in a second optical sensor. In some embodiments, the tuning device may be a thermo-optical tuning device that can change an effective mode index of the optical sensor (e.g., such as in FIG. 21). For example, step 4106 may involve controlling (e.g., via the electrical control signal) the amount of current delivered to a heater in order to tune the optical waveguide. In some embodiments, the tuned optical waveguide may have an overlap with a localized field of temperature from the tuning device and/or the tuning device may reduce crosstalk of the sensor array. In some embodiments, the tuning device may be an electro-optical or free-carrier-injection-based tuning device that can change an effective mode index of the optical sensor (e.g., FIG. 22). In some embodiments, the tuning device may be a mechanical actuator that induces solid-mechanical field that can change an effective mode index of the optical sensor.

In some embodiments, process 4100 includes a step 4108 of transmitting an output signal from the first optical sensor. An output signal may include an optical interference signal, as described herein. For example, a first output signal may include an optical power response generated from the first optical sensor due to interference. The first output signal may be transmitted from an optical output port of the first optical sensor. In some embodiments, step 4108 includes transmitting a second output signal from a second optical sensor.

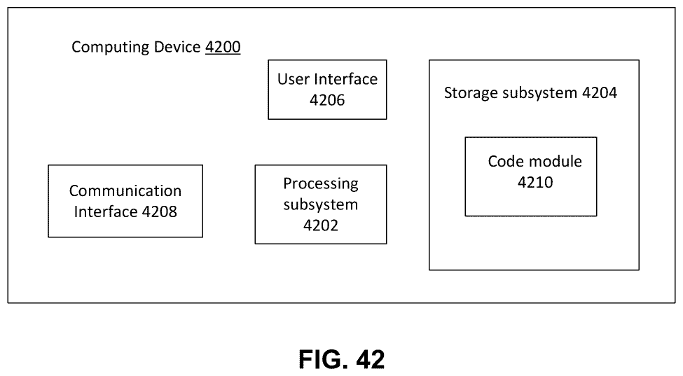

FIG. 42 is a simplified block diagram of a computing device 4200. Computing device 4200 can implement some or all functions, behaviors, and/or capabilities described above that would use electronic storage or processing, as well as other functions, behaviors, or capabilities not expressly described. In some embodiments, computing device 4200 may include or implement system 100, as described in FIG. 1. Computing device 4200 includes a processing subsystem 4202, a storage subsystem 4204, a user interface 4206, and/or a communication interface 4208. Computing device 4200 can also include other components (not explicitly shown) such as a battery, power controllers, and other components operable to provide various enhanced capabilities. In various embodiments, computing device 4200 can be implemented in a desktop or laptop computer, mobile device (e.g., tablet computer, smart phone, mobile phone), wearable device, media device, application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, or electronic units designed to perform a function or combination of functions described above.

Storage subsystem 4204 can be implemented using a local storage and/or removable storage medium, e.g., using disk, flash memory (e.g., secure digital card, universal serial bus flash drive), or any other non-transitory storage medium, or a combination of media, and can include volatile and/or non-volatile storage media. Local storage can include random access memory (RAM), including dynamic RAM (DRAM), static RAM (SRAM), or battery backed up RAM. In some embodiments, storage subsystem 4204 can store one or more applications and/or operating system programs to be executed by processing subsystem 4202, including programs to implement some or all operations described above that would be performed using a computer. For example, storage subsystem 4204 can store one or more code modules 4210 for implementing one or more method steps described above.

A firmware and/or software implementation may be implemented with modules (e.g., procedures, functions, and so on). A machine-readable medium tangibly embodying instructions may be used in implementing methodologies described herein. Code modules 4210 (e.g., instructions stored in memory) may be implemented within a processor or external to the processor. As used herein, the term “memory” refers to a type of long term, short term, volatile, nonvolatile, or other storage medium and is not to be limited to any particular type of memory or number of memories or type of media upon which memory is stored.

Moreover, the term “storage medium” or “storage device” may represent one or more memories for storing data, including read only memory (ROM), RAM, magnetic RAM, core memory, magnetic disk storage mediums, optical storage mediums, flash memory devices and/or other machine readable mediums for storing information. The term “machine-readable medium” includes, but is not limited to, portable or fixed storage devices, optical storage devices, wireless channels, and/or various other storage mediums capable of storing instruction(s) and/or data.

Furthermore, embodiments may be implemented by hardware, software, scripting languages, firmware, middleware, microcode, hardware description languages, and/or any combination thereof. When implemented in software, firmware, middleware, scripting language, and/or microcode, program code or code segments to perform tasks may be stored in a machine readable medium such as a storage medium. A code segment (e.g., code module 4210) or machine-executable instruction may represent a procedure, a function, a subprogram, a program, a routine, a subroutine, a module, a software package, a script, a class, or a combination of instructions, data structures, and/or program statements. A code segment may be coupled to another code segment or a hardware circuit by passing and/or receiving information, data, arguments, parameters, and/or memory contents. Information, arguments, parameters, data, etc., may be passed, forwarded, or transmitted by suitable means including memory sharing, message passing, token passing, network transmission, etc.

Implementation of the techniques, blocks, steps, and means described above may be done in various ways. For example, these techniques, blocks, steps, and means may be implemented in hardware, software, or a combination thereof. For a hardware implementation, the processing units may be implemented within one or more ASICs, DSPs, DSPDs, PLDs, FPGAs, processors, controllers, micro-controllers, microprocessors, other electronic units designed to perform the functions described above, and/or a combination thereof.

Each code module 4210 may comprise sets of instructions (codes) embodied on a computer-readable medium that directs a processor of a computing device 4200 to perform corresponding actions. The instructions may be configured to run in sequential order, in parallel (such as under different processing threads), or in a combination thereof. After loading a code module 4210 on a general purpose computer system, the general purpose computer is transformed into a special purpose computer system.

Computer programs incorporating various features described herein (e.g., in one or more code modules 4210) may be encoded and stored on various computer readable storage media. Computer readable media encoded with the program code may be packaged with a compatible electronic device, or the program code may be provided separately from electronic devices (e.g., via Internet download or as a separately packaged computer-readable storage medium). Storage subsystem 4204 can also store information useful for establishing network connections using the communication interface 4208.

User interface 4206 can include input devices (e.g., touch pad, touch screen, scroll wheel, click wheel, dial, button, switch, keypad, microphone, etc.), as well as output devices (e.g., video screen, indicator lights, speakers, headphone jacks, virtual-or augmented-reality display, etc.), together with supporting electronics (e.g., digital-to-analog or analog-to-digital converters, signal processors, etc.). A user can operate input devices of user interface 4206 to invoke the functionality of computing device 4200 and can view and/or hear output from computing device 4200 via output devices of user interface 4206. For some embodiments, the user interface 4206 might not be present (e.g., for a process using an ASIC).

Processing subsystem 4202 can be implemented as one or more processors (e.g., integrated circuits, one or more single-core or multi-core microprocessors, microcontrollers, central processing unit, graphics processing unit, etc.). In operation, processing subsystem 4202 can control the operation of computing device 4200. In some embodiments, processing subsystem 4202 can execute a variety of programs in response to program code and can maintain multiple concurrently executing programs or processes. At a given time, some, or all of a program code to be executed can reside in processing subsystem 4202 and/or in storage media, such as storage subsystem 4204. Through programming, processing subsystem 4202 can provide various functionality for computing device 4200. Processing subsystem 4202 can also execute other programs to control other functions of computing device 4200, including programs that may be stored in storage subsystem 4204.

Communication interface 4208 can provide voice and/or data communication capability for computing device 4200. In some embodiments, communication interface 4208 can include radio frequency (RF) transceiver components for accessing wireless data networks (e.g., Wi-Fi network; 3G, 4G/LTE; etc.), mobile communication technologies, components for short-range wireless communication (e.g., using Bluetooth communication standards, NFC, etc.), other components, or combinations of technologies. In some embodiments, communication interface 4208 can provide wired connectivity (e.g., universal serial bus, Ethernet, universal asynchronous receiver/transmitter, etc.) in addition to, or in lieu of, a wireless interface. Communication interface 4208 can be implemented using a combination of hardware (e.g., driver circuits, antennas, modulators/demodulators, encoders/decoders, and other analog and/or digital signal processing circuits) and software components. In some embodiments, communication interface 4208 can support multiple communication channels concurrently. In some embodiments, the communication interface 4208 is not used.

It will be appreciated that computing device 4200 is illustrative and that variations and modifications are possible. A computing device can have various functionalities not specifically described (e.g., voice communication via cellular telephone networks) and can include components appropriate to such functionality.

Further, while the computing device 4200 is described with reference to particular blocks, it is to be understood that these blocks are defined for convenience of description and are not intended to imply a particular physical arrangement of component parts. For example, the processing subsystem 4202, the storage subsystem 4204, the user interface 4206, and/or the communication interface 4208 can be in one device or distributed among multiple devices.

Further, the blocks need not correspond to physically distinct components. Blocks can be configured to perform various operations, e.g., by programming a processor or providing appropriate control circuitry, and various blocks might or might not be reconfigurable depending on how an initial configuration is obtained. Embodiments of the present invention can be realized in a variety of apparatus including electronic devices implemented using a combination of circuitry and software. Electronic devices described herein can be implemented using computing device 4200.

Embodiments of the present disclosure may be described with respect to the following clauses:
1: An apparatus for acoustic imaging, the apparatus comprising:
   an optical sensor;
   the optical sensor including an acoustic stack;
   the acoustic stack comprising a backing layer that supports an optical layer;
   the optical layer comprising an optical waveguide and a tuning device configured to tune an optical propagation property of the optical waveguide; and
   the optical waveguide including a core region and one or more cladding regions, the one or more cladding regions having optical refractive index less than that of the core region.
2. The apparatus of clause 1, wherein:
   the optical waveguide includes a plurality of straight parallel portions and a plurality of bend portions disposed within the width of the sensor; and
   an optical propagation property of the optical waveguide is configured to change in response to the ultrasound signals.
3. The apparatus of clause 2, wherein the average spacing of the straight portions is smaller than the smallest bending diameter of the bend portions.
4. The apparatus of any of the preceding clauses, further comprising a plurality of ultrasound transducers configured to generate ultrasound signals, and an optical sensor array comprising the optical sensor.
5. The apparatus of any of the preceding clauses, wherein the optical waveguide is an acoustic responsive optical waveguide configured such that a complex refractive index or a group velocity associated with a guided mode of the acoustic-responsive optical waveguide changes in response to the ultrasound signals reflecting from the imaged medium.
6. The apparatus of any of the preceding clauses, further comprising a top layer coupled to the optical layer.
7. The apparatus of clause 6, wherein the top layer comprises an acoustic matching layer having an acoustic impedance between that of the imaged medium and that of the backing layer, wherein the acoustic matching layer has a thickness configured to facilitate acoustic transmission from the imaged medium to the optical layer.
8. The apparatus of any of the preceding clauses, wherein the optical waveguide includes a plurality of straight portions and a plurality of bend portions disposed within the width of the sensor.
9. The apparatus any of the preceding clauses, wherein the tuning device and the optical waveguide are included in a single layer in a photonic chip, wherein the mode refractive index of the optical waveguide is tuned via at least one of thermo-optical effect, electro-optic effect, photoelastic effect, or free-carrier-based electro-refractive effect.
10. The apparatus of any of clauses 1-8, wherein the tuning device and the optical waveguide are included in different layers in an acoustic stack, wherein the tuning device is in an external layer that is adjacent to the optical layer, the mode refractive index of the optical waveguide is tuned via at least one of thermo-optical effect, electro-optic effect, photoelastic effect, or mechanical deformation of the waveguide structure.
11. The apparatus of any of the preceding clauses, wherein at least one of the cladding regions and/or core regions comprises an acoustic responsive material.
12. A method of imaging comprising:
   receiving an input optical signal at an interference-based device,
   wherein the interference-based device comprises:
      one or more optical waveguides including a cladding, the one or more optical waveguides configured to be perturbed by an acoustic signal from an imaged medium;
      one or more optical ports coupled to the one or more optical waveguides; and
      a tuning device configured to tune an optical waveguide of the one or more optical waveguides;
   generating, via the interference-based device, an optical interference signal encoding a change in an optical propagation property of one or more optical waveguides based on the perturbation by the acoustic signal;
   measuring the optical interference signal from the interference-based device; and
   detecting the acoustic signal from the imaged medium based on the measured optical interference signal.
13. The method of clause 12, wherein the interference-based device comprises an interferometer including:
   a reference arm optical waveguide coupled to an optical input port and an optical output port of the one or more optical ports, and
   a sensing arm optical waveguide coupled to an optical input port and an optical output port of the one or more optical waveguides.
14. The method of clause 13, wherein the reference arm optical waveguide includes an acoustic-responsive material and the tuning device is disposed adjacent to an optical core of the sensing arm optical waveguide.
15. The method of clause 12, wherein the interference-based device comprises a waveguide resonator, the waveguide resonator comprising a resonator body having the one or more optical waveguide.
16. A method of reading signals from a sensor array, the method comprising:
   receiving a plurality of input signals from an optical source;
   branching the plurality of input signals to a sensor array comprising a plurality of optical sensors,
   wherein each optical sensor of the plurality of optical sensors comprises:
      one or more optical waveguides disposed between an optical input port and an optical output port;
      a tuning device; and
      an electrical input port;
   wherein a first input signal of the plurality of input signals corresponds to a first optical sensor of the plurality of optical sensors;
   tuning, with the tuning device of the first optical sensor, the first optical sensor according to a wavelength of the optical source; and
   transmitting, from the optical output port of the first optical sensor, a first output signal.
17. The method of clause 16, further comprising:
   receiving a second input signal corresponding to a second optical sensor of the plurality of optical sensors;
   tuning, with the tuning device of the second optical sensor, the second optical sensor; and
   transmitting, from the second optical sensor, a second output signal.
18. The method of any of clauses 16-17, further comprising:
   receiving a plurality of electrical control signals at each electrical input port; and
   controlling the tuning device of each optical sensor with the plurality of electrical control signals.
19. The method of any of clauses 16-18, wherein the tuning device comprises a thermo-optical tuning device that changes an effective mode index of the optical sensor.
20. The method of any of clause 16-19, wherein the tuning device comprises an optoelectronic tuning device configured to change an effective mode index of the optical sensor.
21. An apparatus for acoustic imaging of a medium, the apparatus comprising:
   an optical sensor;
   the optical sensor including an acoustic stack;
   the acoustic stack comprising a backing layer that supports an optical layer;
   the optical layer comprising an optical waveguide and a tuning device configured to tune an optical propagation property of the optical waveguide; and
   the optical waveguide including a core region and one or more cladding regions, the one or more cladding regions having an optical refractive index less than that of the core region.
22. The apparatus of clause 21, further comprising:
   a plurality of ultrasonic transducers configured to generate ultrasound signals; and
   an optical sensor array comprising the optical sensor.
23. The apparatus of any of clauses 21-22, wherein the optical waveguide is an acoustic responsive optical waveguide configured such that a complex refractive index or a group velocity associated with a guided mode of the acoustic-responsive optical waveguide changes in response to the ultrasound signals reflecting from the imaged medium.
24. The apparatus of any of clauses 21-23, further comprising a top layer coupled to the optical layer.
25. The apparatus of clause 24, wherein the top layer comprises an acoustic matching layer having an acoustic impedance between that of the imaged medium and that of the backing layer, wherein the acoustic matching layer has a thickness configured to facilitate acoustic transmission from the imaged medium to the optical layer.
26. The apparatus of any of clauses 21-24, wherein the optical waveguide includes a plurality of straight portions and a plurality of bend portions disposed within the width of the sensor; and the optical waveguide configured such that an optical propagation property of the optical waveguide changes in response to the ultrasound signals.
27. The apparatus of any of clauses 21-25, wherein:
   the optical waveguide includes a plurality of straight parallel portions and a plurality of bend portions disposed within the width of the sensor;
   the average spacing of the straight portions is smaller than the smallest bending diameter of the bend portions, and
   the optical waveguide configured such that an optical propagation property of the optical waveguide changes in response to the ultrasound signals.
28. The apparatus of any of clauses 21-27, wherein the optical waveguide is configured such that a refractive index or a group velocity associated with a guided mode of the optical waveguide changes in response to the ultrasound signals reflecting from the imaged medium.
29. The apparatus of any of clause 21-28, wherein:
   the optical waveguide is further configured such that an optical propagation property of the optical waveguide changes in response to a physical property associated with the imaged medium;
   the physical property associated with the imaged medium is one of: a temperature; a pressure; or a physical attribute of an acoustic wave, or
   the optical propagation property of the optical waveguide that changes is one of: phase velocity; waveguide loss; waveguide dispersion; leading to the response in interference mode of: a mode shift; a baseline drift; a mode split; a mode broadening; or a change of mode shape.
30. The apparatus of clause 29, wherein the mode shift is one of a change in resonance frequency; a change in depth; and a change in mode shape.
31. The apparatus of any of clauses 21-30, wherein the core region of the optical waveguide includes one of: a rectangular cross-section; a trapezoidal cross-section; an elliptical cross-section; and a tapered edge.
32. The apparatus of any of clauses 21-31, wherein the core region comprises a plurality of sub-core regions, wherein disposed between the sub-core regions is at least one of: a vertical slot; or a horizontal slot.
33. The apparatus of any of clauses 21-32, wherein at least one of the cladding regions and/or core regions comprises an acoustic responsive material.
34. The apparatus of any of clauses 21-33, the thickness of the cladding comprising the acoustic responsive material is smaller than c_{ARC}/4fₕ, where c_{ARC} is the speed of sound in the acoustic responsive cladding, fₕ is the higher band edge of the ultrasound imaging band, reading fₕ=max[3f_{c}, 10 MHz], where f_{c} is the center frequency of the ultrasound generation.
35. The apparatus of any of clauses 21-34, wherein a direction of optical waveguide propagation in at least one of the plurality of straight portions of the optical waveguide is opposite to a direction of optical wave propagation in at least an adjacent another of the plurality of straight portions, or a direction of optical wave propagation in at least one of the plurality of bend portions of the optical waveguide is opposite to a direction of optical wave propagation in at least an adjacent another of the plurality of bend portions.
36. The apparatus of any of clause 21-35, wherein the tuning device and the optical waveguide are included in a single layer in a photonic chip, wherein the mode refractive index of the corresponding acoustic-responsive optical waveguide is tuned via at least one of thermo-optical effect, Pockels effect, photoelastic effect, or free-carrier-based electro-refractive effect.
37. The apparatus of any of clauses 21-35, wherein the tuning device and the optical waveguide are included in different layers in an acoustic stack, wherein the tuning device is in an external layer that is adjacent to the optical layer, wherein the mode refractive index of the corresponding acoustic-responsive optical waveguide is tuned via at least one of thermo-optical effect, Pockels effect, photoelasticity, or mechanical deformation of the waveguide structure.
38. The apparatus of any of clauses 21-37, wherein the photonic chip is one of: a silicon/silicon nitride photonic chip; a lithium niobate photonic chip; a glass-based planar lightwave circuit; and a polymer integrated photonic chip.
39. The apparatus of any of clauses 21-38, wherein the photonic chip is fabricated using at least one of a silicon-on-insulator wafer, silicon-nitride on insulator wafer, silicon carbide on insulator wafer, lithium-niobate-on-Insulator wafer, gallium-phosphorus-on-insulator wafer, gallium-nitride-on-insulator wafer, gallium-arsenide-on-insulator wafer, aluminum-nitride-on-insulator wafer, diamond-on-insulator wafer, or indium-phosphorus-on-insulator wafer.
40. The apparatus of any of clauses 21-39, wherein at least one of the one or more cladding regions is formed from a buried oxide layer of the silicon-on-insulator wafer.
41. The apparatus of any of clauses 21-40, wherein the plurality of ultrasonic transducers are selected from the group consisting of: piezoelectric transducers; lead zirconate titanate transducers; polymer thick film transducers; polyvinylidene fluoride transducers; capacitive micromachined ultrasound transducers; piezoelectric micromachined ultrasound transducers; photoacoustic transducers; and single-crystal material transducers.
42. The apparatus of any of clauses 21-41, wherein the first optical sensor is selected from the group consisting of: waveguide, optical interferometer, optical resonator; and optical fiber sensor.
43. The apparatus of any of clauses 21-42, wherein the backing layer is curved, wherein a flexible superstrate supports the optical layer and is bonded to the curved backing layer.
44. The apparatus of any of clauses 21-43, wherein the optical waveguide includes a plurality of straight portions with spacings approximate to or less than the minimum bending diameter of the optical waveguide.
45. The apparatus of any of clauses 21-44, wherein the tuning device includes an optical source with a tunable output wavelength.
46. A method of imaging comprising:
   receiving an input optical signal at an interference-based device,
   wherein the interference-based device comprises:
      one or more optical waveguides including a cladding, the one or more optical waveguides configured to be perturbed by an acoustic signal from an imaged medium;
      one or more optical ports coupled to the one or more optical waveguides; and
      a tuning device configured to tune an optical waveguide of the one or more optical waveguides;
   generating, via the interference-based device, an optical interference signal encoding a change in an optical propagation property of one or more optical waveguides based on the perturbation by the acoustic signal;
   measuring the optical interference signal from the interference-based device; and
   detecting the acoustic signal from the imaged medium based on the measured optical interference signal.
47. The method of clause 46, wherein a first waveguide has one or more of a different polarization of the waveguide mode, different dimension of a waveguide core or subcore, different acoustic responsive material for a waveguide core or subcore, different acoustic responsive materials for a cladding, or a different tuning device than that of a second waveguide.
48. A method of imaging comprising:
   receiving an input optical signal at an interferometer,
   wherein the interferometer comprises:
      a first coupler coupled to an optical input port of the interferometer;
      a second coupler coupled to an optical output port of the interferometer;
      a reference arm optical waveguide coupled to the first coupler and the second coupler; and
      a sensing arm optical waveguide coupled to the first coupler and the second coupler, the sensing arm optical waveguide configured to be perturbed by an acoustic signal from an imaged medium;
   wherein at least one of the reference arm optical waveguide or the sensing arm optical waveguide includes a cladding;
   wherein at least one of the reference arm optical waveguide or the sensing arm optical waveguide includes a tuning device;
   generating, via the interferometer, an optical interference signal encoding a change in an optical propagation property of the sensing arm optical waveguide based on the perturbation by the acoustic signal;
   measuring the optical interference signal from the interferometer; and
   detecting the acoustic signal from the imaged medium based on the measured optical interference signal.
49. The method of clause 48, wherein the sensing arm optical waveguide and the reference arm optical waveguide both include a cladding.
50. The method of any of clauses 48-49, wherein the reference arm optical waveguide includes an acoustic-responsive material and the tuning device is disposed adjacent to an optical core of the sensing arm optical waveguide.
51. The method of any of clauses 48-50, wherein the tuning device is disposed adjacent to an optical core of the reference arm optical waveguide and the sensing arm optical waveguide includes an acoustic-response material.
52. The method of any of clauses 48-51, wherein a physical length of the sensing arm optical waveguide is one of less than a physical length of the reference arm optical waveguide or greater than a physical length of the reference arm optical waveguide.
53. The method of any of clauses 48-51, wherein a physical length of the sensing arm optical waveguide is substantially similar to a physical length of the reference arm optical waveguide.
54. The method of any of clauses 48-53, wherein the interferometer is configured to provide an ultra-wide acceptance angle.
55. The method of any of clauses 48-55, wherein the optical propagation property is one of a refractive index, an optical path length, an amplitude, or a phase.
56. The method of any of clauses 48-55, wherein the interferometer comprises one of a Mach-Zehnder interferometer (MZI), a Michelson interferometer, a Fabry-Perot interferometer, or a Sagnac interferometer.
57. A method of imaging comprising:
   receiving an input optical signal at a waveguide resonator,
   wherein the waveguide resonator comprises:
      a resonator body;
      a coupler;
      an input optical port and an output optical port each coupled to the coupler; and
   a tuning device;
   wherein the resonator body comprises an optical waveguide configured to be perturbed by an acoustic signal from an imaged medium;
   wherein the optical waveguide is coupled to the coupler and the tuning device is disposed adjacent to the optical waveguide;
   generating, via the waveguide resonator, an optical interference signal encoding a change in an optical propagation property of the optical waveguide based on the perturbation by the acoustic signal;
   measuring the optical interference signal from the waveguide resonator; and
   detecting the acoustic signal from the imaged medium based on the measured optical interference signal.
58. The method of any of clauses 46-57, further comprising receiving the input optical signal at the input optical port.
59. The method of any of clauses 46-58, wherein the coupler is a 2×2 coupler.
60. The method of any of clauses 57-59, further comprising the waveguide resonator is a ring resonator.
61. The method of any of clauses 57-60, further comprising the waveguide resonator is configured as an all-pass spectral filter.
62. The method of any of clauses 57-61, further comprising the waveguide resonator comprises a plurality of couplers.
63. The method of any of clauses 57-62, further comprising the waveguide resonator is configured as an add-drop resonator.
64. The method of any of clauses 57-63, further comprising receiving the input optical signal at an input bus that is shared between an input optical port of a first waveguide resonator and an input optical port of a second waveguide resonator.
65. The method of clause 64, further comprising an output bus is shared between an output optical port of the first waveguide resonator and an output optical port of the second waveguide resonator.
66. The method of any of clauses 57-65, wherein the waveguide resonator comprises a plurality of reflectors coupled to the resonator body.
67. The method of clause 66, wherein the plurality of reflectors is configured such that a phase change in the optical waveguide is accumulated.
68. The method of any of clauses 45-67, further comprising the optical waveguide includes a Fabry-Perot cavity.
69. A method of reading signals from a sensor array, the method comprising:
   receiving a plurality of input signals from an optical source;
   branching the plurality of input signals to a sensor array comprising a plurality of optical sensors,
   wherein each optical sensor of the plurality of optical sensors comprises:
      one or more optical waveguides disposed between an optical input port and an optical output port;
      a tuning device; and
      an electrical input port;
   wherein a first input signal of the plurality of input signals corresponds to a first optical sensor of the plurality of optical sensors;
   tuning, with the tuning device of the first optical sensor, the first optical sensor according to a wavelength of the optical source; and
   transmitting, from the optical output port of the first optical sensor, a first output signal.
70. The method of clause 69, further comprising:
   receiving a second input signal corresponding to a second optical sensor of the plurality of optical sensors;
   tuning, with the tuning device of the second optical sensor, the second optical sensor; and
   transmitting, from the second optical sensor, a second output signal.
71. The method of clause 70, wherein the sensor array is configured to receive the first input signal in parallel with the second input signal and configured to transmit the first output signal in parallel with the second output signal.
72. The method of any of clauses 69-71, further comprising:
   receiving a plurality of electrical control signals at each electrical input port; and
   controlling the tuning device of each optical sensor with the plurality of electrical control signals.
73. The method of any of clauses 69-72, wherein the tuning device comprises a thermo-optical tuning device that changes an effective mode index of the optical sensor.
74. The method of any of clauses 69-73, wherein the tuning device comprises an optoelectronic tuning device configured to change an effective mode index of the optical sensor.
75. The method of any of clauses 69-74, wherein the tuning device comprises a mechanical actuator inducing solid-mechanical field that changes an effective mode index of the optical sensor.
76. The method of any of clauses 69-75, further comprising a top layer placed adjacent to an optical layer of the optical waveguide of the first sensor, the top layer comprising at least one of an external tuning device, an acoustic matching layer, an acoustic interface layer contacting the surface of an imaged medium, or an acoustic lens configured to regulate or focus the wavefront of acoustic signal.
77. The method of any of clause 69-76, wherein the tuning device comprises an integrated heater disposed adjacent to the optical waveguide.
78. The method of any of clauses 69-77, wherein the first optical sensor includes one or more acoustic-responsive cladding regions.
79. The method of any of clauses 69-78, wherein the optical waveguide of the first optical sensor overlaps with a localized field of temperature rise from the tuning device.
80. The method of any of clauses 69-79, wherein the tuning device reduces crosstalk of the sensor array.
81. The method of any of clauses 69-80, wherein the tuning device is disposed in an external circuit stack adjacent to the optical waveguide of the first optical sensor.
82. A method of reading signals from a sensor array, the method comprising:
   receiving, at a sensor array comprising a plurality of optical sensors, a first input signal;
   wherein each optical sensor of the plurality of optical sensors comprises an optical waveguide disposed between an optical input port and an optical output port;
   wherein the first input signal corresponds to a first optical sensor of the plurality of optical sensors;
   tuning an optical property of the first input signal based on an operation point of the first optical sensor; and
   transmitting, from the optical output port of the first optical sensor, a first output signal.
83. The method of clause 82, wherein the first input signal is received from a first input port and the first output signal is transmitted to a first output port.
84. The method of any of clauses 82-83, further comprising:
   receiving a second input signal corresponding to a second optical sensor of the plurality of optical sensors;
   tuning an optical property of the second input signal based on an operation point of the second optical sensor; and
   transmitting, from the second optical sensor, a second output signal.
85. The method of clause 84, wherein the first input signal is received in parallel with the second input signal and the first output signal is received in parallel with the second output signal.
86. The method of any of clauses 82-85, further comprising a reflector disposed at the optical output port of the first optical sensor; wherein the reflector is configured to reflect the first output signal.
87. The method of any of clauses 82-86, further comprising:
   receiving a mixed input signal at a wavelength-division demultiplexer coupled to the sensor array;
   demultiplexing the mixed input signal into a plurality of input signals;
   receiving the plurality of input signals at the sensor array;
   wherein each optical source forming the mixed input optical signals receives an electrical tuning signal configured to shift a wavelength according to one optical output from a corresponding sensor, wherein the wavelength-division demultiplexer reduces optical power crosstalk.
88. The method of any of clauses 82-87, wherein each output signal of a plurality of output signals has a wavelength corresponding to a wavelength of an input signal of the plurality of input signals.

Various features described herein, e.g., methods, apparatus, computer-readable media, and the like, can be realized using a combination of dedicated components, programmable processors, and/or other programmable devices. Processes described herein can be implemented on the same processor or different processors. Where components are described as being configured to perform certain operations, such configuration can be accomplished, e.g., by designing electronic circuits to perform the operation, by programming programmable electronic circuits (such as microprocessors) to perform the operation, or a combination thereof. Further, while the embodiments described above may make reference to specific hardware and software components, those skilled in the art will appreciate that different combinations of hardware and/or software components may also be used and that particular operations described as being implemented in hardware might be implemented in software or vice versa.

Specific details are given in the above description to provide an understanding of the embodiments. However, it is understood that the embodiments may be practiced without these specific details. In some instances, well-known circuits, processes, algorithms, structures, and techniques may be shown without unnecessary detail in order to avoid obscuring the embodiments.

While the principles of the disclosure have been described above in connection with specific apparatus and methods, it is to be understood that this description is made only by way of example and not as limitation on the scope of the disclosure. Embodiments were chosen and described in order to explain the principles of the invention and practical applications to enable others skilled in the art to utilize the invention in various embodiments and with various modifications, as are suited to a particular use contemplated. It will be appreciated that the description is intended to cover modifications and equivalents.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in the figure. A process may correspond to a method, a function, a procedure, a subroutine, a subprogram, etc.

A recitation of “a”, “an”, or “the” is intended to mean “one or more” unless specifically indicated to the contrary.

What is claimed is:

1. An apparatus for acoustic imaging of a medium, the apparatus comprising:
an optical sensor;
the optical sensor including an acoustic stack;
the acoustic stack comprising a backing layer that supports an optical layer;
the optical layer comprising an optical waveguide and a tuning device configured to tune an optical propagation property of the optical waveguide; and
the optical waveguide including a core region and one or more cladding regions, the one or more cladding regions having optical refractive index less than that of the core region.

2. The apparatus of claim 1, wherein:
the optical waveguide includes a plurality of straight parallel portions and a plurality of bend portions disposed within the width of the sensor; and
the optical propagation property of the optical waveguide is configured to change in response to ultrasound signals.

3. The apparatus of claim 2, wherein the average spacing of the straight portions is smaller than the smallest bending diameter of the bend portions.

4. The apparatus of claim 1, further comprising:
a plurality of ultrasound transducers configured to generate ultrasound signals, and
an optical sensor array comprising the optical sensor.

5. The apparatus of claim 1, wherein the optical waveguide is an acoustic responsive optical waveguide configured such that a complex refractive index or a group velocity associated with a guided mode of the acoustic-responsive optical waveguide changes in response to ultrasound signals reflecting from the imaged medium.

6. The apparatus of claim 1, further comprising a top layer coupled to the optical layer.

7. The apparatus of claim 6, wherein the top layer comprises an acoustic matching layer having an acoustic impedance between that of the imaged medium and that of the backing layer, wherein the acoustic matching layer has a thickness configured to facilitate acoustic transmission from the imaged medium to the optical layer.

8. The apparatus of claim 1, wherein the tuning device and the optical waveguide are included in a single layer in a photonic chip, wherein the mode refractive index of the optical waveguide is tuned via at least one of thermo-optical effect, electro-optic effect, photoelastic effect, or free-carrier-based electro-refractive effect.

9. The apparatus of claim 1, wherein the tuning device and the optical waveguide are included in different layers in an acoustic stack, wherein the tuning device is in an external layer that is adjacent to the optical layer, the mode refractive index of the optical waveguide is tuned via at least one of thermo-optical effect, electro-optic effect, photoelastic effect, or mechanical deformation of the waveguide.

10. The apparatus of claim 1, wherein at least one of the one or more cladding regions is formed from a buried oxide layer of a silicon-on-insulator wafer.

11. The apparatus of claim 1, wherein at least one of the cladding regions or core regions comprises an acoustic responsive material.

12. A method of imaging comprising:
receiving an input optical signal at an interference-based device,
wherein the interference-based device comprises:
one or more optical waveguides including a cladding, the one or more optical waveguides configured to be perturbed by an acoustic signal from an imaged medium;
one or more optical ports coupled to the one or more optical waveguides; and
a tuning device configured to tune an optical waveguide of the one or more optical waveguides;
generating, via the interference-based device, an optical interference signal encoding a change in an optical propagation property of one or more optical waveguides based on the perturbation by the acoustic signal;
measuring the optical interference signal from the interference-based device; and
detecting the acoustic signal from the imaged medium based on the measured optical interference signal.

13. The method of claim 12, wherein the interference-based device comprises an interferometer including:
a reference arm optical waveguide coupled to an optical input port and an optical output port of the one or more optical ports, and
a sensing arm optical waveguide coupled to an optical input port and an optical output port of the one or more optical waveguides.

14. The method of claim 13, wherein the reference arm optical waveguide includes an acoustic-responsive material and the tuning device is disposed adjacent to an optical core of the sensing arm optical waveguide.

15. The method of claim 12, wherein the interference-based device comprises a waveguide resonator, the waveguide resonator comprising a resonator body having the one or more optical waveguides.

16. A method of reading signals from a sensor array, the method comprising:
receiving a plurality of input signals from an optical source;
branching the plurality of input signals to a sensor array comprising a plurality of optical sensors,
wherein each optical sensor of the plurality of optical sensors comprises:
one or more optical waveguides disposed between an optical input port and an optical output port;
a tuning device; and
an electrical input port;
wherein a first input signal of the plurality of input signals corresponds to a first optical sensor of the plurality of optical sensors;
tuning, with the tuning device of the first optical sensor, the first optical sensor according to a wavelength of the optical source; and
transmitting, from the optical output port of the first optical sensor, a first output signal.

17. The method of claim 16, further comprising:
receiving a second input signal corresponding to a second optical sensor of the plurality of optical sensors;
tuning, with the tuning device of the second optical sensor, the second optical sensor; and
transmitting, from the second optical sensor, a second output signal.

18. The method of claim 16, further comprising:
receiving a plurality of electrical control signals at each electrical input port; and
controlling the tuning device of each optical sensor with the plurality of electrical control signals.

19. The method of claim 16, wherein the tuning device comprises a thermo-optical tuning device that changes an effective mode index of the optical sensor.

20. The method of claim 16, wherein the tuning device comprises an optoelectronic tuning device configured to change an effective mode index of the optical sensor.
